(19) United States
(12) Patent Application Publication
(10) Pub. No.: US 2023/0303776 A1
(43) Pub. Date: Sep. 28, 2023

(54) FULLY AND PARTIALLY BACKBONE-DEGRADABLE POLYMERS VIA LOW TEMPERATURE RING-OPENING METATHESIS POLYMERIZATION (ROMP)

(71) Applicant: Northwestern University, Evanston, IL (US)

(72) Inventors: Nathan C. GIANNESCHI, Wilmette, IL (US); Yifei LIANG, Evanston, IL (US); Hao SUN, Evanston, IL (US)

(73) Assignee: Northwestern University, Evanston, IL (US)

(21) Appl. No.: 18/012,001

(22) PCT Filed: Jul. 1, 2021
(86) PCT No.: PCT/US2021/040072

§ 371 Date: Dec. 21, 2022

Related U.S. Application Data
(60) Provisional application No. 63/047,799, filed on Jul. 2, 2020.

(51) Int. Cl. C08G 79/04; C08L 85/02

(52) U.S. Cl. CPC C08G 79/04; C08L 85/02; C08G 2261/334; C08G 2261/418

(57) ABSTRACT

Aspects disclosed herein include fully or partially degradable polymers, liquid formulations comprising such polymers, methods for treating or managing a condition in a subject using such polymers, methods for using such polymers, and methods of synthesizing such polymers. Aspects disclosed herein also include monomers suitable for forming a partially or fully degradable polymer and methods for forming such monomers.

### CROSS REFERENCE TO RELATED APPLICATIONS

This application claims the benefit of priority to U.S. Provisional Pat. Application No. 63/047,799, filed Jul. 2, 2020, which is hereby incorporated by reference in its entirety.

### REFERENCE TO A SEQUENCE LISTING

A sequence listing containing SEQ ID NOs: 1-7, created Jun. 30, 2021, 2 kB, named “338867_76-20_WO_ST25” is provided herewith in a computer-readable nucleotide/amino acid .txt file and is specifically incorporated by reference.

### STATEMENT REGARDING FEDERALLY SPONSORED RESEARCH OR DEVELOPMENT

This invention was made with government support under Award Number HL139001 awarded by the National Institutes of Health. The government has certain rights in the invention.

### BACKGROUND OF INVENTION

Degradable polymers are of significant interest for a wide array of applications, including, but not limited to, drug delivery, tissue engineering, automotive materials, agricultural materials, and in fabricating electronic devices and recyclable materials. For example, degradable polymers with backbones containing ester, acetal, carbonate and amide linkages hold immense promise in drug delivery, tissue engineering, and in fabricating electronic devices and recyclable materials. Traditionally, ring-opening polymerization (ROP) of cyclic monomers, such as cyclic ketene acetals, lactides, and lactones is harnessed to synthesize well-defined degradable polyesters. Recently, polymers containing a variety of hydrolytically and redox degradable moieties have been prepared via ruthenium based metathesis polymerizations, including acyclic diene metathesis (ADMET) polymerization, cascade enyne metathesis polymerization, and ring-opening metathesis polymerization (ROMP).

ROMP is known as a powerful tool for the synthesis of polymers with predictable molecular weights, narrow molecular weight distributions, and complex architectures. In particular, the development of well-defined ruthenium carbene initiators has enabled efficient polymerization with excellent functional group tolerance. Despite the tremendous diversity of functional non-degradable polymers accessed via ROMP, examples of well-defined high molecular weight polymers consisting of fully degradable backbones are lacking. Typically, synthetic approaches to preparing degradable polymers have included radical ring opening polymerizations of cyclic ketene acetals as well as anionic or metal-catalyzed ring opening polymerizations of lactides, lactones, and N-carboxylic anhydrides. However, these strategies have fundamental limitations including poor monomer stability, low functional group tolerance, a low degree of modularity in macromolecular design, poor control over the polymer molecular weight and dispersity, as well as being limited to producing high molecular weight fragments upon the degradation of copolymers consisting of both degradable and non-degradable monomer units.

These, and other, challenges are addressed by the monomers, polymers, formulations, and methods disclosed herein.

### SUMMARY OF THE INVENTION

Included herein are new polymers and new methods for synthesizing polymers that are partially or fully degradable, such as in the presence of an acid. The synthesis methods provide for control over the degree of polymerization of the polymer, degradable repeating units, and non-degradable repeating units (in the case of copolymers). The methods also provide for well-controlled copolymerizations to provide for useful copolymers. Also disclosed herein are monomers and methods for synthesizing monomers that may be used in the syntheses of partially or fully degradable polymers disclosed herein. Other associates methods and compositions are also disclosed, including therapeutic polymers and liquid formulations useful for treating a conditions in a subject.

Aspects disclosed herein include a fully or partially degradable polymer comprising: a plurality of first repeating units; wherein each first repeating unit is characterized by formula FX1A;

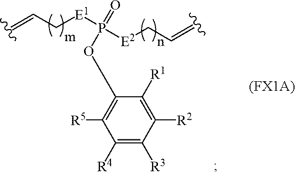

wherein: each of E¹ and E² is independently NR⁶, O, or OR⁷; each of R¹-R⁵ is independently a hydrogen, a halogen, a methyl group, or any combination of these; each of R⁶ and R⁷ is independently hydrogen, a substituted or unsubstituted methyl group, a substituted or unsubstituted ethyl group, a substituted or unsubstituted phenyl group, or any combination of these; and each of m and n is independently 1 or 2. Each of E¹ and E² is independently covalently attached to the P via the N or the O, depending on the chemical identity of E¹ and E². In some embodiments, each of R¹-R⁵ is independently a hydrogen, a halogen, or a methyl group. Optionally, for example optionally in embodiments of any monomer, polymer, method, or formulation disclosed herein, each of R¹-R⁵ is independently a hydrogen, a methyl group, or any combination of these. Optionally, for example optionally in embodiments of any monomer, polymer, method, or formulation disclosed herein, each first repeating unit is chemically degradable in the presence of an acid. Optionally, for example optionally in embodiments of any monomer, polymer, method, or formulation disclosed herein, each first repeating unit comprises a ROMP-polymerized monomer group. Optionally, for example optionally in embodiments of any monomer, polymer, method, or formulation disclosed herein, each of E¹ and E² is independently NR⁶ or O. Optionally, for example optionally in embodiments of any monomer, polymer, method, or formulation disclosed herein, each of E¹ and E² is independently NR⁶. Optionally, for example optionally in embodiments of any monomer, polymer, method, or formulation disclosed herein, one of E¹ and E² is O the other of E¹ and E², respectively, is NR⁶. Optionally, for example optionally in embodiments of any monomer, polymer, method, or formulation disclosed herein, each of R⁶ and R⁷ is independently hydrogen, a substituted or unsubstituted methyl group, a substituted or unsubstituted ethyl group, or a substituted or unsubstituted phenyl group. Optionally, for example optionally in embodiments of any monomer, polymer, method, or formulation disclosed herein, each of R⁶ and R⁷ is independently hydrogen, a methyl group, an ethyl group, or a phenyl group.

Optionally, for example optionally in embodiments of any monomer, polymer, method, or formulation disclosed herein, for any polymer disclosed herein the entire polymer is characterized by a total degree of polymerization (“DP_{polymer}”) selected from the range of 2 to 10,000, or any DP or range thereof therebetween inclusively, such as optionally selected from the range of 5 to 10,000, optionally 10 to 10,000, optionally 2 to 5,000, optionally 5 to 5,000, optionally 10 to 5,000, optionally 10 to 1000, optionally 5 to 1000, optionally 50 to 1000, optionally 50 to 5000. For example, in the case of a homopolymer, wherein in at least 95% of the repeating units (or, each and every, or 100% of repeating units) is the first repeating unit (characterized by formula FX1A), the total degree of polymerization may be selected from the range of 50 to 1000. For example, in the case of a copolymer, the total degree of polymerization of the entire polymer may be selected from the range of 50 to 5000. Optionally, for example optionally in embodiments of any monomer, polymer, method, or formulation disclosed herein, any polymer disclosed herein comprises at least 4 of the first repeating units. Optionally, for example optionally in embodiments of any monomer, polymer, method, or formulation disclosed herein, any polymer disclosed herein comprises at least 5, optionally at least 10, optionally at least 15, optionally at least 20, optionally at least 25 first repeating units.

Optionally, each of at least 95% of the repeating units of any polymer disclosed herein is the first repeating unit. Optionally, for example optionally in embodiments of any monomer, polymer, method, or formulation disclosed herein, any polymer disclosed herein is a homopolymer, wherein each repeating unit of said homopolymer is independently the first repeating unit. Optionally, for example optionally in embodiments of any monomer, polymer, method, or formulation disclosed herein, any polymer disclosed herein is a homopolymer characterized by FX2: Q¹-[U¹]_{z}-Q² (FX2); wherein: each U¹ is independently the first repeating unit; z is an integer selected from the range of 2 to 10,000; and each of Q¹ and Q² is independently a polymer terminating group. Optionally, for example optionally in embodiments of any monomer, polymer, method, or formulation disclosed herein, each of Q¹ and Q² is independently a methyl group, an ethyl group, a phenyl group, a dye molecule (e.g., rhodamine, fluorescein, cy5.5), an MRI agent, a biomolecule (e.g., oligonucleotide or oligopeptide), or any combination of these. Optionally, for example optionally in embodiments of any monomer, polymer, method, or formulation disclosed herein, at least one of Q¹ and Q² is a phenyl group. Optionally, for example optionally in embodiments of any monomer, polymer, method, or formulation disclosed herein, z is selected from the range of 2 to 10,000, or any DP or range thereof therebetween inclusively, such as optionally selected from the range of 5 to 10,000, optionally 10 to 10,000, optionally 2 to 2000, optionally 2 to 5,000, optionally 5 to 5,000, optionally 10 to 5,000, optionally 10 to 1000, optionally 5 to 1000, optionally 50 to 1000, optionally 50 to 5000. For example, in the case of a homopolymer, wherein in at least 95% of the repeating units (or, each and every, or 100% of repeating units) is the first repeating unit (characterized by formula FX1A), the total degree of polymerization may be selected from the range of 50 to 1000. Optionally, for example optionally in embodiments of any monomer, polymer, method, or formulation disclosed herein, any polymer disclosed herein is characterized by formula FX1B:

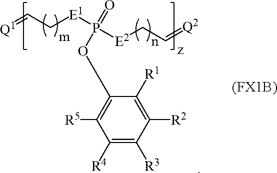

Optionally, for example optionally in embodiments of any monomer, polymer, method, or formulation disclosed herein, with respect to each first repeating unit being characterized by formula FX1A, each of E¹ and E² is independently NH, each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, each of E¹ and E² is independently NH, each of R¹-R⁵ is independently a hydrogen, m is 1, and n is 2. Optionally, for example optionally in embodiments of any monomer, polymer, method, or formulation disclosed herein, with respect to each first repeating unit being characterized by formula FX1A, each of E¹ and E² is independently N(CH₃), each of R¹-R⁵ is independently a hydrogen, m is 1, and n is 2. Optionally, for example optionally in embodiments of any monomer, polymer, method, or formulation disclosed herein, with respect to each first repeating unit being characterized by formula FX1A, each of E¹ and E² is independently N(CH₃), each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, each of E¹ and E² is independently N(C₂H₆), each of R1-R⁵ is independently a hydrogen, m is 1, and n is 2. Optionally, for example optionally in embodiments of any monomer, polymer, method, or formulation disclosed herein, with respect to each first repeating unit being characterized by formula FX1A, each of E¹ and E² is independently N(C₂H₆), each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, each of E¹ and E² is independently NH, each of R¹-R⁵ is independently a hydrogen, m is 2, and n is 2. Optionally, for example optionally in embodiments of any monomer, polymer, method, or formulation disclosed herein, with respect to each first repeating unit being characterized by formula FX1A, each of E¹ and E² is independently NH, each of R¹-R⁵ is independently a hydrogen, m is 1, and n is 2. Optionally, for example optionally in embodiments of any monomer, polymer, method, or formulation disclosed herein, with respect to each first repeating unit being characterized by formula FX1A, each of E¹ and E² is independently N(CH₃), each of R¹-R⁵ is independently a hydrogen, m is 2, and n is 2. Optionally, for example optionally in embodiments of any monomer, polymer, method, or formulation disclosed herein, with respect to each first repeating unit being characterized by formula FX1A, each of E¹ and E² is independently N(CH₃), each of R¹-R⁵ is independently a hydrogen, m is 1, and n is2. Optionally, for example optionally in embodiments of any monomer, polymer, method, or formulation disclosed herein, with respect to each first repeating unit being characterized by formula FX1A, each of E¹ and E² is independently N(C₂H₆), each of R¹-R⁵ is independently a hydrogen, m is 2, and n is 2. Optionally, for example optionally in embodiments of any monomer, polymer, method, or formulation disclosed herein, with respect to each first repeating unit being characterized by formula FX1A, each of E¹ and E² is independently N(C₂H₆), each of R¹-R⁵ is independently a hydrogen, m is 1, and n is 2. Optionally, for example optionally in embodiments of any monomer, polymer, method, or formulation disclosed herein, with respect to each first repeating unit being characterized by formula FX1A, each of E¹ and E² is independently NR⁶, each R⁶ is independently -(CH₂)-(phenyl), each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, E¹ or E² is N(CH₃) and the other of E¹ or E² is O, each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, E¹ or E² is N(CH₃) and the other of E¹ or E² is O(CH₃), each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A, E¹ or E² is N(C₂H₆) and the other of E¹ or E² is O(C₂H₆), each of R¹-R⁵ is independently a hydrogen, m is 1, and n is 1. Optionally, for example optionally in embodiments of any monomer, polymer, method, or formulation disclosed herein, with respect to each first repeating unit being characterized by formula FX1A: each of E¹ and E² is independently NH, each of R¹-R⁵ is independently a hydrogen, m is 1, and n is 1; and/or each of E¹ and E² is independently NH, each of R¹-R⁵ is independently a hydrogen, m is 1, and n is 2; and/or each of E¹ and E² is independently N(CH₃), each of R¹-R⁵ is independently a hydrogen, m is 1, and n is 2; and/or each of E¹ and E² is independently N(CH₃), each of R¹-R⁵ is independently a hydrogen, m is 1, and n is 1; and/or each of E¹ and E² is independently N(C₂H₆), each of R¹-R⁵ is independently a hydrogen, m is 1, and n is 2; and/or each of E¹ and E² is independently N(C₂H₆), each of R¹-R⁵ is independently a hydrogen, m is 1, and n is 1; and/or each of E¹ and E² is independently NH, each of R¹-R⁵ is independently a hydrogen, m is 2, and n is 2; and/or each of E¹ and E² is independently NH, each of R¹-R⁵ is independently a hydrogen, m is 1, and n is 2; and/or each of E¹ and E² is independently N(CH₃), each of R¹-R⁵ is independently a hydrogen, m is 2, and n is 2; and/or each of E¹ and E² is independently N(CH₃), each of R¹-R⁵ is independently a hydrogen, m is 1, and n is 2; and/or each of E¹ and E² is independently N(C₂H₆), each of R¹-R⁵ is independently a hydrogen, m is 2, and n is 2; and/or each of E¹ and E² is independently N(C₂H₆), each of R¹-R⁵ is independently a hydrogen, m is 1, and n is 2; and/or each of E¹ and E² is independently NR⁶, each R⁶ is independently —(CH₂)—(phenyl), each of R¹-R⁵ is independently a hydrogen, m is 1, and n is 1; and/or E¹ or E² is N(CH₃) and the other of E¹ or E² is O, each of R¹-R⁵ is independently a hydrogen, m is 1, and n is 1; and/or E¹ or E² is N(CH₃) and the other of E¹ or E² is O(CH₃), each of R¹-R⁵ is independently a hydrogen, m is 1, and n is 1; and/or E¹ or E² is N(C₂H₆) and the other of E¹ or E² is O(C₂H₆), each of R¹-R⁵ is independently a hydrogen, m is 1, and n is 1. Optionally, for example optionally in embodiments of any monomer, polymer, method, or formulation disclosed herein, each first repeating unit is characterized by formula FX30B, FX31B, FX32B, FX33B, FX34B, FX35B, FX36B, FX37B, FX38B, FX39B, FX40B, FX41B, FX42B, any substituted version thereof, any derivative thereof, or any combination thereof:

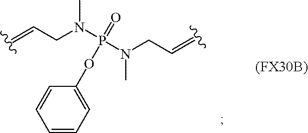

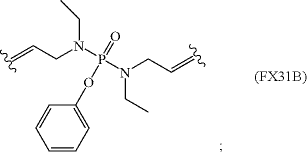

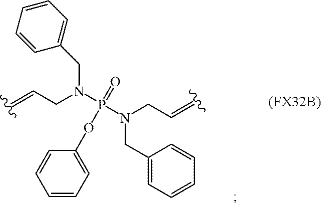

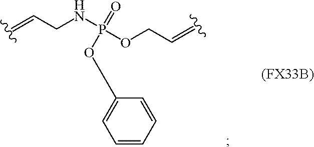

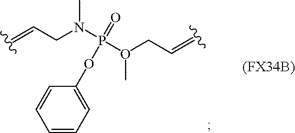

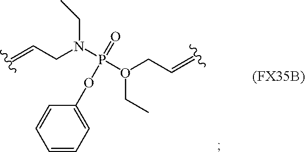

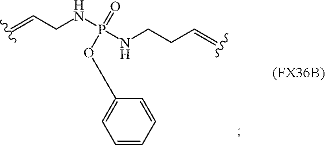

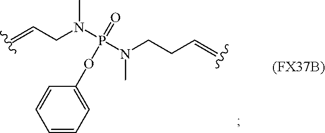

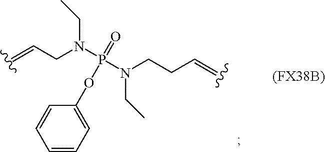

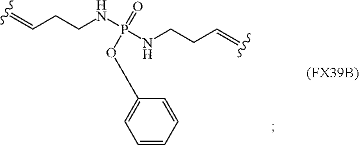

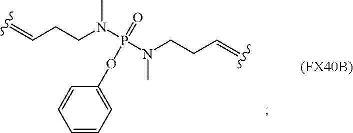

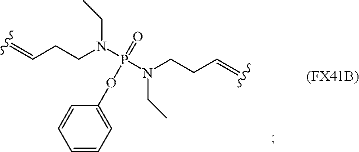

or

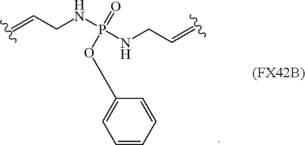

Optionally, for example optionally in embodiments of any monomer, polymer, method, or formulation disclosed herein, each first repeating unit is characterized by formula FX30B, FX31B, FX32B, FX33B, FX34B, FX35B, FX36B, FX37B, FX38B, FX39B, FX40B, FX41B, FX42B, any substituted version thereof, or any combination thereof. Optionally, for example optionally in embodiments of any monomer, polymer, method, or formulation disclosed herein, each first repeating unit is characterized by formula FX30B, FX31B, FX32B, FX33B, FX34B, FX35B, FX36B, FX37B, FX38B, FX39B, FX40B, FX41B, FX42B, or any combination thereof. Optionally, for example optionally in embodiments of any monomer, polymer, method, or formulation disclosed herein, each first repeating unit is characterized by formula FX30B, FX31B, FX32B, FX33B, FX34B, FX35B, FX36B, FX37B, FX38B, FX39B, FX40B, FX41B, or FX42B.

Optionally, for example optionally in embodiments of any monomer, polymer, method, or formulation disclosed herein, each first repeating unit is a ROMP-polymerization product of a ROMP-polymerizable monomer characterized by formula FX30A, FX31A, FX32A, FX33A, FX34A, FX35A, FX36A, FX37A, FX38A, FX39A, FX40A, FX41A, FX42A, any substituted version thereof, any derivative thereof, or any combination thereof:

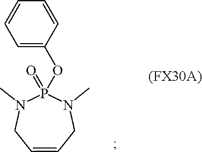

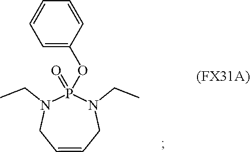

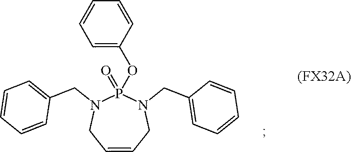

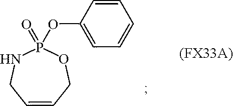

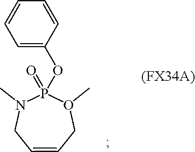

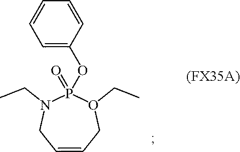

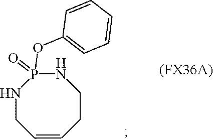

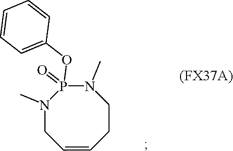

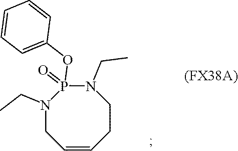

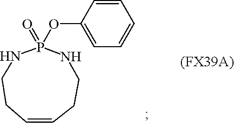

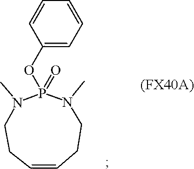

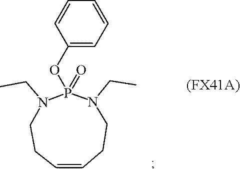

or

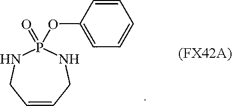

Optionally, for example optionally in embodiments of any monomer, polymer, method, or formulation disclosed herein, each first repeating unit is a ROMP-polymerization product of a ROMP-polymerizable monomer characterized by formula FX30A, FX31A, FX32A, FX33A, FX34A, FX35A, FX36A, FX37A, FX38A, FX39A, FX40A, FX41A, FX42A, any substituted version thereof, or any combination thereof. Optionally, for example optionally in embodiments of any monomer, polymer, method, or formulation disclosed herein, each first repeating unit is a ROMP-polymerization product of a ROMP-polymerizable monomer characterized by formula FX30A, FX31A, FX32A, FX33A, FX34A, FX35A, FX36A, FX37A, FX38A, FX39A, FX40A, FX41A, FX42A, or any combination thereof. Optionally, for example optionally in embodiments of any monomer, polymer, method, or formulation disclosed herein, each first repeating unit is a ROMP-polymerization product of a ROMP-polymerizable monomer characterized by formula FX30A, FX31A, FX32A, FX33A, FX34A, FX35A, FX36A, FX37A, FX38A, FX39A, FX40A, FX41A, or FX42A.

Optionally, for example optionally in embodiments of any monomer, polymer, method, or formulation disclosed herein, the polymer is a copolymer comprising: a plurality of second repeating units, each second repeating unit comprising a ROMP-polymerized monomer group; wherein at least one second repeating unit is covalently attached to a first repeating unit. Optionally, each second repeating unit is a ROMP-polymerized monomer unit or group. Optionally, at least one second repeating unit is covalently attached to a first repeating unit. Optionally, each second repeating unit comprises a polymer backbone group; wherein each polymer backbone group comprises a ROMP-polymerized monomer group. Optionally, for example optionally in embodiments of any copolymer, method involving a copolymer, or formulation including a copolymer disclosed herein, wherein the polymer is a copolymer comprising first repeating units and at least second repeating units (e.g., optionally also third repeating units), the ratio of the DP of all the first repeating units (DP_{deg}) to the DP of the entire polymer (“DP_{polymer}”, i.e., sum of DP of all repeating units in the polymer) is optionally selected from the range of 0.05 to 1, optionally 0.05 to 0.95, optionally 0.05 to 0.9, optionally 0.05 to 0.85, optionally 0.05 to 0.8, optionally 0.05 to 0.75, optionally 0.05 to 0.7, optionally 0.05 to 0.65, optionally 0.05 to 0.6, optionally 0.05 to 0.55, optionally 0.05 to 0.5, optionally 0.05 to 0.45, optionally 0.05 to 0.4, optionally 0.05 to 0.35, optionally 0.05 to 0.3, optionally 0.05 to 0.25, optionally 0.05 to 0.2, optionally 0.05 to 0.15, optionally 0.2 to 0.95, optionally 0.25 to 0.95, optionally 0.3 to 0.95, optionally 0.35 to 0.95, optionally 0.4 to 0.95, optionally 0.45 to 0.95, optionally 0.5 to 0.95, optionally 0.55 to 0.95, optionally 0.6 to 0.95, optionally 0.65 to 0.95, optionally 0.7 to 0.95, optionally 0.75 to 0.95, optionally 0.8 to 0.95, optionally 0.85 to 0.95, optionally 0.9 to 0.95, optionally 0.1 to 0.3, optionally 0.1 to 0.25, optionally 0.15 to 0.3, optionally 0.15 to 0.25, optionally 0.2 to 0.3, optionally 0.24 to 0.3, optionally 0.24 to 0.26 (this ratio may be referred to as the degradable unit ratio of the polymer and optionally represented by the formula DP_{deg}:DP_{polymer}). Optionally, for example optionally in embodiments of any copolymer, method involving a copolymer, or formulation including a copolymer disclosed herein, wherein the polymer is a copolymer comprising first repeating units and at least second repeating units (e.g., optionally also third repeating units), the ratio of the DP of all the first repeating units (DP_{deg}) to the DP of the entire polymer (“DP_{polymer}”; i.e., sum of DP of all repeating units in the polymer) is selected from the range of 0.2 to 1, optionally 0.25 to 1, optionally 0.2 to 0.95, optionally 0.25 to 0.95.

Optionally, for example optionally in embodiments of any copolymer, method involving a copolymer, or formulation including a copolymer disclosed herein, each second repeating unit comprises the ROMP-polymerization product of a monomer comprising: a substituted or unsubstituted norbornene group, a substituted or unsubstituted dicyclopentadiene group, a substituted or unsubstituted norbornene-imide group, a substituted or unsubstituted oxanorbornene-imide group, a substituted or unsubstituted oxanorbornene group, a substituted or unsubstituted cyclooctene group, a substituted or unsubstituted 1,5-cyclooctadiene group, a substituted or unsubstituted dithiocine group, a substituted or unsubstituted dioxaphosphepine group, a substituted or unsubstituted dioxepinone group, any derivative thereof, or any combination of these. Optionally, for example optionally in embodiments of any copolymer, method involving a copolymer, or formulation including a copolymer disclosed herein, the copolymer is a block copolymer, an alternating copolymer, a random copolymer, a graft copolymer, or any combination of these. Optionally, for example optionally in embodiments of any copolymer, method involving a copolymer, or formulation including a copolymer disclosed herein, the copolymer is characterized by formula FX3: Q¹-[U¹]ᵤ-/-[U²]_{q}-Q² (FX3); wherein: each U¹ is independently the first repeating unit; each U² is independently the second repeating unit; each of u and q is independently an integer selected from the range of 2 to 10,000 (optionally wherein the sum of u and q is 10,00 or less); each of Q¹ and Q² is independently a polymer terminating group; and the symbol “/” indicates that the units separated thereby are covalently linked randomly or in any order. Optionally, for example optionally in embodiments of any copolymer, method involving a copolymer, or formulation including a copolymer disclosed herein, each of u and q is independently an integer selected from the range of 2 to 10,000, or any DP or range thereof therebetween inclusively, such as optionally selected from the range of 5 to 10,000, optionally 10 to 10,000, optionally 2 to 5,000, optionally 5 to 5,000, optionally 10 to 5,000, optionally 10 to 1000, optionally 5 to 1000, optionally 50 to 1000, optionally 50 to 5000. Optionally, for example optionally in embodiments of any copolymer, method involving a copolymer, or formulation including a copolymer disclosed herein, the sum of the integers u and q is less than or equal to 10,000, optionally less than or equal to 8000, optionally less than or equal to 6000, optionally less than or equal to 5000, optionally less than or equal to 4000, optionally less than or equal to 3000, optionally less than or equal to 2000, optionally less than or equal to 1000, optionally less than or equal to 800, optionally less than or equal to 600, optionally less than or equal to 500, optionally less than or equal to 300, optionally less than or equal to 200. Optionally, for example optionally in embodiments of any copolymer, method involving a copolymer, or formulation including a copolymer disclosed herein, the sum of the integers u and q is selected from the range of 10 to 10,000, optionally selected from the range of 10 to 5000, optionally selected from the range of 50 to 5000, optionally selected from the range of 10 to 2000, optionally selected from the range of 50 to 2000, optionally selected from the range of 10 to 1000, optionally selected from the range of 50 to 1000. For example, in some embodiments of a copolymer, the total degree of polymerization of the entire polymer (DP_{polymer}) may be selected from the range of 50 to 5000. Optionally, for example optionally in embodiments of any monomer, polymer, method, or formulation disclosed herein, each of Q¹ and Q² is independently a methyl group, an ethyl group, a phenyl group, a dye molecule (e.g., rhodamine, fluorescein, cy5.5), an MRI agent, a biomolecule (e.g., oligonucleotide or oligopeptide), or any combination of these. Optionally, for example optionally in embodiments of any monomer, polymer, method, or formulation disclosed herein, at least one of Q¹ and Q² is a phenyl group.

Optionally, for example optionally in embodiments of any copolymer, method involving a copolymer, or formulation including a copolymer disclosed herein, each second repeating unit comprises a polymer backbone group directly or indirectly covalently linked to one or more side chain moieties; wherein each second repeating unit is characterized by formula FX4:

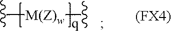

wherein: each M is independently the polymer backbone group of one of the second repeating units and each M independently comprises a ROMP-polymerized monomer group; each Z is independently one of the one or more side chain moieties of each second repeating unit; q is an integer selected from the range of 2 to 5000; w is an integer selected from the range of 1 to 4; and the polymer backbone group of each second repeating unit is directly or indirectly covalently attached to the polymer backbone group of a different second repeating and/or to a first repeating unit. Optionally, for example optionally in embodiments of any copolymer, method involving a copolymer, or formulation including a copolymer disclosed herein, q is selected from the range of 2 to 9,998, or any DP or range thereof therebetween inclusively, such as optionally selected from the range of 5 to 10,000, optionally 10 to 10,000, optionally 2 to 2000, optionally 2 to 5,000, optionally 5 to 5,000, optionally 10 to 5,000, optionally 10 to 1000, optionally 5 to 1000, optionally 50 to 1000, optionally 50 to 5000. Optionally, for example optionally in embodiments of any copolymer, method involving a copolymer, or formulation including a copolymer disclosed herein, w is the integer 1 or 2. Optionally, for example optionally in embodiments of any copolymer, method involving a copolymer, or formulation including a copolymer disclosed herein, each second repeating unit is characterized by formula FX5:

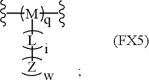

wherein: L is a covalent linking group; each of i and w is independently an integer selected from the range of 1 to 4. Optionally, for example optionally in embodiments of any copolymer, method involving a copolymer, or formulation including a copolymer disclosed herein, i is the integer 1 or 2. Optionally, for example optionally in embodiments of any copolymer, method involving a copolymer, or formulation including a copolymer disclosed herein, w is the integer 1 or 2. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21A, FX22A, FX23A, FX24A, FX25A, FX26A, FX27A, FX28A, FX29A, any substituted version thereof, any derivative thereof, or any combination thereof:

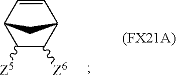

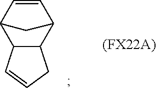

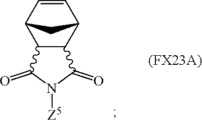

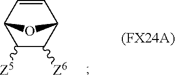

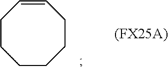

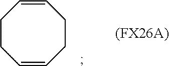

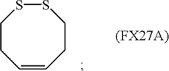

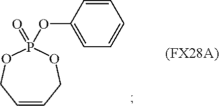

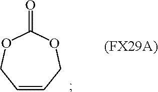

wherein: each of Z⁵ and Z⁶ is independently a side chain moiety or a combination of a covalent linking group and a side chain moiety. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21A, FX22A, FX23A, FX24A, FX25A, FX26A, FX27A, FX28A, FX29A, any substituted version thereof, or any combination thereof. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21A, FX22A, FX23A, FX24A, FX25A, FX26A, FX27A, FX28A, FX29A, or any combination thereof. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21A, FX22A, FX23A, FX24A, FX25A, FX26A, FX27A, FX28A, or FX29A. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21B, FX22B, FX23B, FX24B, FX25B, FX26B, FX27B, FX28B, FX29B, any substituted version thereof, any derivative thereof, or any combination thereof:

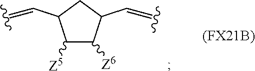

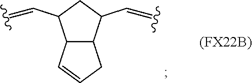

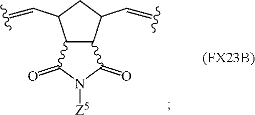

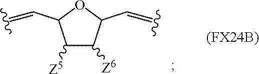

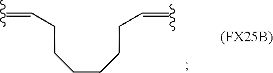

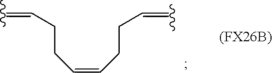

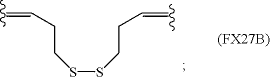

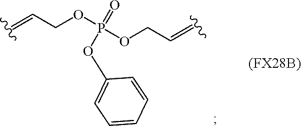

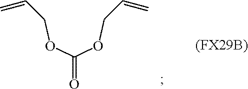

wherein: each of Z⁵ and Z⁶ is independently a side chain moiety or a combination of a covalent linking group and a side chain moiety. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21B, FX22B, FX23B, FX24B, FX25B, FX26B, FX27B, FX28B, FX29B, any substituted version thereof, or any combination thereof. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21B, FX22B, FX23B, FX24B, FX25B, FX26B, FX27B, FX28B, FX29B, or any combination thereof. Optionally, for example optionally in embodiments of any copolymer, method involving a copolymer, or formulation including a copolymer disclosed herein, each second repeating unit is a ROMP-polymerization product of a ROMP-polymerizable monomer characterized by formula FX21B, FX22B, FX23B, FX24B, FX25B, FX26B, FX27B, FX28B,or FX29B.

Optionally, for example optionally in embodiments of any copolymer, method involving a copolymer, or formulation including a copolymer disclosed herein, each second repeating unit is characterized by formula FX6, FX7, FX8, FX9, FX10, FX11, FX12, or FX13:

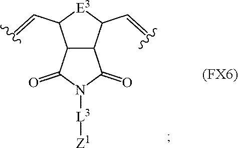

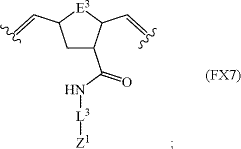

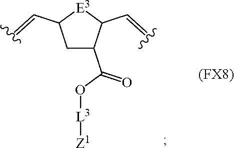

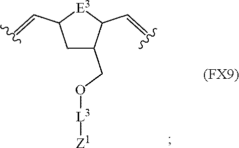

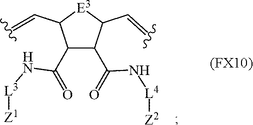

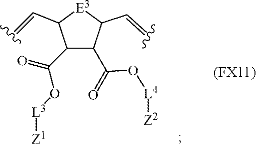

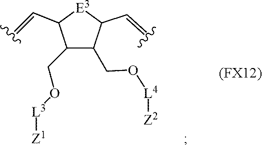

or

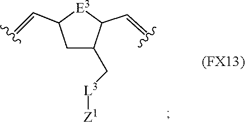

wherein E³ is C or O; wherein each of L³ and L⁴ is independently the covalent linking group; and wherein each of Z¹ and Z² is independently one of the one or more side chain moieties of a second repeating unit. Optionally, for example optionally in embodiments of any copolymer, method involving a copolymer, or formulation including a copolymer disclosed herein, each second repeating unit is characterized by formula FX6, FX7, FX8, FX9, FX10, FX11, FX12, FX13, any substituted version thereof, any derivative thereof, or any combination thereof. Optionally, for example optionally in embodiments of any copolymer, method involving a copolymer, or formulation including a copolymer disclosed herein, each second repeating unit is characterized by formula FX6, FX7, FX8, FX9, FX10, FX11, FX12, FX13, or any combination thereof. Optionally, for example optionally in embodiments of any copolymer, method involving a copolymer, or formulation including a copolymer disclosed herein, each second repeating unit is characterized by formula FX6, FX7, FX8, FX9, FX10, FX11, FX12, FX13, or any substituted version thereof.

Optionally, for example optionally in embodiments of any copolymer, method involving a copolymer, or formulation including a copolymer disclosed herein, the copolymer comprises: a plurality of third repeating units, each third repeating unit comprising a ROMP-polymerized monomer group; wherein at least one third repeating unit is covalently attached to a first repeating unit, a second repeating unit, or both. Optionally, for example optionally in embodiments of any copolymer, method involving a copolymer, or formulation including a copolymer disclosed herein, each third repeating unit is a ROMP-polymerized monomer unit or group. Optionally, for example optionally in embodiments of any copolymer, method involving a copolymer, or formulation including a copolymer disclosed herein, each third repeating unit comprises a polymer backbone group directly or indirectly covalently linked to one or more side chain moieties. Optionally, for example optionally in embodiments of any copolymer, method involving a copolymer, or formulation including a copolymer disclosed herein, each third repeating unit is characterized by formula FX6, FX7, FX8, FX9, FX10, FX11, FX12, FX13, FX21B, FX22B, FX23B, FX24B, FX25B, FX26B, FX27B, FX28B, FX29B, any substituted version thereof, any derivative thereof, or any combination thereof. Optionally, for example optionally in embodiments of any copolymer, method involving a copolymer, or formulation including a copolymer disclosed herein, each third repeating unit is a ROMP-polymerization product of a ROMP-polymerizable monomer characterized by formula FX21A, FX22A, FX23A, FX24A, FX25A, FX26A, FX27A, FX28A, FX29A, any substituted version thereof, any derivative thereof, or any combination thereof.

Optionally, for example optionally in embodiments of any monomer, polymer, method, or formulation disclosed herein, each covalent linking group is independently a single bond, an oxygen, or one or more substituted or substituted groups having an alkyl group, an alkenylene group, an arylene group, an alkoxy group, an acyl group, a carboxyl group, an aliphatic group, an amide group, an aryl group, an amine group, an ether group, a ketone group, an ester group, a triazole group, a diazole group, a pyrazole group, or combinations thereof.

Optionally, for example optionally in embodiments of any monomer, polymer, method, or formulation disclosed herein, wherein at least one side chain moiety of the polymer comprises a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of side chain moieties of the polymer, or each (100%) side chain moiety of the polymer comprises a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of side chain moieties of the polymer, or each (100%) side chain moiety of the polymer comprises a therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of side chain moieties of the polymer, or each (100%) side chain moiety of the polymer comprises a peptide moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of side chain moieties of the polymer, or each (100%) side chain moiety of the polymer comprises a non-peptide therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of repeating units of the polymer comprises a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of repeating units of the polymer comprises a therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of repeating units of the polymer comprises a peptide moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of repeating units of the polymer comprises a non-peptide therapeutic moiety. Optionally, for example optionally in embodiments of any monomer, polymer, method, or formulation disclosed herein, at least one second repeating unis and/or at least one third repeating unit, if present, independently comprises at least one side chain moiety having a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of second repeating units of the polymer, or each (100%) second repeating unit of the polymer comprises a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of second repeating units of the polymer, or each (100%) second repeating unit of the polymer comprises a therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of second repeating units of the polymer, or each (100%) second repeating unit of the polymer comprises a peptide moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of second repeating units of the polymer, or each (100%) second repeating unit of the polymer comprises a non-peptide therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of third repeating units of the polymer, or each (100%) third repeating unit of the polymer comprises a therapeutic moiety, a peptide moiety, a therapeutic peptide moiety, a non-peptide therapeutic moiety, or any combination thereof. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of third repeating units of the polymer, or each (100%) third repeating unit of the polymer comprises a therapeutic moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of third repeating units of the polymer, or each (100%) third repeating unit of the polymer comprises a peptide moiety. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of third repeating units of the polymer, or each (100%) third repeating unit of the polymer comprises a non-peptide therapeutic moiety. Optionally, for example optionally in embodiments of any monomer, polymer, method, or formulation disclosed herein, each of 4% to 25%, optionally each of 5% to 25%, optionally each of 5% to 20%, optionally each of 5% to 15% of the repeating units of the entire polymer independently comprises a peptide moiety. Optionally, for example optionally in embodiments of any monomer, polymer, method, or formulation disclosed herein, each of 4% to 25%, optionally each of 5% to 25%, optionally each of 5% to 20%, optionally each of 5% to 15% of the second and/or third repeating units (if present) of the entire polymer independently comprises a peptide moiety. Optionally, for example optionally in embodiments of any monomer, polymer, method, or formulation disclosed herein, the polymer comprises at least one non-peptide therapeutic moiety having a cell growth or proliferation inhibitory agent, an anti-inflammatory agent, an anti-tumor or anti-cancer agent, an anti-apoptotic agent, anti-diabetic agent, anti-obesity agent, anti-infective agent, anti-bacterial agent, anti-viral agent, an agent for promoting cell growth and differentiation, an agent for preventing pain, an agent for preventing or treating neural degeneration, an agent for promoting neurogenesis; an immunosuppressant agent, an immunostimulant agent, an MMP-inhibitor agent, a corticosteroid, an anti-angiogenic agent, a pro-angiogenic agent, an NSAID, paclitaxel, rapamycin, dexamethasone, or any combination of these. Optionally, for example optionally in embodiments of any monomer, polymer, method, or formulation disclosed herein, each of every non-peptide therapeutic moiety of the polymer comprises a cell growth or proliferation inhibitory agent, an anti-inflammatory agent, an anti-tumor or anti-cancer agent, an anti-apoptotic agent, anti-diabetic agent, anti-obesity agent, anti-infective agent, anti-bacterial agent, anti-viral agent, an agent for promoting cell growth and differentiation, an agent for preventing pain, an agent for preventing or treating neural degeneration, an agent for promoting neurogenesis; an immunosuppressant agent, an immunostimulant agent, an MMP-inhibitor agent, a corticosteroid, an anti-angiogenic agent, a pro-angiogenic agent, an NSAID, paclitaxel, rapamycin, dexamethasone, or any combination of these. Optionally, for example optionally in embodiments of any monomer, polymer, method, or formulation disclosed herein, each of at least 50% of the non-peptide therapeutic moieties of the polymer comprises a cell growth or proliferation inhibitory agent, an anti-inflammatory agent, an anti-tumor or anti-cancer agent, an anti-apoptotic agent, anti-diabetic agent, anti-obesity agent, anti-infective agent, anti-bacterial agent, anti-viral agent, an agent for promoting cell growth and differentiation, an agent for preventing pain, an agent for preventing or treating neural degeneration, an agent for promoting neurogenesis; an immunosuppressant agent, an immunostimulant agent, an MMP-inhibitor agent, a corticosteroid, an anti-angiogenic agent, a pro-angiogenic agent, an NSAID, paclitaxel, rapamycin, dexamethasone, or any combination of these. Optionally, for example optionally in embodiments of any monomer, polymer, method, or formulation disclosed herein, the polymer comprise at least one peptide moiety comprising a sequence having 80% or greater (e.g., 90% or greater) sequence homology with GGSGSGS (SEQ ID NO:1), GGSGSGE (SEQ ID NO:2), GGSGSGK (SEQ ID NO:3), GGSGSGR (SEQ ID NO:4), GGSGSGRR (SEQ ID NO:5), KVPRNQDWL (SEQ ID NO:6), GPLGLAGGWGERDGS (SEQ ID NO:7), or a combination of these. Optionally, for example optionally in embodiments of any monomer, polymer, method, or formulation disclosed herein, each of at least 5%, each of at least 10%, each of at least 15%, each of at least 20%, each of at least 25%, each of at least 30%, each of at least 40%, each of at least 50%, each of at least 60%, each of at least 70%, each of at least 80%, each of at least 90%, each of at least 95% of peptide moieties of the polymer, or each (100%) peptide moiety of the polymer comprises a sequence having 80% or greater (e.g., 90% or greater) sequence homology with GGSGSGS (SEQ ID NO:1), GGSGSGE (SEQ ID NO:2), GGSGSGK (SEQ ID NO:3), GGSGSGR (SEQ ID NO:4), GGSGSGRR (SEQ ID NO:5), KVPRNQDWL (SEQ ID NO:6), GPLGLAGGWGERDGS (SEQ ID NO:7), or a combination of these.

Optionally, for example optionally in embodiments of any polymer, method, or formulation disclosed herein, the polymer is an amphiphilic block copolymer having a hydrophilic block and a hydrophobic block. Optionally, for example optionally in embodiments of any polymer, method, or formulation disclosed herein, a plurality of the first repeating units forms the hydrophobic block and wherein a plurality of the second repeating units forms the hydrophilic block. Optionally, for example optionally in embodiments of any polymer, method, or formulation disclosed herein, the amphiphilic block copolymer being in the form of a particle or micelle in a solution.

Applications of polymers, formulations, and methods disclosed herein include utilizing the polymers, according to certain embodiments, to facilitate delivery of one or more therapeutic agents (e.g., therapeutic peptide and/or non-peptide therapeutic agent), such as but not limited to hydrophobic non-peptide therapeutic drugs. For example, the polymers, according to certain embodiments, may be used as or configured as drug delivery vehicles, such as in the case of copolymers, according to embodiments here, that may form micellar structures in a biological fluid. Optionally, for example optionally in embodiments of any copolymer, method involving a copolymer, or formulation including a copolymer disclosed herein, each of a majority of the second repeating units independently comprises an enzyme-cleavable peptide moiety. Optionally, for example optionally in embodiments of any copolymer, method involving a copolymer, or formulation including a copolymer disclosed herein, each of 4% to 25%, optionally each of 5% to 25%, each of 5% to 25%, optionally each of 5% to 20%, optionally each of 5% to 15% of the repeating units of the entire polymer independently comprises an enzyme-cleavable peptide moiety. Optionally, for example optionally in embodiments of any monomer, polymer, method, or formulation disclosed herein, each of 4% to 25%, optionally each of 5% to 25%, optionally each of 5% to 20%, optionally each of 5% to 15% of the second and/or third repeating units (if present) of the entire polymer independently comprises an enzyme-cleavable peptide moiety. Optionally, for example optionally in embodiments of any monomer, polymer, method, or formulation disclosed herein, each of 5% to 15% of the repeating units of the entire polymer independently comprises an enzyme-cleavable peptide moiety wherein the DP of peptide-containing repeating units is about 5, the DP of non-peptide therapeutic moiety-containing repeating units is about 30 to about 50, and the total DP of the entire polymer (DP_{polymer}) is selected from the range of 30 to 100. Optionally, for example optionally in embodiments of any copolymer, method involving a copolymer, or formulation including a copolymer disclosed herein, the enzyme-cleavable peptide moiety is cleavable by a matrix metalloproteinases. Optionally, for example optionally in embodiments of any copolymer, method involving a copolymer, or formulation including a copolymer disclosed herein, the polymer is an amphiphilic block copolymer having at least one hydrophilic block and at least one hydrophobic block; wherein a plurality of the first repeating units forms a hydrophobic block and wherein a plurality of the second repeating units forms a hydrophilic block; and wherein the amphiphilic block copolymer is in the form of a particle or micelle in a solution.

Optionally, for example optionally in embodiments of any copolymer, method involving a copolymer, or formulation including a copolymer disclosed herein, the copolymer is in the form of a particle or micelle in the presence of (e.g., when dispersed in or otherwise exposed to) a biological fluid, such as but not limited to blood.

For example, polymers disclosed herein, according to certain embodiments, may be configured to deliver hydrophobic therapeutic agents to a subject via encapsulation of the therapeutic agents. Optionally, for example optionally in embodiments of any copolymer, method involving a copolymer, or formulation including a copolymer disclosed herein, the particle or micelle encapsulates a hydrophobic therapeutic agent. Optionally, for example optionally in embodiments of any copolymer, method involving a copolymer, or formulation including a copolymer disclosed herein, polymer is an amphiphilic block copolymer characterized by formula FX14: Q¹-[U¹]ᵤ-[U²]_{q}-Q² (FX14); wherein: each U¹ is independently the first repeating unit being hydrophobic; each U² is independently the second repeating unit being hydrophilic and comprising a peptide moiety; each of u and q is independently an integer selected from the range of 2 to 1000; and each of Q¹ and Q² is independently a polymer terminating group. Optionally, for example optionally in embodiments of any copolymer, method involving a copolymer, or formulation including a copolymer disclosed herein, the polymer is characterized by formula FX15:

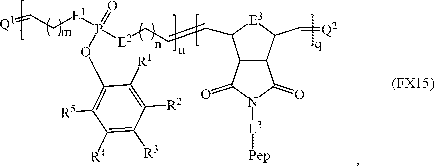

wherein: E³ is C or O; each of u and q is independently an integer selected from the range of 2 to 1000; each L³ is independently a covalent linking group; each of Q¹ and Q² is independently a polymer terminating group; and each “pep” is a peptide moiety. Optionally, each of u and q is independently an integer selected from the range of 2 to 10,000, or any DP or range thereof therebetween inclusively, such as optionally selected from the range of 5 to 10,000, optionally 10 to 10,000, optionally 2 to 5,000, optionally 5 to 5,000, optionally 10 to 5,000, optionally 10 to 1000, optionally 5 to 1000, optionally 50 to 1000, optionally 50 to 5000. Optionally, the sum of the integers u and q is less than or equal to 10,000, optionally less than or equal to 8000, optionally less than or equal to 6000, optionally less than or equal to 5000, optionally less than or equal to 4000, optionally less than or equal to 3000, optionally less than or equal to 2000, optionally less than or equal to 1000, optionally less than or equal to 800, optionally less than or equal to 600, optionally less than or equal to 500, optionally less than or equal to 300, optionally less than or equal to 200. Optionally, the sum of the integers u and q is selected from the range of 10 to 10,000, optionally selected from the range of 10 to 5000, optionally selected from the range of 50 to 5000, optionally selected from the range of 10 to 2000, optionally selected from the range of 50 to 2000, optionally selected from the range of 10 to 1000, optionally selected from the range of 50 to 1000.

For example, polymers disclosed herein, according to certain embodiments, may be configured to deliver hydrophobic therapeutic agents to a subject via covalent functionalization of the therapeutic agents, such as having wherein side chain moieties on second and/or third repeating units of the copolymer comprise covalently functionalized hydrophobic therapeutic agents. Optionally, for example optionally in embodiments of any copolymer, method involving a copolymer, or formulation including a copolymer disclosed herein, the polymer is an amphiphilic block copolymer characterized by formula FX16: Q¹-[U²]_{q}-[U¹]ᵤ-/-[U³]_{g}-Q² (FX16); wherein: each U¹ is independently the first repeating unit being hydrophobic; each U² is independently the second repeating unit being hydrophilic and comprising a peptide moiety; each U³ is independently a third repeating unit being hydrophobic and comprising a peptide moiety; each third repeating unit comprising a ROMP-polymerized monomer group; each third repeating unit comprises a polymer backbone group directly or indirectly covalently linked to one or more third side chain moieties; at least one third repeating unit comprises a side chain moiety having a non-peptide therapeutic moiety; each of u, q, and g is independently an integer selected from the range of 2 to 1000; each of Q¹ and Q² is independently a polymer terminating group; and the symbol “/” indicates that the units separated thereby are covalently linked randomly or in any order. Optionally, for example optionally in embodiments of any copolymer, method involving a copolymer, or formulation including a copolymer disclosed herein, the copolymer is characterized by formula FX17:

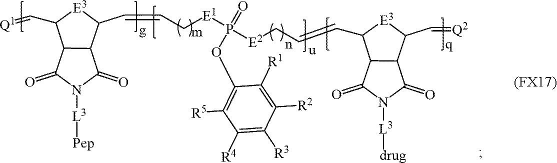

wherein: each “pep” is a peptide moiety; each “drug” is a hydrophobic non-peptide therapeutic moiety; each E³ is independently is C or O; each of u, q, and g is independently an integer selected from the range of 2 to 1000; each of Q¹ and Q² is independently a polymer terminating group; and each of L³ is independently a covalent linking group that can be degraded through enzymolysis and/or hydrolysis. Optionally, for example optionally in embodiments of any copolymer, method involving a copolymer, or formulation including a copolymer disclosed herein, each L³ independently comprises a hydrolytically labile ester. For example, a small molecule drug may be connected to the norbornene via an ester bond, which can be cleaved by water (hydrolysis) and/or enzymes (for example, esterase). This bond may need to be cleaved to release the free drug for function/efficacy (e.g., see FIG. 36). For example, a peptide moiety, such as in the polymer of formula FX17, can be a matrix metalloproteinases (MMP) responsive sequence, which is linked to the norbornene via an amide bond. Each L³ can independently be, but is not limited to, a covalent linkage comprising an amide, an ester, a carbonate, etc. An ester bond, as characterized by formula —COO—, can be split/cleaved by a water molecule (the hydrolysis process) to yield carboxylic acid and alcohol. Therefore, this type of bond may be referred to as “hydrolytically labile”, meaning that it can be split by water. If a drug is connected to the norbornene monomer/backbone through ester bond, it can be released free in the presence of water or enzyme such as esterase. The presence of acid (many diseased sites actually has lower pH like 6 or 6.5) or base can further accelerate this hydrolysis process. Optionally, each of u, q, and g is independently an integer selected from the range of 2 to 10,000, or any DP or range thereof therebetween inclusively, such as optionally selected from the range of 5 to 10,000, optionally 10 to 10,000, optionally 2 to 5,000, optionally 5 to 5,000, optionally 10 to 5,000, optionally 10 to 1000, optionally 5 to 1000, optionally 50 to 1000, optionally 50 to 5000. Optionally, the sum of the integers u, q, and g is less than or equal to 10,000, optionally less than or equal to 8000, optionally less than or equal to 6000, optionally less than or equal to 5000, optionally less than or equal to 4000, optionally less than or equal to 3000, optionally less than or equal to 2000, optionally less than or equal to 1000, optionally less than or equal to 800, optionally less than or equal to 600, optionally less than or equal to 500, optionally less than or equal to 300, optionally less than or equal to 200. Optionally, for example in any embodiments of polymers, methods, and formulations disclosed herein, the sum of the integers u, q, and g is selected from the range of 10 to 10,000, optionally selected from the range of 10 to 5000, optionally selected from the range of 50 to 5000, optionally selected from the range of 10 to 2000, optionally selected from the range of 50 to 2000, optionally selected from the range of 10 to 1000, optionally selected from the range of 50 to 1000.

Applications of polymers and methods disclosed herein also include modified versions of polymers already used in various industries, such as automotive and agricultural materials, where the modified version have the relevant functions or properties for those industries but further include degradable repeating units (“first repeating units” according to embodiments herein) thereby rendering those modified polymers degradable, and thereby less harmful to the environment. Applications of polymers disclosed herein also including recyclable polymers, and associated synthesis and use methods, which may be useful in a wide array of industries, such as wherein the degradation products may be either used to re-form useful polymers and/or wherein the degradation products may be themselves useful products, such as in agricultural fertilizer. Optionally, for example optionally in embodiments of any copolymer, method involving a copolymer, or formulation including a copolymer disclosed herein, the copolymer is a random or alternating copolymer characterized by formula FX18: Q¹-[U¹]ᵤ-co-[U²]_{q}-Q² (FX18); wherein: each U¹ is independently the first repeating unit; each U² is independently the second repeating unit having a therapeutic peptide moiety; each of u and q is independently an integer selected from the range of 2 to 1000; and each of Q¹ and Q² is independently a polymer terminating group; and the symbol “co” indicates that the units separated thereby are covalently linked random and/or alternating order. Optionally, each of u and q is independently an integer selected from the range of 2 to 10,000, or any DP or range thereof therebetween inclusively, such as optionally selected from the range of 5 to 10,000, optionally 10 to 10,000, optionally 2 to 5,000, optionally 5 to 5,000, optionally 10 to 5,000, optionally 10 to 1000, optionally 5 to 1000, optionally 50 to 1000, optionally 50 to 5000. Optionally, the sum of the integers u and q is less than or equal to 10,000, optionally less than or equal to 8000, optionally less than or equal to 6000, optionally less than or equal to 5000, optionally less than or equal to 4000, optionally less than or equal to 3000, optionally less than or equal to 2000, optionally less than or equal to 1000, optionally less than or equal to 800, optionally less than or equal to 600, optionally less than or equal to 500, optionally less than or equal to 300, optionally less than or equal to 200. Optionally, the sum of the integers u and q is selected from the range of 10 to 10,000, optionally selected from the range of 10 to 5000, optionally selected from the range of 50 to 5000, optionally selected from the range of 10 to 2000, optionally selected from the range of 50 to 2000, optionally selected from the range of 10 to 1000, optionally selected from the range of 50 to 1000.

Aspects disclosed herein also include a plurality of polymers, each polymer being according to embodiment or any combination of embodiments of a polymer disclosed herein. Optionally, the plurality of polymers is characterized by a dispersity selected from the range of 1.1 to 1.5. Optionally, the plurality of polymers is characterized by a dispersity selected from the range of 1.0 to 1.5, optionally 1.01 to 1.5, optionally, 1.0 to 1.3, optionally, 1.01 to 1.3.

Aspects disclosed herein also include a liquid formulation comprising: a solvent or solvent mixture; and a polymer (or, plurality of said polymer) according to any embodiment or any combination of embodiments of polymers disclosed herein; wherein the polymer is dispersed in the solvent or solvent mixture. Optionally, the liquid formulation is aqueous. Optionally, the liquid formulation is a therapeutic formulation having a therapeutically effective concentration of the polymer.

Aspects disclosed herein also include a method of treating or managing a condition in a subject comprising: administering to the subject a liquid formulation according to any embodiment or any combination of embodiments of liquid formulations disclosed herein (having a polymer according to any embodiment or any combination of embodiments of polymers disclosed herein); wherein the administered amount of the liquid formulation has a therapeutically effective concentration of the polymer.

Aspects disclosed herein also include a method of treating or managing a condition in a subject comprising: administering to the subject a therapeutically effective amount of a polymer according to any embodiment or any combination of embodiments of polymers disclosed herein.

Aspects disclosed herein also include a method of using a polymer according to any embodiment or any combination of embodiments of polymers disclosed herein, the method comprising: degrading or dissolving the polymer in the presence of acid thereby forming degradation products. Optionally, the degradation products comprise a phosphoric acid, a substituted or unsubstituted diamine or a derivative thereof, or a combination of these. Optionally, the method of using comprises using at least a fraction of the degradation products to synthesize a monomer characterized by formula FX19 or FX20 (as shown and characterized below):

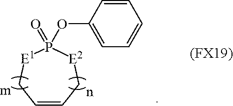

Optionally, the method of using comprises forming an agricultural fertilizer comprising at least a fraction of the degradation products. Optionally, the polymer is a random or alternating copolymer characterized by formula FX18: Q¹-[U¹]ᵤ-co-[U²]_{q}-Q² (FX18); wherein: each U¹ is independently the first repeating unit; each U² is independently the second repeating unit being non-degradable and comprising a polymer backbone group having a ROMP-polymerized monomer group or a cyclopentane group; each of u and q is independently an integer selected from the range of 2 to 10,000; and each of Q¹ and Q² is independently a polymer terminating group; and the symbol “co” indicates that the units separated thereby are covalently linked random and/or alternating order.

Aspects disclosed herein also include a method for synthesis of a partially or fully degradable polymer, such as a polymer according to any embodiment or any combination of embodiments of polymers disclosed herein, the method comprising: polymerizing a plurality of monomers using ring-opening metathesis polymerization; wherein the plurality of monomers comprises a plurality of first monomers; each first monomer being independently characterized by formula FX20:

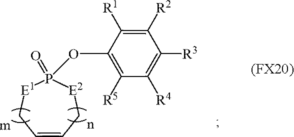

wherein: each of E¹ and E² is independently NR⁶, O, or OR⁷; each of R¹-R⁵ is independently a hydrogen, a halogen, a methyl group, or any combination of these; each of R⁶ and R⁷ is independently hydrogen, a substituted or unsubstituted methyl group, a substituted or unsubstituted ethyl group, a substituted or unsubstituted phenyl group, or any combination of these; and each of m and n is independently 1 or 2. Optionally, for example optionally in embodiments of any monomer, polymer, method, or formulation disclosed herein, each of R¹-R⁵ is independently a hydrogen, a methyl group, or any combination of these. Optionally, in any method for synthesis of a polymer disclosed herein, each of the plurality of monomers are the same of substantially the same. Optionally, in any method for synthesis of a polymer disclosed herein, a majority of the monomer of the plurality of monomers are the same or substantially the same. Optionally, in any method for synthesis of a polymer disclosed herein, the plurality of monomers is a mixture two or more different monomers (or, those having different formulas) such as a mixture of a plurality of monomers that are ROMP-polymerizable into first repeating units (each characterized by formula FX1A) according to embodiments herein, and a plurality of second (different) monomers that are ROMP-polymerizable into second repeating units, according to embodiments thereof herein, and optionally the mixture of monomers further comprising a plurality of third (different) monomers that are ROMP-polymerizable into third repeating units, according to embodiments thereof herein. Optionally, in any method for synthesis of a polymer disclosed herein, the step of polymerizing occurs in the presence of a Grubbs catalyst; wherein step of polymerizing comprising mixing an initiator solution comprising the Grubbs catalyst and a first monomer solution comprising at least a portion of the plurality of monomers to form a first reaction solution. Optionally, in a method for synthesis of a polymer disclosed herein, in the case of the method being a method for forming a homopolymer, the first monomer solution may comprise the entire plurality of monomers. Optionally, in a method for synthesis of a polymer disclosed herein, in the case of the method being a method for forming a copolymer, the first monomer solution may comprise a first portion of the plurality of monomers. Optionally, in any method for synthesis of a polymer disclosed herein, the first portion of the plurality of monomers comprises the first monomers (being characterized by formula FX20). Optionally, in any method for synthesis of a polymer disclosed herein, the first portion of the plurality of monomers is free, or substantially free, of the first monomers. Optionally, in any method for synthesis of a polymer disclosed herein, the step of polymerizing further comprises mixing the first reaction solution with a second monomer solution comprising a remaining portion or a second portion of the plurality of monomers to form a second reaction solution. Optionally, in any method for synthesis of a polymer disclosed herein, the remaining portion comprises the first monomers. Optionally, in any method for synthesis of a polymer disclosed herein, each monomer or each of a majority of the monomers of the remaining portion is a first monomer. Optionally, in any method for synthesis of a polymer disclosed herein, the remaining portion comprises the first monomers and the remaining portion is free, or substantially free, of the first monomers. Optionally, in any method for synthesis of a polymer disclosed herein, the remaining portion comprises second monomers, each second monomer being different from each first monomer. Optionally, in any method for synthesis of a polymer disclosed herein, the step of polymerizing further comprises mixing the first reaction solution with a second monomer solution comprising a second portion of the plurality of monomers to form a second reaction solution (the sum of the first portion and the second portion being less than 100% of the plurality of monomers). Optionally, in any method for synthesis of a polymer disclosed herein, the plurality of monomers further comprises a third portion, wherein the step of polymerizing further comprises mixing the second reaction solution with a third monomer solution comprising a third portion of the plurality of monomers to form a third reaction solution. Optionally, in any method for synthesis of a polymer disclosed herein, each step of mixing comprises (co)polymerization of at least a fraction of the plurality of monomers or the respective portion of the plurality of monomers being mixed in the respective step of mixing. Optionally, for example optionally in embodiments of any monomer, polymer, method, or formulation disclosed herein, each of E¹ and E² is independently NR⁶ or O. Optionally, for example optionally in embodiments of any monomer, polymer, method, or formulation disclosed herein, each of E¹ and E² is independently NR⁶. Optionally, for example optionally in embodiments of any monomer, polymer, method, or formulation disclosed herein, one of E¹ and E² is O the other of E¹ and E², respectively, is NR⁶. Optionally, for example optionally in embodiments of any monomer, polymer, method, or formulation disclosed herein, each of R⁶ and R⁷ is independently hydrogen, a substituted or unsubstituted methyl group, a substituted or unsubstituted ethyl group, or a substituted or unsubstituted phenyl group. Optionally, for example optionally in embodiments of any monomer, polymer, method, or formulation disclosed herein, each of R⁶ and R⁷ is independently hydrogen, a methyl group, an ethyl group, or a phenyl group.

Optionally, in any method for synthesis of a polymer disclosed herein, the plurality of monomers comprises a plurality of second monomers, each second monomer being different from each first monomer; wherein each second monomer comprises ROMP-polymerizable group; and wherein the resulting degradable polymer is a copolymer. Optionally, in any method for synthesis of a polymer disclosed herein, each second monomer comprises a substituted or unsubstituted norbornene group, a substituted or unsubstituted dicyclopentadiene group, a substituted or unsubstituted norbornene-imide group, a substituted or unsubstituted oxanorbornene-imide group, a substituted or unsubstituted oxanorbornene group, a substituted or unsubstituted cyclooctene group, a substituted or unsubstituted 1,5-cyclooctadiene group, a substituted or unsubstituted dithiocine group, a substituted or unsubstituted dioxaphosphepine group, a substituted or unsubstituted dioxepinone group, any derivative thereof, or any combination of these. Optionally, in any method for synthesis of a polymer disclosed herein, the plurality of monomers comprises a plurality of third monomers, each third monomer being different from each first monomer and from each second monomer; wherein each third monomer comprises ROMP-polymerizable group. Optionally, in any method for synthesis of a polymer disclosed herein, each second monomer and/or each third monomer, if present, is characterized by formula FX21, FX22, FX23, FX24, FX25, FX26, FX27, FX28, FX29, any substituted version thereof, any derivative thereof, or any combination thereof:

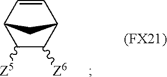

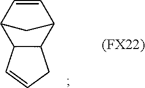

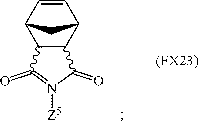

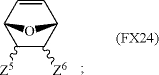

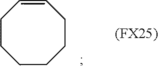

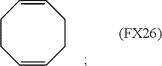

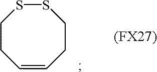

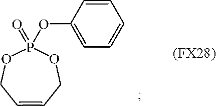

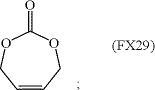

wherein: each of Z⁵ and Z⁶ is independently a side chain moiety or a combination of a covalent linking group and a side chain moiety.

Optionally, the method for synthesis of a polymer is a method for synthesizing polymer comprising substituted PTDO monomer units. Optionally, in any method for synthesis of a polymer disclosed herein, one or both of E¹ and E² is other than NH. Optionally, in any method for synthesis of a polymer disclosed herein, the concentration of the plurality of first monomers in the monomer solution is great than 0.1 M, optionally greater than 0.5 M, optionally greater than 0.8 M, optionally selected from the range of 0.5 M to 10 M, optionally selected from the range of 0.8 M to 10 M, optionally selected from the range of 0.5 M to 5 M, optionally selected from the range of 0.8 M to 5 M, optionally selected from the range of 0.5 M to 2 M, optionally selected from the range of 0.8 M to 2 M. Optionally, in any method for synthesis of a polymer disclosed herein, a temperature of the monomer solution immediately prior to the mixing step, the initiator solution immediately prior to the mixing step, and/or the mixture of initiator solution and the monomer solution immediately after mixing is greater than -5° C., optionally selected from the range of -5° C. to 10° C., optionally selected from the range of 5° C. to 10° C., optionally selected from the range of 5° C. to 30° C., optionally selected from the range of- 5° C. to 30° C., optionally selected from the range of 10° C. to 30° C., optionally greater than or equal to 10° C. Optionally, in any method for synthesis of a polymer disclosed herein, the concentration of the plurality of first monomers in the monomer solution is great than 0.1 M (optionally greater than 0.5 M, optionally greater than 0.8 M); and wherein a temperature of the monomer solution immediately prior to the mixing step, the initiator solution immediately prior to the mixing step, and/or the mixture of initiator solution and the monomer solution immediately after mixing is greater than 5° C. (optionally greater than 10° C., optionally greater than 15° C., optionally greater than 20° C., optionally greater than or equal to 22° C., optionally greater than or equal to 25° C.). Optionally, in any method for synthesis of a polymer disclosed herein, the monomer solution has a solvent that comprises dimethyl formamide and/or is free of dichloromethane. Optionally, in any method for synthesis of a polymer disclosed herein, each first monomer is characterized by formula FX30, FX31, FX32, FX33, FX34, FX35, FX36, FX37, FX38, FX39, FX40, FX41, any substituted version thereof, any derivative thereof, or any combination thereof:

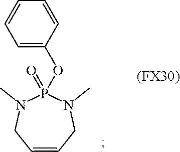

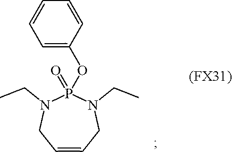

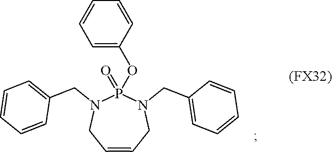

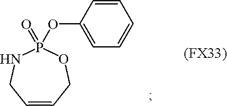

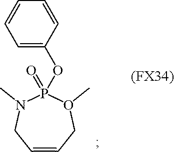

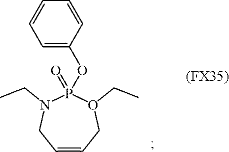

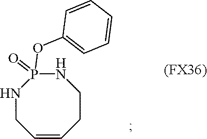

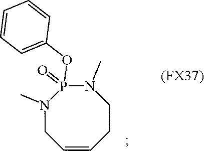

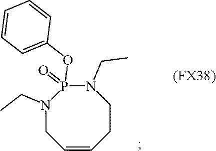

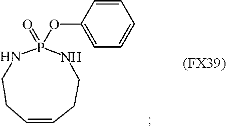

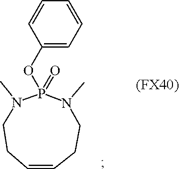

or

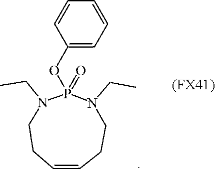

Optionally, in any method for synthesis of a polymer disclosed herein, each first monomer is characterized by formula FX30, FX31, FX32, FX33, FX34, FX35, FX36, FX37, FX38, FX39, FX40, FX41, any substituted version thereof, or any combination thereof. Optionally, in any method for synthesis of a polymer disclosed herein, each first monomer is characterized by formula FX30, FX31, FX32, FX33, FX34, FX35, FX36, FX37, FX38, FX39, FX40, FX41, or any combination thereof. Optionally, in any method for synthesis of a polymer disclosed herein, each first monomer is characterized by formula FX30, FX31, FX32, FX33, FX34, FX35, FX36, FX37, FX38, FX39, FX40, FX41, or any substituted version thereof. Optionally, in any method forsynthesis of a polymer disclosed herein, each first monomer is characterized by formula FX30, FX31, FX32, FX33, FX34, FX35, FX36, FX37, FX38, FX39, FX40, or FX41. Optionally, in any method for synthesis of a polymer disclosed herein, each first monomer is characterized by formula FX30, FX31, FX32, FX33, FX34, FX35, FX37, FX38, FX40, FX41, any substituted version thereof, or any combination thereof. Optionally, in any method for synthesis of a polymer disclosed herein, each first monomer is characterized by formula FX30, FX31, FX32, FX33, FX34, FX35, FX37, FX38, FX40, FX41, or any combination thereof. Optionally, in any method for synthesis of a polymer disclosed herein, each first monomer is characterized by formula FX30, FX31, FX32, FX33, FX34, FX35, FX37, FX38, FX40, FX41, or any substituted version thereof. Optionally, in any method for synthesis of a polymer disclosed herein, each first monomer is characterized by formula FX30, FX31, FX32, FX33, FX34, FX35, FX37, FX38, FX40, or FX41.

Optionally, the method for synthesis of a polymer is a method for synthesizing polymer comprising non-substituted PTDO monomer units. Optionally, in any method for synthesis of a polymer disclosed herein, each of E¹ and E² is NH; the Grubbs catalyst is a third-generation Grubbs catalyst (G3) catalyst; the initiator solution is characterized by a temperature selected from the range of -5° C. to 20° C. (optionally -5° C. to 20° C., optionally 0° C. to 20° C., optionally -5° C. to 15° C., optionally 0° C. to 15° C.) immediately prior to or at the time of mixing; the first monomer solution comprises the plurality of first monomers; the concentration of the plurality of first monomers in the monomer solution is selected from the range of 0.1 M to 0.8 M; and the first monomer solution comprises a solvent selected from the group consisting of dichloromethane, chloroform, tetrahydrofuran, methanol, and any combination of these. Optionally, in any method for synthesis of a polymer disclosed herein, the first monomer solution comprises a solvent selected from the group consisting of dichloromethane, chloroform, tetrahydrofuran, and any combination of these. Optionally, in any method for synthesis of a polymer disclosed herein, the polymerization of the plurality of first monomers in the presence of the Grubbs catalyst is performed for a time selected from the range of 30 minutes to 5 hours prior to terminating the polymerization reaction. Optionally, in any method for synthesis of a polymer disclosed herein, the first monomer solution comprises an additive at an additive concentration selected to facilitate the dissolution of the plurality of first monomers such that the plurality of first monomers do not dissolve at said concentration in the absence of said additive at said additive concentration. Optionally, in any method for synthesis of a polymer disclosed herein, the solvent is a solvent mixture comprising an additive being methanol at an additive concentration selected from the range of 5 vol.% to 10 vol.%, optionally 5 vol.% to 15 vol.%. Optionally, in any method for synthesis of a polymer disclosed herein, each first monomer is characterized by formula, each first monomer is characterized by formula FX42A, FX36, or FX39:

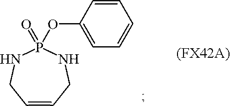

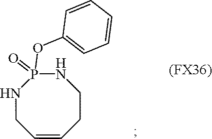

or

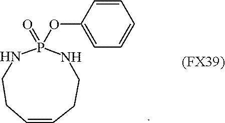

Optionally, in any method for synthesis of a polymer disclosed herein, each first monomer is characterized by formula FX42A:

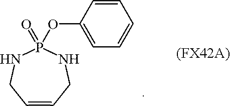

Aspects disclosed herein also include a monomer suitable for forming a partially or fully degradable polymer, the monomer being characterized by formula FX20:

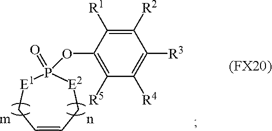

wherein: each of E¹ and E² is independently NR⁶, O, or OR⁷; each of R¹-R⁵ is independently a hydrogen, a halogen, a methyl group, or any combination of these; each of R⁶ and R⁷ is independently hydrogen, a substituted or unsubstituted methyl group, a substituted or unsubstituted ethyl group, a substituted or unsubstituted phenyl group, or any combination of these; with the provisio that one or both of E¹ and E² is other than NH; and each of m and n is independently 1 or 2. Optionally, for example optionally in embodiments of any monomer, polymer, method, or formulation disclosed herein, each of R¹-R⁵ is independently a hydrogen, a methyl group, or any combination of these. Optionally, for example optionally in embodiments of any monomer, polymer, method, or formulation disclosed herein, each of E¹ and E² is independently NR⁶ or O. Optionally, for example optionally in embodiments of any monomer, polymer, method, or formulation disclosed herein, each of E¹ and E² is independently NR⁶. Optionally, for example optionally in embodiments of any monomer, polymer, method, or formulation disclosed herein, one of E¹ and E² is O the other of E¹ and E², respectively, is NR⁶. Optionally, for example optionally in embodiments of any monomer, polymer, method, or formulation disclosed herein, each of R⁶ and R⁷ is independently hydrogen, a substituted or unsubstituted methyl group, a substituted or unsubstituted ethyl group, or a substituted or unsubstituted phenyl group. Optionally, for example optionally in embodiments of any monomer, polymer, method, or formulation disclosed herein, each of R⁶ and R⁷ is independently hydrogen, a methyl group, an ethyl group, or a phenyl group.

Aspects disclosed herein also include a method for synthesizing a monomer suitable for forming a partially or fully degradable polymer, the method comprising: reacting a precursor using ring-closing metathesis to form the monomer characterized by formula FX20:

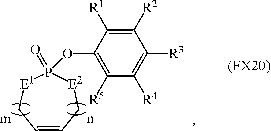

wherein: each of E¹ and E² is independently NR⁶, O, or OR⁷; each of R1-R⁵ is independently a hydrogen, a halogen, a methyl group, or any combination of these; each of R⁶ and R⁷ is independently hydrogen, a substituted or unsubstituted methyl group, a substituted or unsubstituted ethyl group, a substituted or unsubstituted phenyl group, or any combination of these; with the provisio that one or both of E¹ and E² is other than NH; and each of m and n is independently 1 or 2. Optionally, for example optionally in embodiments of any monomer, polymer, method, or formulation disclosed herein, each of R1-R⁵ is independently a hydrogen, a methyl group, or any combination of these. Optionally, in any method disclosed herein for synthesizing a monomer, the step of reacting is performed in the presence of a Grubbs catalyst. Optionally, in any method disclosed herein for synthesizing a monomer, the precursor is formed by reacting a first reagent and a second reagent, wherein the first reagent is characterized by formula FX43 and wherein the second reagent is characterized by formula FX44A:

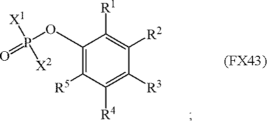

and

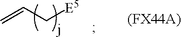

wherein: each of R¹-R⁵ is independently a hydrogen, a halogen, a methyl group, or any combination of these; each of X¹ and X² is independently a halide; j is an integer selected from the range of 1 to 2; E⁵ is independently NR⁶, O, or OR⁷; and each of R⁶ and R⁷ is independently hydrogen, a substituted or unsubstituted methyl group, a substituted or unsubstituted ethyl group, a substituted or unsubstituted phenyl group, or any combination of these. Optionally, for example optionally in embodiments of any monomer, polymer, method, or formulation disclosed herein, each of R¹-R⁵ is independently a hydrogen, a methyl group, or any combination of these. Optionally, in any method disclosed herein for synthesizing a monomer, the precursor is formed by reacting a first reagent and a plurality of different second reagents, differing by the chemical identity of E⁵. Optionally, in any method disclosed herein for synthesizing a monomer, the precursor is characterized by formula FX45A:

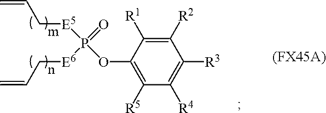

wherein: each of R¹-R⁵ is independently a hydrogen, a halogen, a methyl group, or any combination of these; each of m and n is independently the integer 1 or 2; each of E⁵ and E⁶ is independently NR⁶, O, or OR⁷; and each of R⁶ and R⁷ is independently hydrogen, a substituted or unsubstituted methyl group, a substituted or unsubstituted ethyl group, a substituted or unsubstituted phenyl group, or any combination of these. Optionally, for example optionally in embodiments of any monomer, polymer, method, or formulation disclosed herein, each of R¹-R⁵ is independently a hydrogen, a methyl group, or any combination of these. Optionally, in any method disclosed herein for synthesizing a monomer, the second reagent is characterized by formula FX44B or FX44C:

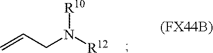

or

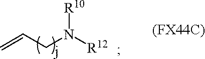

wherein E⁵ is N or O; and each of R¹⁰ and R¹¹ is independently either absent or a hydrogen, a substituted or unsubstituted methyl group, a substituted or unsubstituted ethyl group, a substituted or unsubstituted phenyl group, or any combination of these. Optionally, in any method disclosed herein for synthesizing a monomer, the precursor is characterized by formula FX45B or FX45C:

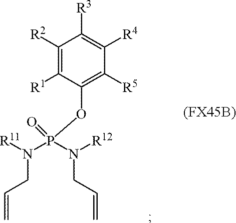

or

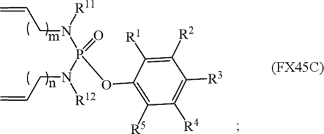

wherein E⁵ is N or O; and each of R¹⁰ and R¹¹ is independently either absent or a hydrogen, a substituted or unsubstituted methyl group, a substituted or unsubstituted ethyl group, a substituted or unsubstituted phenyl group, or any combination of these. Optionally, for example optionally in embodiments of any monomer, polymer, method, or formulation disclosed herein, each of E¹ and E² is independently NR⁶ or O. Optionally, for example optionally in embodiments of any monomer, polymer, method, or formulation disclosed herein, each of E¹ and E² is independently NR⁶. Optionally, for example optionally in embodiments of any monomer, polymer, method, or formulation disclosed herein, one of E¹ and E² is O the other of E¹ and E², respectively, is NR⁶. Optionally, for example optionally in embodiments of any monomer, polymer, method, or formulation disclosed herein, each of R⁶ and R⁷ is independently hydrogen, a substituted or unsubstituted methyl group, a substituted or unsubstituted ethyl group, or a substituted or unsubstituted phenyl group. Optionally, for example optionally in embodiments of any monomer, polymer, method, or formulation disclosed herein, each of R⁶ and R⁷ is independently hydrogen, a methyl group, an ethyl group, or a phenyl group.

Variants of the following peptide monomers are disclosed throughout the figures and description of the figures: GGSGSGS (SEQ ID NO:1), GGSGSGE (SEQ ID NO:2), GGSGSGK (SEQ ID NO:3), GGSGSGR (SEQ ID NO:4), GGSGSGRR (SEQ ID NO:5), KVPRNQDWL (SEQ ID NO:6), GPLGLAGGWGERDGS (SEQ ID NO:7).

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1: Synthesis and ring-opening metathesis polymerization of 2-phenoxy-1,3,4,7-tetrahydro-1,3,2-diazaphosphepine 2-oxide (PTDO) to afford polymers bearing phosphoramidate linkages.

FIGS. 2A-2C: Synthesis of PPTDOs by ROMP in accordance with Table 2. FIG. 2A: Plot of Mₙ and Ð versus monomer conversion, obtained by a combination of SEC-MALS and ¹H-NMR analysis. The dotted line represents the theoretical Mₙ. FIG. 2B: SEC traces (normalized RI) of PPTDOs quenched at different reaction times (correlated to Table 2, Entries 1-5). FIG. 2C: SEC traces (normalized RI) of PPTDOs of different molecular weights (correlated to Table 2, Entry 5: PTDO₅₅, Entry 6: PTDO₉₄; Entry 7: PTDO₂₁₆).

FIGS. 3A-3C: Degradation of PTDO and PPTDO (DP = 94) in 0.25 M HCI in DMSO-d₆ at room temperature. ³¹P-NMR spectra of (FIG. 3A) PTDO degradation, and (FIG. 3B) PPTDO degradation at different times. FIG. 3C: SEC traces of PPTDO before and after 240 h acid treatment. Note: ³¹P-NMR of phenylphosphoric acid was measured to give a signal at - 6.23 ppm.

FIGS. 4A-4F: Synthesis and degradation of NB-PTDO copolymers. Synthetic scheme for the preparation of (FIG. 4A) random copolymers, and (FIG. 4B) block copolymers of NB and PTDO. SEC traces (normalized RI) of random copolymers with (FIG. 4C) NBPh, and (FIG. 4D) NBOEG before and after acid treatment. SEC traces (normalized RI) of block copolymers with (FIG. 4E) NBPh, and (FIG. 4F) NBOEG before and after acid treatment. Degradation condition: 0.5 M HCI in DMSO for 24 h at room temperature.

FIG. 5: Optimized geometries of the reactants and products calculated by density functional theory and the corresponding energies used to calculate the ring strain of PTDO.

FIG. 6: SEC traces of PTDO polymerized under different reaction conditions with I in accordance with Table 1.

FIG. 7: SEC traces of PTDO polymerized under different reaction conditions with I-Br.

FIG. 8: dn/dc measurement of PPTDO (DP = 94) in DMF with 0.05 M LiBr. Five different polymer concentrations: 5.0, 4.0, 2.5, 1.0, 0.5 mg/mL were used.

FIG. 9: ¹H-NMR analysis of PTDO homopolymerization quenched at different times.

FIG. 10: Plot of In([M]₀/[M]ₜ) versus time with R² = 0.997.

FIG. 11: ¹H-NMR determination of monomer conversion for the polymerization of PTDO. In this example, the conversion was calculated to be M% = 55% based on the equation above. The integration of a′ signal at 5.54 ppm (trans-olefin) and 5.40 ppm (cis-olefin) afforded an E/Z ratio of 5:1.

FIG. 12: Thermogravimetric analysis of PPTDO (DP = 94) under helium atmosphere with a heating rate of 10° C./min. Polymer begins to decompose at 235° C.

FIG. 13: Differential scanning calorimetry thermogram of PPTDO (DP = 94). The second heating scan under nitrogen at a heating rate of 10° C./min estimates a glass transition temperature of 42° C.

FIG. 14A: PTDO and (FIG. 14B) PPTDO degradation monitored by ³¹P-NMR spectroscopy.

FIG. 15: ³¹P-NMR spectra of PTDO degradation at different times in 0.25 M HCI in DMSO-d₆. The decrease in signal at 18.07 ppm and the increase in signal at -6.72 ppm is indicative of the conversion of PTDO into phenylphosphoric acid via acid hydrolysis.

FIG. 16: ¹H-NMR spectra of PTDO degradation at different times in 0.25 M HCI in DMSO-d₆. The decrease of the cyclic alkene proton signal at 5.54 ppm is indicative of hydrolysis of PTDO.

FIG. 17: ¹H-NMR spectrum of PTDO degradation post 192 h of acid treatment.

FIG. 18: ³¹P-NMR spectra of PPTDO degradation at different times in 0.25 M HCI in DMSO-d₆. The decrease in signal at 13.00 ppm and the increase in signal at -6.72 ppm is indicative of PPTDO degradation via phosphoramidate linkage cleavage resulting in the formation of phenylphosphoric acid.

FIG. 19: ¹H-NMR spectra of PPTDO degradation at different times in 0.25 M HCI in DMSO-d₆. The gradual decrease in signal corresponding to the polyolefin protons at 5.50 ppm is indicative of the degradation of the polymer backbone via acid hydrolysis.

FIG. 20: ¹H-NMR spectra of NBPh homopolymerization at 1 h and copolymerization with PTDO at 5 h. A feed ratio of 50 : 50 : 1, NBPh : PTDO : I was used. Monomer signals were labeled and assigned to their chemical structures. The signals of olefin and amine shifted after the polymerization as indicated by the arrows. Aromatic protons were used as an internal reference. Integration of the residual norbornene vinyl peak at 6.3 ppm and residual PTDO olefin peak at 5.6 ppm provided 84% NBPh (DP = 42) and 64% PTDO (DP = 32) conversion.

FIG. 21: ¹H-NMR spectra of NBOEG homopolymerization at 1 h and copolymerization with PTDO at 5 h. A feed ratio of 50 : 50 : 1, NBOEG : PTDO : I was used. Monomer signals were labeled and assigned to their chemical structures. The signals of olefin and amine shifted after the polymerization as indicated by the arrows. Aromatic protons were used as an internal reference. Integration of the residual norbornene vinyl peak at 6.3 ppm and residual PTDO olefin peak at 5.6 ppm provided 76% NBOEG (DP = 38) and 64% PTDO (DP = 32) conversion.

FIG. 22: ¹H-NMR spectra of NBPh polymerization at 1 h and chain extension with PTDO at 3 h. A feed ratio of 50 : 50 : 1, NBPh : PTDO : I was used. Integration of the residual monomer and polymer amine signals provided a 50% PTDO conversion (DP = 25).

FIG. 23: ¹H-NMR spectra of NBOEG polymerization at 1 h and chain extension with PTDO at 3 h. A feed ratio of 40 : 80 : 1, NBOEG : PTDO : I was used. Integration of the residual monomer and polymer amine signals provided a 41% PTDO conversion (DP = 33).

FIGS. 24A-24C: Characterization and cytotoxicity of NB-PTDO nanoparticles. FIGS. 24A-24B: TEM images of particles formulated from block and random copolymers. Scale bar: 100 nm. FIG. 24C: Cell viability of HeLa cells incubated for 24 h with nanoparticles. Five concentrations: 1, 20, 50, 100, 150 µg/mL were used. Two replicates of the experiment were performed. All values are relative to the cell media control, normalized to 100%.

FIG. 25: ¹H-NMR spectrum of cis-1,4-diamino-2-butene-2HCl in D₂O.

FIG. 26: ¹H-NMR spectrum of PTDO in DMSO-d₆.

FIG. 27: ¹³C-NMR spectrum of PTDO in DMSO-d₆.

FIG. 28: ³¹P-NMR spectrum of PTDO in DMSO-d₆.

FIG. 29: ¹H-NMR spectrum of phenylphosphoric acid in DMSO-d₆.

FIG. 30: ³¹P-NMR spectrum of phenylphosphoric acid in DMSO-d₆.

FIG. 31: ¹H-NMR spectrum of PPTDO (DP=94) in DMSO-d₆. Integration of trans (5.54 ppm) and cis (5.40 ppm) signals revealed an E/Z ratio of 7:1.

FIG. 32: ¹³C-NMR spectrum of PPTDO (DP=94) in DMSO-d₆.

FIG. 33: HSQC spectrum of PPTDO (DP=94) in DMSO-d₆. H signals at 5.54 and 5.40 ppm showed a correlation with C signal at 130 ppm, indicating for trans and cis alkene configurations.

FIG. 34: ³¹P-NMR spectrum of PPTDO (DP=94) in DMSO-d₆. The peak at 17.68 ppm was attributed to the residual PTDO monomer after repeated precipitation purification (three times).

FIG. 35: Illustration showing features and embodiments of copolymers, according to certain embodiments disclosed herein, that are relevant to an application of the polymers for delivery of therapeutic agents, such including encapsulation of the therapeutic agents.

FIG. 36: Illustration showing features and embodiments of copolymers, according to certain embodiments disclosed herein, that are relevant to an application of the polymers for delivery of therapeutic agents, such including functionalization of repeating units with the therapeutic agents.

FIG. 37: Illustration showing features and embodiments of copolymers, according to certain embodiments disclosed herein, that are relevant to an application of the polymers for delivery of therapeutic agents, such as but not limited to hydrophilic therapeutic peptides and/or oligonucleotide-based therapeutics.

FIG. 38: Monomer Scope Investigation.

FIG. 39: Monomer Scope Investigation.

FIG. 40: Me-PTDO Shows Improved Reactivity Towards Polymerization.

FIG. 41: Me-PTDO Shows Improved Reactivity Towards Polymerization.

FIG. 42: Removal of Residual Catalyst in Me-PTDO Further Improved Reactivity.

FIG. 43: Computational Modeling to Estimate Ring Strain.

FIG. 44: Me-PTDO Monomer Degradation (³¹P-NMR).

FIG. 45: Me-PTDO Monomer Degradation (¹H-NMR).

FIG. 46: Poly(Me-PTDO) Degradation.

FIG. 47: MMP responsive Poly(Me-PTDO).

FIG. 48: Data pertaining to encapsulation of molecules, such as Nile Red dye, in nanoparticles of polymers, according to embodiments herein, under physiological conditions. Left side of FIG. 48 includes data from the following reference: Prasad, et al., Fabrication of nanostructures through self-assembly of non-ionic amphiphiles for biomedical applications” RSC Adv., 2017, 7, 22121-22132, DOI: 10.1039/C6RA28654B.

FIG. 49: A schematic showing features of a synthesis of PTDO monomer, according to embodiments herein.

FIG. 50: A schematic showing features of a synthesis of a polymer’s repeating units, according to embodiments herein, using a PTDO monomer.

FIG. 51: A schematic showing features of a synthesis of a polymer’s repeating units, according to embodiments herein, using a PTDO monomer and a bromopyridine modified Grubbs initiator (“I-Br”) [(IMesH₂)(C₅H₄NBr)₂(CI)₂Ru=CHPh].

FIG. 52: A schematic of a generalized method, according to some embodiments herein, for forming a polymer, or portion thereof, having degradable repeating units, according to certain embodiments herein.

FIG. 53: A schematic showing that an ester bond is split by a water molecule to give a carboxylic acid and an alcohol. A repeating unit having an ester bond may be a degradable unit of a polymer, for example.

FIG. 54: Synthetic approaches to degradable polymers via olefin metathesis polymerization. Four different approaches have been developed, including (i) acyclic diene metathesis polymerization (ADMET); (ii) entropy-driven ring-opening metathesis polymerization (entropy-driven ROMP); (iii) strain-induced or enthalpy-driven ring-opening metathesis polymerization (enthalpy-driven ROMP); and (iv) cascade enyne metathesis polymerization (CEMP).

FIG. 55: Structures of exemplary ruthenium-based olefin metathesis catalysts.

FIGS. 56A-E: Degradable polyphosphoramidate via low temperature ROMP. FIG. 56A: Schematic of PTDO polymerization and degradation. FIG. 56B: SEC traces of PPTDO of different lengths (DP = 55, 94, 216). FIG. 56C: Degradation of PPTDO and production of phosphoric acid monitored by ³¹P NMR. Condition: 0.25 M HCI in DMSO-d6 at RT. FIG. 56D: SEC traces of NBOEG homopolymer and NBOEG-PTDO random copolymer before and after acid treatment. FIG. 56E: Transmission electron microscopy (TEM) image of micellar nanoparticles assembled from NBOEG-PTDO random copolymer. Scale bar: 100 nm. [22], Copyright 2020. Adapted with permission from the American Chemical Society.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The following abbreviations may be used herein: MBHA refers to 4-methylbenzylhydrylamine; DMF refers to dimethylformaide; Acm refers to acetamidomethyl; TFA refers to trifluoroacetic acid; TIPS refers to triisopropyl silyl; RP-HPLC refers to reverse-phase high performance liquid chromatography; ESI-MS refers to electrospray ionization mass spectrometry; SEC-MALS refers to size-exclusion chromatography coupled with multiangle light scattering; and DP refers to degree of polymerization.

In an embodiment, a composition or compound of the invention is isolated or purified. In an embodiment, an isolated or purified compound is at least partially isolated or purified as would be understood in the art. In an embodiment, the composition or compound of the invention has a chemical purity of at least 95%, optionally for some applications at least 99%, optionally for some applications at least 99.9%, optionally for some applications at least 99.99%, and optionally for some applications at least 99.999% pure. The invention includes isolated and purified compositions of any of the polymers described herein.

As used herein, the term “polymer” refers to a molecule composed of repeating structural units connected by covalent chemical bonds often characterized by a number of repeating units, also referred to as base units (e.g., greater than or equal to 2 base units). As used herein, a term “polymer” is inclusive of an “oligomer” (i.e., an oligomer is a polymer; i.e., a polymer is optionally an oligomer). An “oligomer” refers to a molecule composed of repeating structural units, also referred to as base units, connected by covalent chemical bonds often characterized by a number of repeating units less such that the oligomer is a low molecular weight polymer. Preferably, but not necessarily, for example, an oligomer has equal to or less than 100 repeating units. Preferably, but not necessarily, for example, an oligomer has a lower molecular weight less than or equal to 10,000 Da. Oligomers may be the polymerization product of one or more monomer precursors. Polymerization of one or more monomers, or monomer precursors, resulting in formation of an oligomer may be referred to as oligomerization. An oligomer optionally includes 100 or less, 50 or less, 15 or less, 12 or less, 10 or less, or 5 or less repeating units (or, “base units”). An oligomer may be characterized has having a molecular weight of 10,000 Da or less, 5,000 Da or less, 1,000 Da or less, 500 Da or less, or 200 Da or less. A dimer, a trimer, a tetramer, or a pentamer is an oligomer having two, three, four, or five, respectively, repeating units, or base units. Polymers can have, for example, greater than 100 repeating units. Polymers can have, for example, a high molecular weight, such as greater than 10,000 Da, in some embodiments greater than or equal to 50,000 Da or greater than or equal to 100,000 Da. The term polymer includes homopolymers, or polymers consisting essentially of a single repeating monomer subunit. The term polymer also includes copolymers which are formed when two or more different types of monomers are linked in the same polymer. Copolymers may comprise two or more monomer subunits, and include random, block, brush, brush block, alternating, segmented, grafted, tapered and other architectures. Useful polymers include organic polymers or inorganic polymers that may be in amorphous, semi-amorphous, crystalline or semi-crystalline states. Polymer side chains capable of cross linking polymers (e.g., physical cross linking) may be useful for some applications. The invention provides polymers comprising therapeutic agents, such as brush polymers having at least a portion of the repeating units comprising side chains having therapeutic peptides and/or non-peptide therapeutic moieties. The polymers disclosed herein include one or more non-peptide therapeutic moieties.

Except where otherwise specified, the term “molecular weight” refers to an average molecular weight. Except where otherwise specified, the term “average molecular weight,” refers to number-average molecular weight. Number average molecular weight is defined as the total weight of a sample volume divided by the number of molecules within the sample. As is customary and well known in the art, peak average molecular weight and weight average molecular weight may also be used to characterize the molecular weight of the distribution of polymers within a sample.

The term “weight-average molecular weight” (M_{w}) refers to the average molecular weight defined as the sum of the products of the molecular weight of each polymer molecule (Mᵢ) multiplied by its weight fraction (wi): M_{w} = ΣWiMi. As is customary and well known in the art, peak average molecular weight and number average molecular weight may also be used to characterize the molecular weight of the distribution of polymers within a sample.

A “polypeptide” or “oligopeptide” herein are used interchangeably and refer to a polymer of repeating structural units connected by a peptide bond. Typically, the repeating structural units of the polypeptide are amino acids including naturally occurring amino acids, non-naturally occurring amino acids, analogues of amino acids or any combination of these. The number of repeating structural units of a polypeptide, as understood in the art, are typically less than a “protein”, and thus the polypeptide often has a lower molecular weight than a protein. Peptides and peptide moieties, as used and described herein, comprise two or more amino acid groups connected via peptide bonds.

Amino acids and amino acid groups refer to naturally-occurring amino acids, unnatural (non-naturally occurring) amino acids, and/or combinations of these. Naturally-occurring amino acids are those encoded by the genetic code, as well as those amino acids that are later modified, e.g., hydroxyproline, γ-carboxyglutamate, and O-phosphoserine. Naturally-occurring α-amino acids include, without limitation, alanine (Ala), cysteine (Cys), aspartic acid (Asp), glutamic acid (Glu), phenylalanine (Phe), glycine (Gly), histidine (His), isoleucine (Ile), arginine (Arg), lysine (Lys), leucine (Leu), methionine (Met), asparagine (Asn), proline (Pro), glutamine (Gln), serine (Ser), threonine (Thr), valine (Val), tryptophan (Trp), tyrosine (Tyr), and combinations thereof. Stereoisomers of a naturally-occurring α-amino acids include, without limitation, D-alanine (D-Ala), D-cysteine (D-Cys), D-aspartic acid (D-Asp), D-glutamic acid (D-Glu), D-phenylalanine (D-Phe), D-histidine (D-His), D-isoleucine (D-Ile), D-arginine (D-Arg), D-lysine (D-Lys), D-leucine (D-Leu), D-methionine (D-Met), D-asparagine (D-Asn), D-proline (D-Pro), D-glutamine (D-Gln), D-serine (D-Ser), D-threonine (D-Thr), D-valine (D-Val), D-tryptophan (D-Trp), D-tyrosine (D-Tyr), and combinations thereof.

Unnatural (non-naturally occurring) amino acids include, without limitation, amino acid analogs, amino acid mimetics, synthetic amino acids, N-substituted glycines, and N-methyl amino acids in either the L- or D-configuration that function in a manner similar to the naturally-occurring amino acids. For example, “amino acid analogs” can be unnatural amino acids that have the same basic chemical structure as naturally-occurring amino acids (i.e., a carbon that is bonded to a hydrogen, a carboxyl group, an amino group) but have modified side-chain groups or modified peptide backbones, e.g., homoserine, norleucine, methionine sulfoxide, methionine methyl sulfonium. “Amino acid mimetics” refer to chemical compounds that have a structure that is different from the general chemical structure of an amino acid, but that functions in a manner similar to a naturally-occurring amino acid. Amino acids may be referred to herein by either the commonly known three letter symbols or by the one-letter symbols recommended by the IUPAC-IUB Biochemical Nomenclature Commission.

“Block copolymers” are a type of copolymer comprising blocks or spatially segregated domains, wherein different domains comprise different polymerized monomers, for example, including at least two chemically distinguishable blocks. Block copolymers may further comprise one or more other structural domains, such as hydrophobic groups, hydrophilic groups, etc. In a block copolymer, adjacent blocks are constitutionally different, i.e. adjacent blocks comprise constitutional units derived from different species of monomer or from the same species of monomer but with a different composition or sequence distribution of constitutional units. Different blocks (or domains) of a block copolymer may reside on different ends or the interior of a polymer (e.g. [A][B]), or may be provided in a selected sequence ([A][B][A][B]). “Diblock copolymer” refers to block copolymer having two different polymer blocks. “Triblock copolymer” refers to a block copolymer having three different polymer blocks, including compositions in which two non-adjacent blocks are the same or similar. “Pentablock” copolymer refers to a copolymer having five different polymer including compositions in which two or more non-adjacent blocks are the same or similar.

“Polymer backbone group” refers to groups that are covalently linked to make up a backbone of a polymer, such as a block copolymer. Polymer backbone groups may be linked to side chain groups, such as polymer side chain groups. Some polymer backbone groups useful in the present compositions are derived from polymerization of a monomer selected from the group consisting of a substituted or unsubstituted, olefin, vinyl, acrylate, acrylamide, cyclic olefin, norbornene, norbornene anhydride, cyclooctene, cyclopentadiene, styrene and acrylate. Some polymer backbone groups useful in the present compositions are obtained from metal-free photoinduced reversible-deactivation radical polymerization (photo-RDRP), photo-electron transfer reversible addition-fragmentation transfer polymerization (PET-RAFT), and/or photoinitiated polymerization-induced self-assembly (photo-PISA). Polymer backbones may terminate (e.g., by coupling, disproportionation, or chain transfer) in a range of backbone terminating groups including, but not limited to, hydrogen, C₁-C₁₀ alkyl, C₃-C₁₀ cycloalkyl, C₅-C₁₀ aryl, C₅-C₁₀ heteroaryl, C₁-C₁₀ acyl, C₁-C₁₀ hydroxyl, C₁-C₁₀ alkoxy, C₂-C₁₀ alkenyl, C₂-C₁₀ alkynyl, C₅-C₁₀ alkylaryl,-CO₂R³⁰, -CONR³¹R³², -COR³³,-SOR³⁴, -OSR³⁵, -SO₂R³⁶,-OR³⁷, -SR³⁸, -NR³⁹R⁴⁰, -NR⁴¹COR⁴², C₁-C₁₀ alkyl halide, phosphonate, phosphonic acid, silane, siloxane, acrylate, catechol, or any combinations thereof; wherein each of R³⁰-R⁴² is independently hydrogen, C₁-C₁₀ alkyl or C₅-C₁₀ aryl. A polymer backbone may terminate in backbone terminating groups that is a portion or moiety from a chain transfer used during polymerization of the polymer. A backbone terminating group may be a polymer-terminating group. A “polymer-terminating group” is a group or moiety at a terminal end of a polymer and which terminates a polymer backbone.

The symbol “/” indicates that the units separated thereby are covalently linked randomly or in any order. For example, in a copolymer characterized by formula FX3 (Q¹-[U¹]ᵤ-/-[U²]_{q}-Q²), while the total DP of the first repeating units ([U¹]) is equal to the integer u and the total DP of the second repeating units ([U²]) is equal to the integer q, the arrangement of the copolymer may be as block copolymer, an alternating copolymer, a random copolymer, a graft copolymer, or any combination of these. In the latter illustrative example, at any portion of the polymer any number of first repeating units may be followed by any number of second repeating units, subject to the formula and DP dictated by the given formula FX3, for example.

As used herein, the term “chain transfer agent” refers to a compound that reacts with a growing polymer chain to interrupt growth and transfer the reactive species to a different compound (e.g., different polymer chain, monomer, or polymerizable monomer). The chain transfer agent can help regulate the average molecular weight of a polymer by terminating polymerization. The terms “chain transfer agent” and “chain termination agent” are intended to be equivalent and interchangeable.

“Polymer side chain group” refers to a group covalently linked (directly or indirectly) to a polymer backbone group that comprises a polymer side chain, optionally imparting steric properties to the polymer. In an embodiment, for example, a polymer side chain group is characterized by a plurality of repeating units having the same, or similar, chemical composition. A polymer side chain group may be directly or indirectly linked to the polymer backbone groups. In some embodiments, polymer side chain groups provide steric bulk and/or interactions that result in an extended polymer backbone and/or a rigid polymer backbone. Some polymer side chain groups useful in the present compositions include unsubstituted or substituted polypeptide groups. Some polymers useful in the present compositions comprise repeating units obtained via anionic polymerization, cationic polymerization, free radical polymerization, group transfer polymerization, a photopolymerization, a ring-opening polymerization, metal-free photoinduced reversible-deactivation radical polymerization (photo-RDRP), photoelectron transfer reversible addition-fragmentation transfer polymerization (PET-RAFT), and/or photoinitiated polymerization-induced self-assembly (photo-PISA). A polymer side chain may terminate in a wide range of polymer side chain terminating groups including hydrogen, C₁-C₁₀ alkyl, C₃-C₁₀ cycloalkyl, C₅-C₁₀ aryl, C₅-C₁₀ heteroaryl, C₁-C₁₀ acyl, C₁-C₁₀ hydroxyl, C₁-C₁₀ alkoxy, C₂-C₁₀ alkenyl, C₂-C₁₀ alkynyl, C₅-C₁₀ alkylaryl,-CO₂R³⁰, -CONR³¹R³², -COR³³,-SOR³⁴, -OSR³⁵, -SO₂R³⁶,-OR³⁷, -SR³⁸, -NR³⁹R⁴⁰, -NR⁴¹COR⁴², C₁-C₁₀ alkyl halide, phosphonate, phosphonic acid, silane, siloxane acrylate, or catechol; wherein each of R³⁰-R⁴² is independently hydrogen or C₁-C₅ alkyl.

As used herein, the term “brush polymer” refers to a polymer comprising repeating units each independently comprising a polymer backbone group directly or indirectly covalently linked to at least one polymer side chain group. A brush polymer may be characterized by brush density, which refers to the percentage of the repeating units in a brush polymer that comprise a polymer side chain group. Brush polymers of certain aspects are characterized by a brush density greater than or equal to 50% (e.g., greater than or equal to 60%, greater than or equal to 65%, greater than or equal to 70%, greater than or equal to 75%, greater than or equal to 80%, greater than or equal to 85%, or greater than or equal to 90%), optionally for some embodiments a density greater than or equal to 70%, or optionally for some embodiments a density greater than or equal to 90%. Brush polymers of certain aspects are characterized by a brush density selected from the range 50% to 100%, optionally some embodiments a density selected from the range of 75% to 100%, or optionally for some embodiments a density selected from the range of 90% to 100%.

The terms “monomer” or “polymerizable monomer” can be used interchangeably and refer to a monomer precursor capable of undergoing polymerization as described herein to form a polymer according to embodiments described herein. The term “polymerizable monomer” is also interchangeably referred to herein as a “monomer precursor.” Generally, the “monomer” or “polymerizable monomer” comprises an olefin capable of undergoing polymerization as described herein.

The term “ROMP-polymerized monomer” refers to a group, moiety, or monomer unit resulting from or produced by ring opening metathesis polymerization (ROMP) of a ROMP-polymerizable monomer, ROMP-polymerizable monomeric group, or ROMP-polymerizable monomer group/moiety thereof. A ROMP-polymerizable monomer, ROMP-polymerizable monomeric group, or ROMP-polymerizable monomer group/moiety thereof comprises a strained olefin group and may be, but is not necessarily, a cyclic (including bicyclic, tricyclic, etc.) monomer or monomeric group. For example, a ROMP-polymerizable monomer, ROMP-polymerizable monomeric group, or ROMP-polymerizable monomer group/moiety thereof may be or may comprise a substituted or unsubstituted norbornene, cyclic olefin, bicyclic olefin, norbornene anhydride, cyclooctene, cyclopentadiene, or any combination of these. In embodiments, for example, a (ROMP-polymerizable) monomer comprising a cyclopentene and/or cycloheptene group may be ROMP-polymerized resulting in a ROMP-polymerized monomer having a cyclopentane and/or cycloheptane group. The term “ROMP-polymerization product” refers to the ROMP-polymerized monomer unit or repeating unit or group or moiety thereof. As merely an illustrative example, each first repeating unit characterized by formula FX1 may be characterized as a ROMP-polymerization product of a monomer characterized by formula FX20.

The term “strained” in reference to a chemical species or group, such as a “strained olefin group”, refers to a chemical species or group that has a higher internal energy, due to strain, compared to a strain-free reference. Strain refers to a form of deformation. In an embodiment, strain refers to a compression or expansion of one or more bonds compared the lowest internal energy state equilibrium state of the bond. In an embodiment, a strain-free reference is the chemical species or group in its lowest internal energy equilibrium state.

The terms “monomer unit,” “repeating monomer unit,” “repeating unit,” and “polymerized monomer” can be used interchangeably and refer to a monomeric portion of a polymer described herein which is derived from or is a product of polymerization of one individual “monomer” or “polymerizable monomer.” Each individual monomer unit of a polymer is derived from or is a product of polymerization of one polymerizable monomer. Generally, each individual “monomer unit” or “repeating unit” of a polymer comprises one (polymerized) polymer backbone group. For example, in a polymer that comprises monomer units X and Y arranged as X-Y-X-Y-X-Y-X-Y (where each X is identical to each other X and each Y is identical to each other Y), each X and each Y independently can be referred to as a repeating unit or monomer unit.

As used herein, the term “degree of polymerization” refers to the average number of monomer units or repeating units per polymer chain. The term “degree of polymerization” may be used to characterized number of repeating units defining an entire polymer, a polymer block thereof, or a polymerized chain moiety thereof, such as a side chain moiety or a (poly)peptide moiety. In embodiments, a degree of polymerization of a polymer refers to the average total number of repeating monomer units in the polymer. For example, a degree of polymerization of a polymer defined by formula FX2 (Q¹-[U¹]ᵤ-Q²), refers to the average total number of first repeating monomer units ([U¹]) in the polymer, or, in other words, the integer u, in this example. For example, a degree of polymerization of a polymer defined by formula FX3 (Q¹-[U¹]ᵤ-/-[U²]_{q}-Q²), refers to the average sum total of first repeating monomer units ([U¹]) and second repeating monomer units ([U²]) in the polymer, or, in other words, the sum of the integers u and q, in this example. For example, a degree of polymerization of a polymer defined by formula FX16 (Q¹-[U²]_{q}-[U¹]ᵤ-/-[U³]_{g}-Q²), refers to the average sum total of first repeating monomer units ([U¹]), second repeating monomer units ([U²]), and third repeating monomer units ([U³]) in the polymer, or, in other words, the sum of the integers u and q and g, in this example. For example, a degree of polymerization of just the first repeating units in a polymer defined by formula FX3 (Q¹-[U¹]ᵤ-/-[U²]_{q}-Q²), refers to the average number of first repeating monomer units ([U¹]) in the polymer, or, in other words, the integer u, in this example. For example, a degree of polymerization of just the second repeating units in a polymer defined by formula FX3 (Q¹-[U¹]ᵤ-/-[U²]_{q}-Q²), refers to the average number of second repeating monomer units ([U²]) in the polymer, or, in other words, the integer q, in this example. For example, a degree of polymerization of a peptide or polypeptide refers to the number of amino acids forming the peptide. For example, a peptide whose amino acid sequence consists of the sequence GGSGSGK (SEQ ID NO:3), has a degree of polymerization of 7 because the amino acid sequence GGSGSGK (SEQ ID NO:3) has 7 amino acids. Since the degree of polymerization can vary from polymer to polymer, the degree of polymerization is generally represented by an average which can be determined by, for example, size-exclusion chromatography with a multiangle light scattering detector (SEC-MALS). The degree of polymerization can be calculated by the number-average molecular weight of polymer (e.g., determined by SEC-MALS) dividing by the molar mass of the monomer.

As used herein, the terms “peptide density” and “peptide graft density” interchangeably refer to the percentage of monomer units in the polymer chain which have a peptide covalently linked thereto. The percentage is based on the overall sum of monomer units in the polymer chain. For example, for certain polymers described herein, each P¹ is the polymer side chain comprising the peptide, each P² is a polymer side chain having a composition different from that of P¹, and each S is independently a repeating unit having a composition different from P¹ and P². Thus, the peptide density of P¹, or percentage of monomer units comprising the peptide of P¹ (i.e., P¹ for this particular example) would be represented by the formula:

$$\frac{{P}^{1}}{{P}^{1} + {P}^{2} + S} \times 100 ,$$

where each variable refers to the number of monomer units of that type in the polymer chain.

In an aspect, the polymer side chain groups can have any suitable spacing on the polymer backbone. Typically, the space between adjacent polymer side chain groups is from 3 angstroms to 30 angstroms, and optionally 5 to 20 angstroms and optionally 5 to 10 angstroms. By way of illustration, in certain embodiments having a brush density of 100%, the polymer side chain groups typically are spaced 6 ± 5 angstroms apart on the polymer backbone. In some embodiments the brush polymer has a high a brush density (e.g. greater than 70%), wherein the polymer side chain groups are spaced 5 to 20 angstroms apart on the polymer backbone.

The terms “analog” and “analogue” are used interchangeably and are used in accordance with their plain ordinary meaning within Chemistry and Biology and refers to a chemical compound that is structurally similar to another compound (i.e., a so-called “reference” compound) but differs in composition, e.g., in the replacement of one atom by an atom of a different element, or in the presence of a particular functional group, or the replacement of one functional group by another functional group, or the absolute stereochemistry of one or more chiral centers of the reference compound, including isomers thereof. Accordingly, an analog is a compound that is similar or comparable in function and appearance but not in structure or origin to a reference compound. The analogue can be a natural analogue or a synthetic analogue. In embodiments, a peptide analogue has five or fewer substituted or unsubstituted amino acids, or derivatives thereof, that are different, removed, added, or any combination of these, with respect to the reference peptide.

The term “sequence homology” or “sequence identity” means the proportion of amino acid matches between two amino acid sequences. When sequence homology is expressed as a percentage, e.g., 50%, the percentage denotes the fraction of matches over the length of sequence that is compared to some other sequence. Gaps (in either of the two sequences) are permitted to maximize matching; for example, wherein gap lengths of 5 amino acids or less, optionally 3 amino acids or less, are usually used.

The term “fragment” refers to a portion, but not all of, a composition or material, such as a polypeptide composition or material. In an embodiment, a fragment of a polypeptide refers to 50% or more of the sequence of amino acids, optionally 70% or more of the sequence of amino acids and optionally 90% or more of the sequence of amino acids.

As used herein, the term “group” may refer to a functional group of a chemical compound. Groups of the present compounds refer to an atom or a collection of atoms that are a part of the compound. Groups of the present invention may be attached to other atoms of the compound via one or more covalent bonds. Groups may also be characterized with respect to their valence state. The present invention includes groups characterized as monovalent, divalent, trivalent, etc. valence states.

The term “moiety” refers to a group, such as a functional group, of a chemical compound or molecule. A moiety is a collection of atoms that are part of the chemical compound or molecule. The present invention includes moieties characterized as monovalent, divalent, trivalent, etc. valence states. Generally, but not necessarily, a moiety comprises more than one functional group. A “peptide moiety” is a moiety or group that comprises or consists of a peptide.

As used herein, the term “substituted” refers to a compound wherein one or more hydrogens is replaced by another functional group, provided that the designated atom’s normal valence is not exceeded. An exemplary substituent includes, but is not limited to: a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR’), a sulfide (e.g., RSR’), a phosphate (ROP(=O)(OH)₂), an azo (RNNR’), a cyanate (ROCN), an amine (e.g., primary, secondary, or tertiary), an imine (RC(=NH)R′), a nitrile (RCN), a pyridinyl (or pyridyl), a diamine, a triamine, an azide, a diimine, a triimine, an amide, a diimide, or an ether (ROR’); where each of R and R′ is independently a hydrogen or a substituted or unsubstituted alkyl group, aryl group, alkenyl group, or a combination of these. Optional substituent functional groups are also described below. In some embodiments, the term substituted refers to a compound wherein each of more than one hydrogen is replaced by another functional group, such as a halogen group. For example, when the substituent is oxo (i.e., ═O), then two hydrogens on the atom are replaced. The substituent group can be any substituent group described herein. For example, substituent groups can include one or more of a hydroxyl, an amino (e.g., primary, secondary, or tertiary), an aldehyde, a carboxylic acid, an ester, an amide, a ketone, nitro, an urea, a guanidine, cyano, fluoroalkyl (e.g., trifluoromethane), halo (e.g., fluoro), aryl (e.g., phenyl), heterocyclyl or heterocyclic group (i.e., cyclic group, e.g., aromatic (e.g., heteroaryl) or non-aromatic where the cyclic group has one or more heteroatoms), oxo, or combinations thereof. Combinations of substituents and/or variables are permissible provided that the substitutions do not significantly adversely affect synthesis or use of the compound.

As used herein, the term “derivative” refers to a compound wherein an atom or functional group is replaced by another atom or functional group (e.g., a substituent function group as also described below), including, but not limited to: a hydrogen, a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR’), a sulfide (e.g., RSR’), a phosphate (ROP(=O)(OH)₂), an azo (RNNR’), a cyanate (ROCN), an amine (e.g., primary, secondary, or tertiary), an imine (RC(=NH)R′), a nitrile (RCN), a pyridinyl (or pyridyl), a diamine, a triamine, an azide, a diimine, a triimine, an amide, a diimide, or an ether (ROR’); where each of R and R′ is independently a hydrogen or a substituted or unsubstituted alkyl group, aryl group, alkenyl group, or a combination of these. Optional substituent functional groups are also described below. Preferably, the term “derivative” refers to a compound wherein one or two atoms or functional groups are independently replaced by another atom or functional group. Preferably, the term derivative does not refer to or include replacement of a chalcogen atom (S, Se) that is a member of a heterocyclic group. Preferably, the term derivative does not refer to or include replacement of a chalcogen atom (S, Se) nor a N (nitrogen) where the chalcogen atom and the N are members same heterocyclic group. Preferably, but not necessarily, the term derivative does not include breaking a ring structure, replacement of a ring member, or removal of a ring member.

Unless otherwise specified, the term “average molecular weight,” refers to number average molecular weight. Number average molecular weight is the defined as the total weight of a sample volume divided by the number of molecules within the sample. As is customary and well known in the art, peak average molecular weight and weight average molecular weight may also be used to characterize the molecular weight of the distribution of polymers within a sample.

As is customary and well known in the art, hydrogen atoms in formulas presented throughout herein, such as, but not limited to formulas FX1, FX6-13, FX15, FX17, and FX19-45 are not always explicitly shown, for example, hydrogen atoms bonded to the carbon atoms of aromatic, heteroaromatic, and alicyclic rings are not always explicitly shown in formulas presented herein. The structures provided herein, for example in the context of the description of formulas just listed and schematics and structures in the drawings, are intended to convey to one of reasonable skill in the art the chemical composition of compounds of the methods and compositions of the invention, and as will be understood by one of skill in the art, the structures provided do not indicate the specific positions and/or orientations of atoms and the corresponding bond angles between atoms of these compounds.

As used herein, the terms “alkylene” and “alkylene group” are used synonymously and refer to a divalent group derived from an alkyl group as defined herein. The invention includes compounds having one or more alkylene groups. Alkylene groups in some compounds function as linking and/or spacer groups. Compounds of the invention may have substituted and/or unsubstituted C₁-C₂₀ alkylene, C₁-C₁₀ alkylene and C₁-C₅ alkylene groups, for example, as one or more linking groups (e.g. L¹-L²).

As used herein, the terms “cycloalkylene” and “cycloalkylene group” are used synonymously and refer to a divalent group derived from a cycloalkyl group as defined herein. The invention includes compounds having one or more cycloalkylene groups. Cycloalkyl groups in some compounds function as linking and/or spacer groups. Compounds of the invention may have substituted and/or unsubstituted C₃-C₂₀ cycloalkylene, C₃-C₁₀ cycloalkylene and C₃-C₅ cycloalkylene groups, for example, as one or more linking groups (e.g. L¹ - L²).

As used herein, the terms “arylene” and “arylene group” are used synonymously and refer to a divalent group derived from an aryl group as defined herein. The invention includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as linking and/or spacer groups. Arylene groups in some compounds function as chromophore, fluorophore, aromatic antenna, dye and/or imaging groups. Compounds of the invention include substituted and/or unsubstituted C₃-C₃₀ arylene, C₃-C₂₀ arylene, C₃-C₁₀ arylene and C₁-C₅ arylene groups, for example, as one or more linking groups (e.g. L¹ -L²).

As used herein, the terms “heteroarylene” and “heteroarylene group” are used synonymously and refer to a divalent group derived from a heteroaryl group as defined herein. The invention includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as linking and/or spacer groups. Heteroarylene groups in some compounds function as chromophore, aromatic antenna, fluorophore, dye and/or imaging groups. Compounds of the invention include substituted and/or unsubstituted C₃-C₃₀ heteroarylene, C₃-C₂₀ heteroarylene, C₁-C₁₀ heteroarylene and C₃-C₅ heteroarylene groups, for example, as one or more linking groups (e.g. L¹ - L²).

As used herein, the terms “alkenylene” and “alkenylene group” are used synonymously and refer to a divalent group derived from an alkenyl group as defined herein. The invention includes compounds having one or more alkenylene groups. Alkenylene groups in some compounds function as linking and/or spacer groups. Compounds of the invention include substituted and/or unsubstituted C₂-C₂₀ alkenylene, C₂-C₁₀ alkenylene and C₂-C₅ alkenylene groups, for example, as one or more linking groups (e.g. L¹ - L²).

As used herein, the terms “cycloalkenylene” and “cycloalkenylene group” are used synonymously and refer to a divalent group derived from a cycloalkenyl group as defined herein. The invention includes compounds having one or more cycloalkenylene groups. Cycloalkenylene groups in some compounds function as linking and/or spacer groups. Compounds of the invention include substituted and/or unsubstituted C₃-C₂₀ cycloalkenylene, C₃-C₁₀ cycloalkenylene and C₃-C₅ cycloalkenylene groups, for example, as one or more linking groups (e.g. L¹ - L²).

As used herein, the terms “alkynylene” and “alkynylene group” are used synonymously and refer to a divalent group derived from an alkynyl group as defined herein. The invention includes compounds having one or more alkynylene groups. Alkynylene groups in some compounds function as linking and/or spacer groups. Compounds of the invention include substituted and/or unsubstituted C₂-C₂₀ alkynylene, C₂-C₁₀ alkynylene and C₂-C₅ alkynylene groups, for example, as one or more linking groups (e.g. L¹-L²).

As used herein, the term “halo” refers to a halogen group such as a fluoro (—F), chloro (—Cl), bromo (—Br), iodo (—I) or astato (—At).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and functional groups, for example, provided as substituents.

The term “carbocyclic” refers to ring structures containing only carbon atoms in the ring. Carbon atoms of carbocyclic rings can be bonded to a wide range of other atoms and functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy)ₙ-alkoxy wherein n is an integer from 1 to 10, preferably 1 to 4, and more preferably for some embodiments 1 to 3.

Amino acids include glycine, alanine, valine, leucine, isoleucine, methionine, proline, phenylalanine, tryptophan, asparagine, glutamine, glycine, serine, threonine, serine, rhreonine, asparagine, glutamine, tyrosine, cysteine, lysine, arginine, histidine, aspartic acid and glutamic acid. As used herein, reference to “a side chain residue of a natural α-amino acid” specifically includes the side chains of the above-referenced amino acids. Peptides are comprised of two or more amino acids connected via peptide bonds.

Alkyl groups include straight-chain, branched and cyclic alkyl groups. Alkyl groups include those having from 1 to 30 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-30 carbon atoms. The term cycloalkyl specifically refers to an alky group having a ring structure such as ring structure comprising 3-30 carbon atoms, optionally 3-20 carbon atoms and optionally 2 - 10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, or 7-member ring(s). The carbon rings in cycloalkyl groups can also carry alkyl groups. Cycloalkyl groups can include bicyclic and tricycloalkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R-O and can also be referred to as an alkyl ether group. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups. As used herein MeO— refers to CH₃O—. Compositions of some embodiments of the invention comprise alkyl groups as terminating groups, such as polymer backbone terminating groups and/or polymer side chain terminating groups.

Alkenyl groups include straight-chain, branched and cyclic alkenyl groups. Alkenyl groups include those having 1, 2 or more double bonds and those in which two or more of the double bonds are conjugated double bonds. Alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6- or 7-member ring(s). The carbon rings in cycloalkenyl groups can also carry alkyl groups. Cycloalkenyl groups can include bicyclic and tricyclic alkenyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms. Compositions of some embodiments of the invention comprise alkenyl groups as terminating groups, such as polymer backbone terminating groups and/or polymer side chain terminating groups.

Aryl groups include groups having one or more 5-, 6- or 7- member aromatic rings, including heterocyclic aromatic rings. The term heteroaryl specifically refers to aryl groups having at least one 5-, 6- or 7- member heterocyclic aromatic rings. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those which are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein are provided in a covalently attached configuration in the compounds of the invention at any suitable point of attachment. In embodiments, aryl groups contain between 5 and 30 carbon atoms. In embodiments, aryl groups contain one aromatic or heteroaromatic six-membered ring and one or more additional five- or six-membered aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents. Compositions of some embodiments of the invention comprise aryl groups as terminating groups, such as polymer backbone terminating groups and/or polymer side chain terminating groups. As used herein “-(phenyl)” refers to a monovalent phenyl group bonded with another group, element, or compound.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms. Compositions of some embodiments of the invention comprise arylalkyl groups as terminating groups, such as polymer backbone terminating groups and/or polymer side chain terminating groups.

As to any of the groups described herein which contain one or more substituents, it is understood that such groups do not contain any substitution or substitution patterns which are sterically impractical and/or synthetically non-feasible. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for any alkyl, alkenyl and aryl group includes substitution with one or more of the following substituents, among others:
halogen, including fluorine, chlorine, bromine or iodine;
pseudohalides, including —CN;
-COOR where R is a hydrogen or an alkyl group or an aryl group and more specifically where R is a methyl, ethyl, propyl, butyl, or phenyl group all of which groups are optionally substituted;
-COR where R is a hydrogen or an alkyl group or an aryl group and more specifically where R is a methyl, ethyl, propyl, butyl, or phenyl group all of which groups are optionally substituted;
–CON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
–OCON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
–N(R)₂ where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring which can contain one or more double bonds and can contain one or more additional carbon atoms;
-SR, where R is hydrogen or an alkyl group or an aryl group and more specifically where R is hydrogen, methyl, ethyl, propyl, butyl, or a phenyl group, which are optionally substituted;
—SO₂, or -SOR where R is an alkyl group or an aryl group and more specifically where R is a methyl, ethyl, propyl, butyl, or phenyl group, all of which are optionally substituted;
-OCOOR where R is an alkyl group or an aryl group;
-SO₂N(R)₂ where each R, independently of each other R, is a hydrogen, or an alkyl group, or an aryl group all of which are optionally substituted and wherein R and R can form a ring which can contain one or more double bonds and can contain one or more additional carbon atoms; and
-OR where R is H, an alkyl group, an aryl group, or an acyl group all of which are optionally substituted. In a particular example R can be an acyl yielding -OCOR″ where R″ is a hydrogen or an alkyl group or an aryl group and more specifically where R″ is methyl, ethyl, propyl, butyl, or phenyl groups all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups which contain one or more substituents, it is understood that such groups do not contain any substitution or substitution patterns which are sterically impractical and/or synthetically non-feasible.

Certain compounds of the present invention possess asymmetric carbon atoms (optical or chiral centers) or double bonds; the enantiomers, racemates, diastereomers, tautomers, geometric isomers, stereoisometric forms that may be defined, in terms of absolute stereochemistry, as (R)- or (S)— or, as D- or L- for amino acids, and individual isomers are encompassed within the scope of the present invention. The compounds of the present invention do not include those which are known in art to be too unstable to synthesize and/or isolate. The present invention is meant to include compounds in racemic and optically pure forms. Optically active (R)- and (S)—, or D- or L -isomers may be prepared using chiral synthons or chiral reagents, or resolved using conventional techniques. When the compounds described herein contain olefinic bonds or other centers of geometric asymmetry, and unless specified otherwise, it is intended that the compounds include both E and Z geometric isomers.

Many of the molecules disclosed herein contain one or more ionizable groups. Ionizable groups include groups from which a proton can be removed (e.g., —COOH) or added (e.g., amines) and groups that can be quaternized (e.g., amines). All possible ionic forms of such molecules and salts thereof are intended to be included individually in the disclosure herein. With regard to salts of the compounds herein, one of ordinary skill in the art can select from among a wide variety of available counterions that are appropriate for preparation of salts of this invention for a given application. In specific applications, the selection of a given anion or cation for preparation of a salt can result in increased or decreased solubility of that salt.

As used herein, the term “isomers” refers to compounds having the same number and kind of atoms, and hence the same molecular weight, but differing in respect to the structural arrangement or configuration of the atoms. Isomers include structural isomers and stereoisomers such as enantiomers.

The term “tautomer,” as used herein, refers to one of two or more structural isomers which exist in equilibrium and which are readily converted from one isomeric form to another. It will be apparent to one skilled in the art that certain compounds of this invention may exist in tautomeric forms, all such tautomeric forms of the compounds being within the scope of the invention.

Unless otherwise stated, structures depicted herein are also meant to include all stereochemical forms of the structure; i.e., the R and S configurations for each asymmetric center. Therefore, single stereochemical isomers as well as enantiomeric and diastereomeric mixtures of the present compounds are within the scope of the invention.

Unless otherwise stated, structures depicted herein are also meant to include compounds which differ only in the presence of one or more isotopically enriched atoms. For example, compounds having the present structures except for the replacement of a hydrogen by a deuterium or tritium, or the replacement of a carbon by ¹³C- or ¹⁴C-enriched carbon are within the scope of this invention.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I), or carbon-14 (¹⁴C). All isotopic variations of the compounds of the present invention, whether radioactive or not, are encompassed within the scope of the present invention.

The symbol

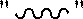

denotes the point of attachment of one or more chemical moieties, one or more functional groups, one or more atoms, one or more ions, an unpaired electron, or one or more other chemical species to the represented molecule, compound, or chemical formula. For example, in the formula

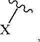

“X” represents a molecule or compound, the symbol “〰” denotes a point of attachment of one or more chemical moieties, one or more functional groups, one or more atoms, one or more ions, an unpaired electron, or one or more other chemical species to X (where X corresponds to the represented molecule, compound, or chemical formula) via covalent bonding, wherein the covalent bonding can be any feasible covalent bond, including, but not limited to, a single bond, a double bond, or a triple bond. As an illustrative example, in the moiety

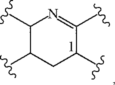

the carbon labeled “1” has point of attachment which can be a double bond to another species, such a double bond to an oxygen, or two single bonds to two independent species, such as two distinct single bonds each to a hydrogen. As another illustrative example, when two points of attachment are shown on a single atom of a molecule, such as in the moiety

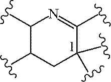

where the carbon labeled “1” has two points of attachment shown, the shown points of attachment on thesame single atom (e.g., carbon 1), can be interpreted as representing either a preferable embodiment of two distinct bonds to that same single atom (e.g., two hydrogens bonded to carbon 1) or an optional embodiment of a single point of attachment to said same single atom (e.g., the two points of attachment on carbon 1 can optionally be consolidated as representing one double to carbon 1, such as a double bond to oxygen). As used herein, the various functional groups represented will be understood to have a point of attachment at the functional group having the hyphen or dash (-) or a dash used in combination with an asterisk (*). In the case of —CH₂CH₂CH₃, it will be understood that the point of attachment is the CH₂ group at the far left. If a group is recited without an asterisk or a dash, then the attachment point is indicated by the plain and ordinary meaning” of the recited group.

As would be understood by one of skill in the art, “N(CH₃)” refers N attached to an methyl group (also abbreviated in art as “NMe”) and may also be represented as N-(CH₃), or —N(CH₃)— where the N is attached to two other groups or elements besides the methyl group. As would be understood by one of skill in the art, “N(C₂H₆)” refers to N attached to an ethyl group (also abbreviated in art as “NEt”) and may also be represented as N—(C₂H₆), or —N(C₂H₆)— where the N is attached to two other groups or elements besides the ethyl group.

Where substituent groups are specified by their conventional chemical formulae, written from left to right, they equally encompass the chemically identical substituents that would result from writing the structure from right to left, e.g., —CH₂0— is equivalent to —OCH₂—.

Where used, a bond represented by

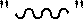

(a squiggly or wavy line) and drawn between any two elements, groups, or species refers to a bond having any angle or geometry, such as in the case of a chemical species exhibiting stereochemistry such as chirality. For example, the compound characterized by formula (FX100):

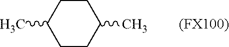

may correspond to one or more compounds, such as those characterized by the formulas (FX100a), (FX100b), (FX100c), and (FX100d):

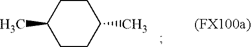

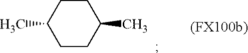

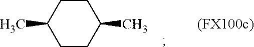

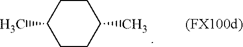

It must also be noted that a bond represented as a non-wavy or non-squiggly line, such as a “-”, may exhibit more than one stereochemical configuration, such as chirality. In other words, the compound characterized by formula (FX100e):

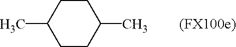

may correspond to one or more compounds, such as those characterized by the formulas (FX100a), (FX100b), (FX100c), and (FX100d).

When referring to a material, such as a polymer, being aqueous, the term “aqueous” refers to said material being dispersed, dissolved, or otherwise solvated by water. An “aqueous solution” refers to a solution that comprises water as solvent and one or more solute species dispersed, dissolved, or otherwise solvated by the water. An aqueous process, such as a polymerization, is a process taking place in an aqueous solution. Optionally, but not necessarily, an aqueous solution or an aqueous solvent includes 20 vol.% or less, optionally 15 vol.% or less, optionally 10 vol.% or less, preferably 5 vol.% or less, of a non-water or organic species. Optionally, but not necessarily, an aqueous solution or an aqueous solvent includes 20 vol.% or less, optionally 15 vol.% or less, optionally 10 vol.% or less, preferably 5 vol.% or less, of a non-water liquid.

The terms “treating” or “treatment” refers to any indicia of success in the treatment or amelioration of an injury, disease, pathology or condition, including any objective or subjective parameter such as abatement; remission; diminishing of symptoms or making the injury, pathology or condition more tolerable to a subject, such as a patient in need of treatment; slowing in the rate of degeneration or decline; making the final point of degeneration less debilitating; improving a subject’s physical or mental well-being. The treatment or amelioration of symptoms can be based on objective or subjective parameters; including the results of a physical examination, neuropsychiatric exams, and/or a psychiatric evaluation. The term “treating,” and conjugations thereof, include prevention of an injury, pathology, condition, or disease.

An “effective amount” is an amount sufficient to accomplish a stated purpose (e.g. achieve the effect for which it is administered, treat a disease, reduce enzyme activity, increase enzyme activity, reduce transcriptional activity, increase transcriptional activity, reduce one or more symptoms of a disease or condition). An example of an “effective amount” is an amount sufficient to contribute to the treatment, prevention, or reduction of a symptom or symptoms of a disease, which could also be referred to as a “therapeutically effective amount.” A “reduction” of a symptom or symptoms (and grammatical equivalents of this phrase) means decreasing of the severity or frequency of the symptom(s), or elimination of the symptom(s). A “prophylactically effective amount” of a drug is an amount of a drug that, when administered to a subject, will have the intended prophylactic effect, e.g., preventing or delaying the onset (or reoccurrence) of an injury, disease, pathology or condition, or reducing the likelihood of the onset (or reoccurrence) of an injury, disease, pathology, or condition, or their symptoms. The full prophylactic effect does not necessarily occur by administration of one dose, and may occur only after administration of a series of doses. Thus, a prophylactically effective amount may be administered in one or more administrations. An “activity decreasing amount,” as used herein, refers to an amount of antagonist (inhibitor) required to decrease the activity of an enzyme or protein (e.g. transcription factor) relative to the absence of the antagonist. An “activity increasing amount,” as used herein, refers to an amount of agonist (activator) required to increase the activity of an enzyme or protein (e.g. transcription factor) relative to the absence of the agonist. A “function disrupting amount,” as used herein, refers to the amount of antagonist (inhibitor) required to disrupt the function of an enzyme or protein (e.g. transcription factor) relative to the absence of the antagonist. A “function increasing amount,” as used herein, refers to the amount of agonist (activator) required to increase the function of an enzyme or protein (e.g. transcription factor) relative to the absence of the agonist. The exact amounts will depend on the purpose of the treatment, and will be ascertainable by one skilled in the art using known techniques (see, e.g., Lieberman, Pharmaceutical Dosage Forms (vols. 1-3, 1992); Lloyd, The Art, Science and Technology of Pharmaceutical Compounding (1999); Pickar, Dosage Calculations (1999); and Remington: The Science and Practice of Pharmacy, 20th Edition, 2003, Gennaro, Ed., Lippincott, Williams & Wilkins).

As defined herein, the term “inhibition”, “inhibit”, “inhibiting” and the like in reference to a protein-inhibitor (e.g. antagonist) interaction means negatively affecting (e.g. decreasing) the activity or function of the protein relative to the activity or function of the protein in the absence of the inhibitor. In some embodiments inhibition refers to reduction of a disease or symptoms of disease. In some embodiments, inhibition refers to a reduction in the activity of a signal transduction pathway or signaling pathway. Thus, inhibition includes, at least in part, partially or totally blocking stimulation, decreasing, preventing, or delaying activation, or inactivating, desensitizing, or down-regulating signal transduction or enzymatic activity or the amount of a protein.

As defined herein, the term “activation”, “activate”, “activating” and the like in reference to a protein-activator (e.g. agonist) interaction means positively affecting (e.g. increasing) the activity or function of the protein

The term “modulator” refers to a composition that increases or decreases the level of a target molecule or the function of a target molecule.

“Patient”, “subject”, or “subject in need thereof” refers to a living organism suffering from or prone to a disease or condition that can be treated by administration of a compound or pharmaceutical composition, as provided herein. Non-limiting examples include humans, other mammals, bovines, rats, mice, dogs, monkeys, goat, sheep, cows, deer, and other non-mammalian animals. In some embodiments, a patient is human. In some embodiments, a patient is a mammal. In some embodiments, a patient is a mouse. In some embodiments, a patient is an experimental animal. In some embodiments, a patient is a rat. In some embodiments, a patient is a test animal.

“Pharmaceutically acceptable excipient” and “pharmaceutically acceptable carrier” refer to a substance that aids the administration of an active agent to and absorption by a subject and can be included in the compositions of the present invention without causing a significant adverse toxicological effect on the patient. Non-limiting examples of pharmaceutically acceptable excipients include water, NaCl, normal saline solutions, lactated Ringer’s, normal sucrose, normal glucose, binders, fillers, disintegrants, lubricants, coatings, sweeteners, flavors, salt solutions (such as Ringer’s solution), alcohols, oils, gelatins, carbohydrates such as lactose, amylose or starch, fatty acid esters, hydroxymethycellulose, polyvinyl pyrrolidine, and colors, and the like. Such preparations can be sterilized and, if desired, mixed with auxiliary agents such as lubricants, preservatives, stabilizers, wetting agents, emulsifiers, salts for influencing osmotic pressure, buffers, coloring, and/or aromatic substances and the like that do not deleteriously react with the compounds of the invention. One of skill in the art will recognize that other pharmaceutical excipients are useful in the present invention.

The term “preparation” is intended to include the formulation of the active compound with encapsulating material as a carrier providing a capsule in which the active component with or without other carriers, is surrounded by a carrier, which is thus in association with it. Similarly, cachets and lozenges are included. Tablets, powders, capsules, pills, cachets, and lozenges can be used as solid dosage forms suitable for oral administration.

As used herein, the term “administering” means oral administration, administration as a suppository, topical contact, intravenous, parenteral, intraperitoneal, intramuscular, intralesional, intrathecal, intracranial, intranasal or subcutaneous administration, or the implantation of a slow-release device, e.g., a mini-osmotic pump, to a subject. Administration is by any route, including parenteral and transmucosal (e.g., buccal, sublingual, palatal, gingival, nasal, vaginal, rectal, or transdermal). In embodiments, administration includes direct administration to a tumor. Parenteral administration includes, e.g., intravenous, intramuscular, intra-arteriole, intradermal, subcutaneous, intraperitoneal, intraventricular, and intracranial. Other modes of delivery include, but are not limited to, the use of liposomal formulations, intravenous infusion, transdermal patches, etc. By “co-administer” it is meant that a composition described herein is administered at the same time, just prior to, or just after the administration of one or more additional therapies (e.g. anti-cancer agent or chemotherapeutic). The compound of the invention can be administered alone or can be coadministered to the patient. Coadministration is meant to include simultaneous or sequential administration of the compound individually or in combination (more than one compound or agent). Thus, the preparations can also be combined, when desired, with other active substances (e.g. to reduce metabolic degradation). The compositions of the present invention can be delivered by transdermally, by a topical route, formulated as applicator sticks, solutions, suspensions, emulsions, gels, creams, ointments, pastes, jellies, paints, powders, and aerosols. Oral preparations include tablets, pills, powder, dragees, capsules, liquids, lozenges, cachets, gels, syrups, slurries, suspensions, etc., suitable for ingestion by the patient. Solid form preparations include powders, tablets, pills, capsules, cachets, suppositories, and dispersible granules. Liquid form preparations include solutions, suspensions, and emulsions, for example, water or water/propylene glycol solutions. The compositions of the present invention may additionally include components to provide sustained release and/or comfort. Such components include high molecular weight, anionic mucomimetic polymers, gelling polysaccharides and finely-divided drug carrier substrates. These components are discussed in greater detail in U.S. Pat. Nos. 4,911,920; 5,403,841; 5,212,162; and 4,861,760. The entire contents of these patents are incorporated herein by reference in their entirety for all purposes. The compositions of the present invention can also be delivered as microspheres for slow release in the body. For example, microspheres can be administered via intradermal injection of drug-containing microspheres, which slowly release subcutaneously (see Rao, J. Biomater Sci. Polym. Ed. 7:623-645, 1995; as biodegradable and injectable gel formulations (see, e.g., Gao Pharm. Res. 12:857-863, 1995); or, as microspheres for oral administration (see, e.g., Eyles, J. Pharm. Pharmacol. 49:669-674, 1997). In another embodiment, the formulations of the compositions of the present invention can be delivered by the use of liposomes which fuse with the cellular membrane or are endocytosed, i.e., by employing receptor ligands attached to the liposome, that bind to surface membrane protein receptors of the cell resulting in endocytosis. By using liposomes, particularly where the liposome surface carries receptor ligands specific for target cells, or are otherwise preferentially directed to a specific organ, one can focus the delivery of the compositions of the present invention into the target cells in vivo. (See, e.g., Al-Muhammed, J. Microencapsul. 13:293-306, 1996; Chonn, Curr. Opin. Biotechnol. 6:698-708, 1995; Ostro, Am. J. Hosp. Pharm.46:1576-1587, 1989).

As used herein, the term “conjugated” when referring to two moieties means the two moieties are bonded, wherein the bond or bonds connecting the two moieties may be covalent or non-covalent. In embodiments, the two moieties are covalently attached to each other (e.g. directly or through a covalently attached intermediary). In embodiments, the two moieties are non-covalently attached (e.g. through ionic bond(s), van der waal’s bond(s)/interactions, hydrogen bond(s), polar bond(s), or combinations or mixtures thereof).

The term “non-peptide therapeutic moiety” refers to a therapeutic moiety that is not a peptide or a polypeptide having at least 2 amino acids. A “therapeutic moiety” refers to a chemical moiety that: (i) can function as a therapeutic agent (or perform a therapeutic function), such as for a treatment when administered to or otherwise provided to a patient or subject; and (ii) is covalently attached to host or carrier compound or molecule, such as a polymer according to any of the embodiments disclosed herein. A therapeutic moiety is optionally a monovalent moiety. The therapeutic moiety is a therapeutic agent that is a therapeutically or pharmaceutically active therapeutic agent when attached to the polymer, when released from the polymer (such as via a chemical reaction), or both. A therapeutic agent is capable of treating or managing a condition, such as a disease, in a living patient or subject, such as a human or animal. A non-peptide therapeutic moiety is optionally a small molecule having a molecular weight below 4500 Da, optionally below 2000 Da, optionally below 1000 Da. Unless otherwise stated, a peptide or polypeptide of the invention can be a therapeutic peptide, which is a therapeutic moiety that is or that comprises a peptide or polypeptide. Optionally the term “peptide” can refer to a polypeptide.

Optionally in any of the polymers, compositions, methods, and liquid compositions disclosed herein, the number or degree of polymerization of all repeating units comprising a peptide chain (e.g., as part of a side chain moiety) is selected to provide for and/or enhance cellular uptake of the polymer or portion thereof. The number or degree of polymerization of all repeating units of an entire polymer comprising a peptide chain may be referred to as “DP_{w/peptide}”. Optionally, cellular uptake refers to cellular uptake of or penetration of a biological by at least a portion of the polymer, the majority of the polymer, or the entirety of the polymer. Cellular uptake can be measured or quantified, such as via absorbance or fluorescence signal unique to a portion of the polymer (such as the drug) using different cellular assays, UV-Vis absorption spectroscopy, fluorescence spectroscopy, radio labeling, mass-spectroscopy, and/or inductively coupled plasma mass spectrometry. Optionally in any of the polymers, methods, and liquid compositions disclosed herein, at least one of the plurality of peptide moieties is a non-cell-penetrating peptide. Optionally in any of the polymers, compositions, methods, and liquid compositions disclosed herein, each of at least 25%, each of at least 50%, of each at least 75%, or each of at least 95% of the peptide moieties of the polymer is a non-cell-penetrating peptide moiety. Optionally in any of the polymers, compositions, methods, and liquid compositions disclosed herein, the polymer has a net positive charge. Optionally, the net positive charge of the polymer is present at least when the polymer is exposed to physiological conditions, including normal physiological conditions. Optionally, any positive charge of the polymer is present at least when the polymer is exposed to physiological conditions, including normal physiological conditions. Optionally in any of the polymers, compositions, methods, and liquid compositions disclosed herein, at least one of the plurality of peptide moieties has a positive charge. The presence of a positive charge can increase or otherwise enhance the therapeutic activity or function of the polymer, or portions thereof such as of the non-peptide therapeutic(s) and any therapeutic peptides, if present. In embodiments, the presence of a positive charge on the polymer can increase or otherwise enhance the therapeutic activity or function of the polymer, or portions thereof at least because of the enhanced or improved cellular uptake efficiency of the polymer due to the presence of the positive charge. Optionally, polymers disclosed herein can penetrate or be taken up by a biological cell even when any, a majority, or even when all of the peptide sequences on said polymer do not correspond to cell-penetrating peptides. This is because peptide sequences that are not cell-penetrating peptides but that have at least a single positive charge are able to enter cells (cellular uptake) once polymerized as a high density brush of peptides, wherein, in contrast, the monomeric peptide alone would be unable to enter the cell. See also Blum, et al. (“Activating peptides for cellular uptake via polymerization into high density brushes.” A. P. Blum, J. K. Kammeyer and N. C. Gianneschi, Chem. Sci., 2016, 7, 989-994), which is incorporated herein by reference in its entirety to the extent not inconsistent herewith.

The term “cellular uptake” refers to any process or mechanism that results in a molecule, peptide, therapeutic agent, compound, polymer, or portion thereof, or material being transported either actively of passively across the cellular membrane of a biological cell.

The terms “cell” and “biological cell” are used interchangeably are refer to a cell carrying out metabolic or other function sufficient to preserve or replicate its genomic DNA. A cell can be identified by well-known methods in the art including, for example, presence of an intact membrane, staining by a particular dye, ability to produce progeny or, in the case of a gamete, ability to combine with a second gamete to produce a viable offspring. Cells may include prokaryotic and eukaryotic cells. Prokaryotic cells include but are not limited to bacteria. Eukaryotic cells include but are not limited to yeast cells and cells derived from plants and animals, for example mammalian, insect (e.g., spodoptera) and human cells. A “viable cell” is a living biological cell.

The term “pharmaceutically acceptable salts” is meant to include salts of the active compounds that are prepared with relatively nontoxic acids or bases, depending on the particular substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of pharmaceutically acceptable base addition salts include sodium, potassium, calcium, ammonium, organic amino, or magnesium salt, or a similar salt. When compounds of the present invention contain relatively basic functionalities, acid addition salts can be obtained by contacting the neutral form of such compounds with a sufficient amount of the desired acid, either neat or in a suitable inert solvent. Examples of pharmaceutically acceptable acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids and the like, as well as the salts derived from relatively nontoxic organic acids like acetic, propionic, isobutyric, maleic, malonic, benzoic, succinic, suberic, fumaric, lactic, mandelic, phthalic, benzenesulfonic, p-tolylsulfonic, citric, tartaric, methanesulfonic, and the like. Also included are salts of amino acids such as arginate and the like, and salts of organic acids like glucuronic or galactunoric acids and the like (see, e.g., Berge et al., Journal of Pharmaceutical Science 66:1-19 (1977)). Certain specific compounds of the present invention contain both basic and acidic functionalities that allow the compounds to be converted into either base or acid addition salts. Other pharmaceutically acceptable carriers known to those of skill in the art are suitable for the present invention. Salts tend to be more soluble in aqueous or other protonic solvents that are the corresponding free base forms. In other cases, the preparation may be a lyophilized powder in 1 mM-50 mM histidine, 0.1%-2% sucrose, 2%-7% mannitol at a pH range of 4.5 to 5.5, that is combined with buffer prior to use.

Thus, the compounds of the present invention may exist as salts, such as with pharmaceutically acceptable acids. The present invention includes such salts. Examples of such salts include hydrochlorides, hydrobromides, sulfates, methanesulfonates, nitrates, maleates, acetates, citrates, fumarates, tartrates (e.g., (+)-tartrates, (-)-tartrates, or mixtures thereof including racemic mixtures), succinates, benzoates, and salts with amino acids such as glutamic acid. These salts may be prepared by methods known to those skilled in the art.

The neutral forms of the compounds are preferably regenerated by contacting the salt with a base or acid and isolating the parent compound in the conventional manner. The parent form of the compound differs from the various salt forms in certain physical properties, such as solubility in polar solvents.

In addition to salt forms, the present invention provides compounds, which are in a prodrug form. Prodrugs of the compounds described herein are those compounds that readily undergo chemical changes under physiological conditions to provide the compounds of the present invention. Additionally, prodrugs can be converted to the compounds of the present invention by chemical or biochemical methods in an ex vivo environment. For example, prodrugs can be slowly converted to the compounds of the present invention when placed in a transdermal patch reservoir with a suitable enzyme or chemical reagent.

Certain compounds of the present invention can exist in unsolvated forms as well as solvated forms, including hydrated forms. In general, the solvated forms are equivalent to unsolvated forms and are encompassed within the scope of the present invention. Certain compounds of the present invention may exist in multiple crystalline or amorphous forms. In general, all physical forms are equivalent for the uses contemplated by the present invention and are intended to be within the scope of the present invention.

As used herein, the term “salt” refers to acid or base salts of the compounds used in the methods of the present invention. Illustrative examples of acceptable salts are mineral acid (hydrochloric acid, hydrobromic acid, phosphoric acid, and the like) salts, organic acid (acetic acid, propionic acid, glutamic acid, citric acid and the like) salts, quaternary ammonium (methyl iodide, ethyl iodide, and the like) salts.

The term “substantially” refers to a property, condition, or value that is within 20%, 10%, within 5%, within 1%, optionally within 0.1%, or is equivalent to a reference property, condition, or value. The term “substantially equal”, “substantially equivalent”, or “substantially unchanged”, when used in conjunction with a reference value describing a property or condition, refers to a value that is within 20%, within 10%, optionally within 5%, optionally within 1%, optionally within 0.1%, or optionally is equivalent to the provided reference value. For example, a diameter is substantially equal to 100 nm (or, “is substantially 100 nm”) if the value of the diameter is within 20%, optionally within 10%, optionally within 5%, optionally within 1%, within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value. As used herein, the term “about” means a range of values including the specified value, which a person of ordinary skill in the art would consider reasonably similar to the specified value. In embodiments, about means within a standard deviation using measurements generally acceptable in the art. In embodiments, about means a range extending to +/-10% of the specified value. In embodiments, about means the specified value. In embodiments, the terms “about” and “substantially” are interchangeable and have identical means. For example, a particle having a size of about 1 µm may have a size is within 20%, optionally within 10%, optionally within 5%, optionally within 1%, optionally within 0.1%, or optionally equal to 1 µm.

The term “±” refers to an inclusive range of values, such that “X±Y,” wherein each of X and Y is independently a number, refers to an inclusive range of values selected from the range of (X-Y) to (X+Y).

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

Various potentially useful descriptions, background information, applications of embodiments herein, terminology (to the extent not inconsistent with the terms as defined herein), mechanisms, compositions, methods, definitions, and/or other embodiments may be found in International Patent Publication No. WO 2021/030326 A1, filed Aug. 11, 2020 (Gianneschi, et al.; PCT/US2020/045729), which is incorporated herein by reference in its entirety to the extent not inconsistent herewith.

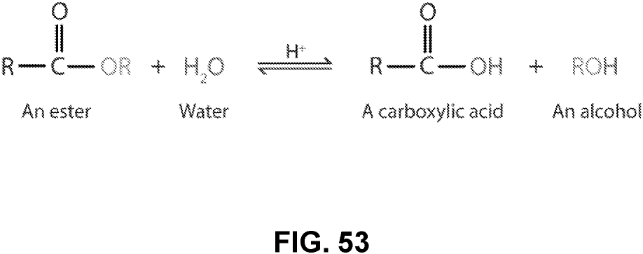

A polymer that is “degradable” is may be partially or fully degraded or decomposed into lower-weight substituents or degradation/decomposition products. For example, degradable polymers disclosed herein may be chemically degraded or decomposed by exposure to an acid or acidic solution. For example, degradable polymers disclosed herein may be chemically and/or biologically degraded or decomposed by exposure to an acid (or acidic solution) and/or to enzyme(s). Optionally, degradable polymers disclosed herein may be degraded or decomposed under physiological and/or physiologically-relevant conditions. Degradable synthetic polymers typically comprise weak covalent bonds in their backbone, such as, but not limited to, esters (e.g., see FIG. 53), acetals, and/or carbonate groups. The degradable polymers, or the degradable repeating units thereof, can be designed to degrade or depolymerize (bond break) at specific or pre-determined stages following different pathways including but not limited to hydrolysis (e.g., see FIG. 53), proteolysis, reduction in the presence of biomolecules (e.g., cysteine and glutathione), and/or irradiation-mediated degradation (e.g., light). Under this definition, polymers synthesized using the traditional ROMP monomers (such as norbornene, cyclooctene, cyclobutene, and cyclopentene) are not considered as degradable due to their all-carbon backbones. In a specific embodiment, polymer degradation is assessed as a change in polymer molecular weight. In certain embodiments, the term degradation is used to refer to cleavage of the backbone of the ROMP polymer by treatment with catalytic amount of acid (e.g., exposure of the polymer to a solution characterized by pH ≤5, optionally pH≤3, optionally pH≤2, optionally pH≤1) at room temperature (20~25° C.) resulting in or yielding small molecules or degradation products having molecular weight less than 1000 g/mol, optionally within 5 days, optionally within 3 days, optionally within 2 days, optionally within 1 day (24 hours), optionally within 12 hours, optionally within 6 hours, optionally within 3 hours. In certain embodiments, a repeating unit, of a polymer, is degradable if the repeating unit or its backbone group is cleavable or cleaved (e.g., from the backbone of the polymer or from neighboring repeating unit(s)) with its exposure to an acid (e.g., exposure to a solution characterized by pH ≤5, optionally pH≤3, optionally pH≤2, optionally pH≤1) and/or with its exposure to a base (e.g., exposure to a solution with pH ≥10), optionally within 5 days, optionally within 3 days, optionally within 2 days, optionally within 1 day (24 hours), optionally within 12 hours, optionally within 6 hours, optionally within 3 hours. In a specific embodiment, polymer degradation is assessed as a change in polymer molecular weight. In certain embodiments, the term degradation is used to refer to cleavage of the backbone of the ROMP polymer by treatment with catalytic amount of base (e.g., exposure of the polymer to a solution with pH ≥10) at room temperature (20~25° C.) resulting in or yielding small molecules or degradation products having molecular weight less than 1000 g/mol, optionally within 5 days, optionally within 3 days, optionally within 2 days, optionally within 1 day (24 hours), optionally within 12 hours, optionally within 6 hours, optionally within 3 hours. For example, both 0.25 M HCl (pH~1) and 0.5 M HCl in DMSO (pH~0) were used to model the accelerated degradation. For example, utilizing size exclusion chromatography-multiangle light scattering (SEC-MALS), it was found that the polyphosphoramidate (DP=94, MW = 21,000 g/mol) completely decomposed into species with MW < 1000 g/mol (2~3 days at 0.5 M HCl and 10 days at 0.25 M HCl). Through nuclear magnetic resonance (NMR), it was confirmed that the final degradation products, in certain embodiments, to be phenyl phosphoric acid and 1,4-diamino-2-butene, which is an unsaturated analog of biogenic amines involved in cell growth and differentiation, highlighting the biocompatibility of polymer disclosed herein, according to certain embodiments. Polymers disclosed herein, according to embodiments, may be degradable under basic conditions (pH >10) at room temperature with similar kinetics. Polymers disclosed herein, according to embodiments, may be degradable under milder and neutral pHs (e.g., between 6~9), in which conditions slower polymer degradation is generally expected compared to acidic or basic conditions, such as taking months (e.g., 1 to 3 months) to reach 80% polymer molecular weight loss. Aside from acid- and base-promoted hydrolysis, elevated temperature (T > 40° C.) may also speed up the polymer degradation. For example, in the case of a homopolymer where each repeating unit is according to FX1A and each of E¹ and E² is independently NH (R⁶ is H), each of R¹-R⁵ is independently a hydrogen, m is 1, and n is 1, (which may be referred to as a “PTDO polymer”) experimental data showed degradation of the polymer in 0.25 M HCl (pH < 1, over 80% polymer degradation in 10 days from NMR) and in 1 M HCl (pH<0, degradation into species of molecular weight less than 1000 in 2 days from SEC-MALS) in DMSO. An increase in the pH to neutral conditions can decrease the rate of degradation, such as to 1 to 3 months at pH 6.5 or 7 (e.g., the pH range for inflamed and normal tissue). On the other hand, for a similar polymer as the latter homopolymer except where either of E¹ and E² is other than NH, such as where both of E¹ and E² is independently NMe (N-CH₃ or N(CH₃)), degradation rates can be faster and more well-defined. Various additional useful descriptions, terminology (to the extent not inconsistent with the terms as defined herein), mechanisms, compositions, methods, definitions, and/or other embodiments pertaining to polymer degradation and degradable polymers, or repeating units thereof, may be found in U.S. Pat. No. 9,206,271B2 to Kiessling, et al. (“Fully backbone degradable and functionalizable polymers derived from the ring-opening metathesis polymerization (ROMP)”), which is incorporated by reference herein in its entirety to the extent not inconsistent herewith.

The term “enzyme-cleavable moiety” refers to a group or moiety that may be cleaved, degraded/decomposed, split, or broken down by an enzyme (e.g., enzymolysis). An enzyme-cleavable peptide, for example, is a peptide that may be cleaved, degraded/decomposed, split, or broken down by an enzyme such as via the process of proteolysis such as by an enzyme in a protease family, such as a matrix metalloproteinase.

Particles and micelles formed of or comprising one or more polymers described herein may be used as delivery vehicles for therapeutic agents, such as therapeutic peptides, non-peptide therapeutic molecule or moieties, and/or nucleic acid-containing molecules or moieties (e.g., oligonucleotide-based therapeutics; e.g., DNA, RNA, mRNA, etc.).

Various useful descriptions, embodiments, and examples, such as of Grubbs catalysts or initiators, including those useful in embodiments herein, of ring close metathesis reactions, and of ring closing metathesis reactions, are included in the following references, each of which is incorporated herein to the extent not inconsistent herewith: (1) Ogba, et al. “Recent advances in ruthenium-based olefin metathesis” Chem. Soc. Rev., 2018, 47, 4510-4544, DOI: 10.1039/C8CS00027A; (2) Song, et al. “Highly active ruthenium metathesis catalysts enabling ring-opening metathesis polymerization of cyclopentadiene at low temperatures” Nature Communications volume 10, Article number: 3860 (2019) DOI: 10.1038/s41467-019-11806-5; and (3) Bielawski, et al. “Living ring-opening metathesis polymerization” Progress in Polymer Science Volume 32, Issue 1, January 2007, Pages 1-29, DOI: 10.1016/j.progpolymsci.2006.08.006. Additional useful descriptions, embodiments, and examples of ring closing metathesis reactions are included in the following references, each of which is incorporated herein to the extent not inconsistent herewith: (1) Kuhn, et al. “Low Catalyst Loadings in Olefin Metathesis: Synthesis of Nitrogen Heterocycles by Ring-Closing Metathesis” Org. Lett. 2010, 12, 5, 984-987, DOI: 10.1021/ol9029808; (2) Khan, et al. “Ring-Closing Metathesis Approaches for the Solid-Phase Synthesis of Cyclic Peptoids” Org. Lett. 2011, 13, 7, 1582-1585 DOI: 10.1021/ol200226z; and (3) Yu, et al. “Ring-Closing Metathesis in Pharmaceutical Development: Fundamentals, Applications, and Future Directions” Org. Process Res. Dev. 2018, 22, 8, 918-946, DOI: 10.1021/acs.oprd.8b00093.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

Certain methods, discussions, and examples provided herein are particularly useful for or pertain to monomers and repeating units where each of E¹ and E² is independently NH (R⁶ is H), each of R¹-R⁵ is independently a hydrogen, m is 1, and n is 1 in formulas FX1A (e.g., optionally referred to as PTDO monomer) and FX20. Certain methods, discussions, and examples provided herein are particularly useful for or pertain to monomers and repeating units where any of E¹, E², R¹-R⁷, m, and/or n different from the latter in formulas FX1A (e.g., in some cases referred to as substituted-PTDO monomer; e.g., wherein one or both of E¹ and E² is other than NH) and FX20. Formulas FX1A and FX20 (also shown above and in the claims) are as follows:

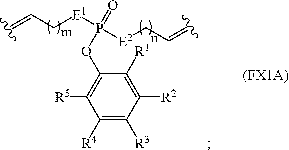

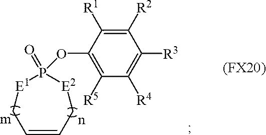

wherein: each of E¹ and E² is independently NR⁶, O, or OR⁷; each of R¹-R⁵ is independently a hydrogen, a halogen, a methyl group, or any combination of these; each of R⁶ and R⁷ is independently hydrogen, a substituted or unsubstituted methyl group, a substituted or unsubstituted ethyl group, a substituted or unsubstituted phenyl group, or any combination of these; and each of m and n is independently 1 or 2.

For example, included herein are syntheses of a degradable polyphosphoramidate via ring-opening metathesis polymerization (ROMP) with a Grubbs initiator, such as the Grubbs initiator (IMesH₂)(C₅H₅N)₂(Cl)₂Ru=CHPh. For example, living, controlled ROMP of a low ring strain diazaphosphepine based cyclic olefin was achieved at low temperatures to afford well-defined polymers that readily undergo degradation in acidic conditions via the cleavage of the acid-labile phosphoramidate linkages. The diazaphosphepine monomer was compatible in random and block copolymerizations with phenyl and oligo(ethylene glycol) bearing norbornenes. This approach introduced partial or complete degradability into the otherwise nondegradable polyolefin backbones. Using this synthetic approach, amphiphilic poly(diazaphosphepine-norbornene) copolymers, which could be used to prepare micellar nanoparticles, were also synthesized. This low temperature ROMP approach can be deployed to prepare degradable polymers starting from functionalized diazaphosphopine and other low ring strain monomers, such as phosphoester and dioxepin based cyclic olefins. Embodiments herein also provide for efficient copolymerization of the diazaphosphepine based monomer with any modified or functionalized norbornenes, including peptide norbornenes to prepare degradable peptide brush polymer.

Degradable polymers with backbones containing ester, acetal, carbonate and amide linkages hold immense promise in drug delivery, tissue engineering, and in fabricating electronic devices and recyclable materials. Typically, synthetic approaches to preparing degradable polymers have included radical ring opening polymerizations of cyclic ketene acetals as well as anionic or metal-catalyzed ring opening polymerizations of lactides, lactones, and N-carboxylic anhydrides. However, these strategies have fundamental limitations including poor monomer stability, low functional group tolerance and a low degree of modularity in macromolecular design. Herein, we develop a low temperature ring-opening metathesis polymerization (ROMP) approach for the synthesis of degradable polyphosphoramidates with the Grubbs initiator (IMesH₂)(C₅H₅N)₂(Cl)₂Ru=CHPh. Living and controlled polymerization of a low ring strain diazaphosphepine based cyclic olefin was achieved at low temperatures. This “cryo” approach enabled us to achieve unprecedented control over the polymerization to yield well-defined olefin polymers that readily undergo complete backbone degradation in acidic conditions via the cleavage of the acid labile phosphoramidate linkages. We also demonstrated that this diazaphosphepine monomer copolymerized efficiently with phenyl and oligo(ethylene glycol) bearing norbornenes, introducing partial or complete degradability into those polymer backbones. The resulting phosphoramidate containing amphiphilic copolymer successfully self-assembled into micellar nanoparticles and showed no discernable cell cytotoxicity.

Applications of embodiments disclosed herein include, but are not limited to: drug delivery platforms; tissue engineering materials; recyclable materials; and polymer electronic devices (sacrificial materials).

Embodiments disclosed herein include a variety of advantages. Ring opening metathesis polymerization (ROMP) has emerged as a method to prepare degradable polymers. However, the prior reported degradable polymer materials via ROMP typically have broad molecular weight distributions (Ð > 1.5) and significant deviations in theoretical and measured molecular weights, potentially impeding their applications. Certain embodiments of methods herein include a low temperature or cryo-ROMP approach to solve this problem by providing unprecedented control over the polymerization of low ring stain diazaphosphepine based cyclic olefin. The resulting degradable polyphosphoramidates are well-defined with predictable molecular weights and narrow molecular weight distributions (Ð < 1.3). By tuning the feed ratio of monomer to catalyst, according to embodiments herein, one can facilely access polyphosphoramidates with different molecular weights. Various embodiments of polyphosphoramidates prepared via embodiments of methods disclosed herein may completely degrade into a phosphoric acid and 1,4-diamino-2-butene, which is an unsaturated analog of biogenic amines involved in cell growth and differentiation, under mild acidic condition, leading to potentially biocompatible materials. Embodiments of polyphosphoramidates disclosed herein are thermally stable and should have a long shelf-life at room temperature. Thermogravimetric analysis revealed that the polymer decomposes at 235° C. and differential scanning calorimetry afforded a glass transition temperature of 42° C., which would lead to optically transparent materials such as films. By incorporating the low ring strain diazaphosphepine based cyclic olefin as a comonomer, according to embodiments herein, one can introduce degradability into the otherwise nondegradable polyolefin backbones. By adjusting the feed ratio and position of the diazaphosphepine monomer, according to embodiments herein, one can we achieve partial or complete degradation of various ROMP derived polymers. This can render biodegradability to multifunctional polyolefins such as peptide brush polymers.

Various potentially useful descriptions, background information, applications of embodiments herein, terminology (to the extent not inconsistent with the terms as defined herein), mechanisms, compositions, methods, definitions, and/or other embodiments may be found in the following references, each of which is incorporated herein to the extent not inconsistent herewith. Some of the following reference include, for example, discussions of using degradable polymers in biomedical applications and as recyclable materials. Some of the following references include, for example, aspects related to both ring-opening metathesis polymerization (ROMP) method and photoinduced reversible addition-fragmentation transfer (RAFT) radical polymerization approach to make synthetic polymers for bio-applications: (1) Fishman, J. M.; Kiessling, L. L. Synthesis of Functionalizable and Degradable Polymers by Ring-Opening Metathesis Polymerization. Angew. Chem. Int. Edit. 2013, 52, 5061-5064; (2) Fishman, J. M.; Zwick, D. B.; Kruger, A. G.; Kiessling, L. L. Chemoselective, Postpolymerization Modification of Bioactive, Degradable Polymers. Biomacromolecules. 2019, 20, 1018-1027; (3) Shieh, P.; Nguyen, H. V. T.; Johnson, J. A. Tailored silyl ether monomers enable backbone-degradable polynorbornene-based linear, bottlebrush and star copolymers through ROMP. Nat. Chem. 2019, 11, 1124-1132; (4) Feist, J. D.; Xia, Y. Enol Ethers Are Effective Monomers for Ring-Opening Metathesis Polymerization: Synthesis of Degradable and Depolymerizable Poly(2,3-dihydrofuran). J. Am. Chem. Soc. 2020, 142, 1186-1189; (5) U.S. Pat. No. 9,206,271B2 to Kiessling, et al.; (6) Kammeyer, J. K.; Blum, A. P.; Adamiak, L.; Hahn, M. E.; Gianneschi, N. C., Polymerization of protecting-group-free peptides via ROMP. Polym. Chem. 2013, 4 (14), 3929-3933; (7) Blum, A. P.; Kammeyer, J. K.; Yin, J.; Crystal, D. T.; Rush, A. M.; Gilson, M. K.; Gianneschi, N. C., Peptides Displayed as High Density Brush Polymers Resist Proteolysis and Retain Bioactivity. J. Am. Chem. Soc. 2014, 136 (43), 15422-15437 ; (8) Blum, A. P.; Kammeyer, J. K.; Gianneschi, N. C., Activating peptides for cellular uptake via polymerization into high density brushes. Chem. Sci. 2016, 7 (2), 989-994; (9) Sun, H.; Choi, W. ; Zang, N.; Battistella, C.; Thompson, M.P.; Cao, W.; Zhou, X.; Forman, C.; Gianneschi, N.C., Bioactive Peptide Brush Polymers via Photoinduced Reversible-Deactivation Radical Polymerization. Angew. Chem. Int. Ed., 2019, 58, 17359-17364.

While certain embodiments and/or definitions from incorporation by reference may optionally be combined with certain embodiments and definitions herein, the embodiments and definitions disclosed herein generally supersede embodiments and definitions incorporated by reference with respect any aspect, portion, or detail that is inconsistent with, disagrees with, or contradicts the embodiments and definitions disclosed herein.

The invention can be further understood by the following non-limiting examples.

### Example 1A: Degradable Polyphosphoramidate via Ring-Opening Metathesis Polymerization

Examples 1A-1B include a subset of embodiments of monomers, polymers, methods disclosed in this application. As evident from the description throughout, and claims, other embodiments of monomers, polymers, and methods are also disclosed in this application.

Included in Examples 1A-1B is synthesis of a degradable polyphosphoramidate via ring-opening metathesis polymerization (ROMP) with the Grubbs initiator (IMesH₂)(C₅H₅N)₂(Cl)₂Ru=CHPh. Controlled ROMP of a low ring strain diazaphosphepine based cyclic olefin was achieved at low temperatures to afford well-defined polymers that readily undergo degradation in acidic conditions via the cleavage of the acid-labile phosphoramidate linkages. The diazaphosphepine monomer was compatible in random and block copolymerizations with phenyl and oligo(ethylene glycol) bearing norbornenes. This approach introduced partial or complete degradability into the polymer backbones. With this chemistry, we accessed amphiphilic poly(diazaphosphepine-norbornene) copolymers which could be used to prepare micellar nanoparticles.

Degradable polymers are attractive in a host of applications including in drug delivery, tissue engineering, and in fabricating electronic devices and recyclable materials.¹⁻⁶ Traditionally, ring-opening polymerization (ROP) of cyclic monomers, such as cyclic ketene acetals, lactides, and lactones is harnessed to synthesize well-defined degradable polyesters.⁷⁻¹¹ Recently, polymers containing a variety of hydrolytically and redox degradable moieties have been prepared via ruthenium based metathesis polymerizations, including acyclic diene metathesis (ADMET) polymerization, ^{12,}¹³ cascade enyne metathesis polymerization, ^{14,}¹⁵ and ring-opening metathesis polymerization (ROMP).

ROMP is known as a powerful tool for the synthesis of polymers with predictable molecular weights, narrow molecular weight distributions, and complex architectures.¹⁶⁻²¹ In particular, the development of well-defined ruthenium carbene initiators has enabled efficient polymerization with excellent functional group tolerance.²²⁻²⁴ Despite the tremendous diversity of functional non-degradable polymers accessed via ROMP, ¹⁶⁻²⁴ examples of well-defined high molecular weight polymers consisting of fully degradable backbones remain rare. In 2013, Kiessling and coworkers demonstrated the controlled ROMP of bicyclic oxazinones, resulting in polymers that degrade under both acidic and basic conditions.²⁵ Recently, Johnson and coworkers reported the statistical copolymerization of silyl ether-based cyclic olefins with norbornene-based macromonomers via ROMP to generate backbone degradable bottlebrush and star copolymers.²⁶ Other monomers, including dioxepins,²⁷ cyclic phosphates,²⁸ disulfide containing cyclic olefin,²⁹ levoglucosenol,³⁰ cyclic carbonate,³¹ and cyclic enol ethers³² have been reported in the preparation of degradable polymers via ROMP. However, in these cases, some fundamental limitations were observed, including poor control over the polymer molecular weight and dispersity, as well as being limited to producing high molecular weight fragments upon the degradation of copolymers consisting of both degradable and non-degradable monomer units.

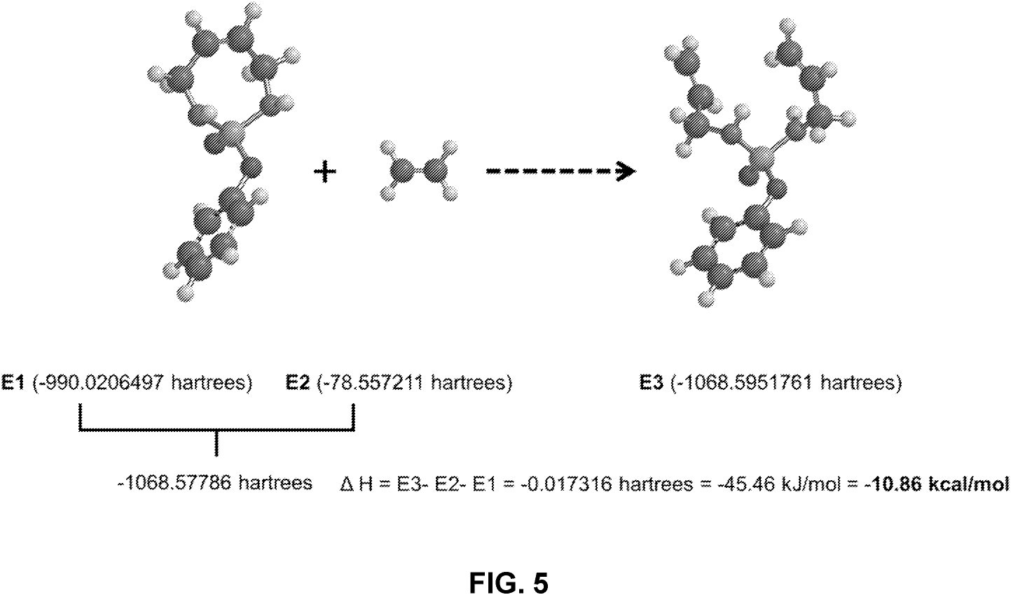

In 2012, Kilbinger and coworkers reported the synthesis of a diazaphosphepine based cyclic olefin, 2-phenoxy-1,3,4,7-tetrahydro-1,3,2-diazaphosphepine 2-oxide (PTDO), which was used as a sacrificial agent for amine end-functionalization of living ROMP polymers.³³ The researchers claimed the formation of an unreactive ruthenium carbene post PTDO incorporation. We envisioned that PTDO should be a good candidate for the preparation of fully degradable polymers via ROMP under the appropriate conditions. It is well known that the release of ring strain of cyclic monomers serves as the main driving force in ROMP, compensating for entropy loss during polymerization.²³ However, an evaluation of the ring strain energy of PTDO via a density functional theory calculation revealed a low ring strain of 10.86 kcal/mol (FIG. 5). This number is markedly lower than the strain energy of norbornene (27.2 kcal/mol), the most widely used monomer class employed for ROMP.^{34,}³⁵ In the case of low ring strain monomers such as cyclopentene, one approach to achieve high monomer conversion is to lower the reaction temperature.^{24,} ³⁶⁻³⁹

Therefore, we hypothesized that ROMP of PTDO would be achieved at low reaction temperatures to afford polymers with controlled molecular weight and low dispersity. Furthermore, upon hydrolysis, the polymer would degrade into a phosphoric acid and 1,4-diamino-2-butene, which is an unsaturated analog of biogenic amines involved in cell growth and differentiation, leading to a potentially biocompatible material.⁴⁰

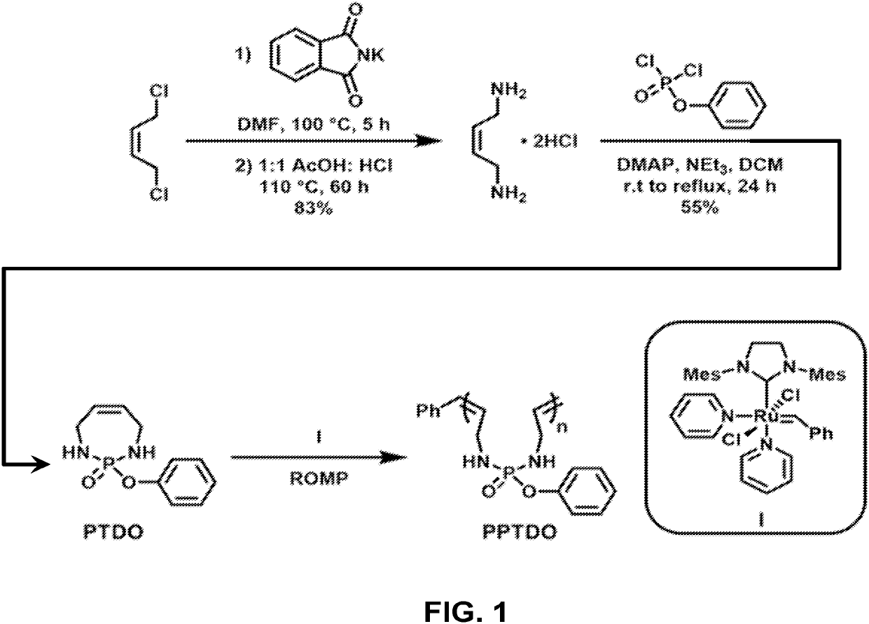

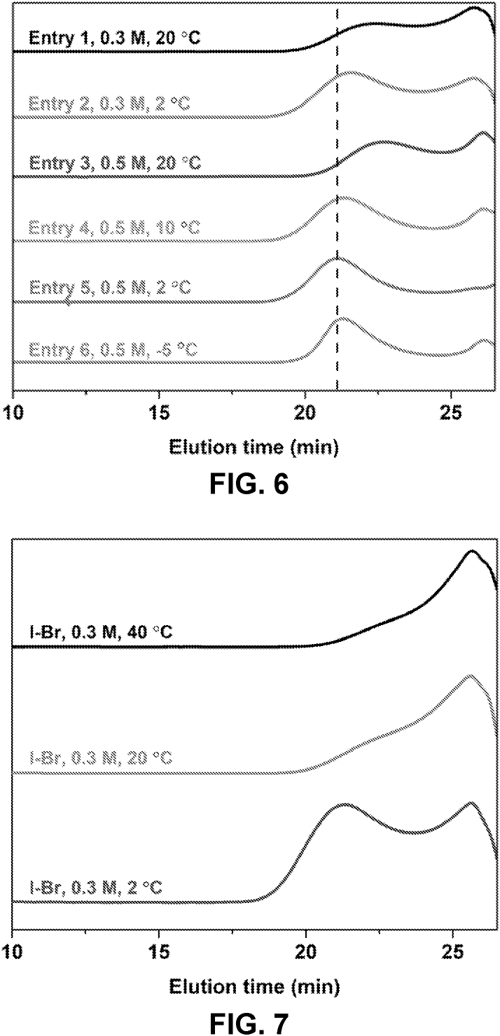

To start the investigation, the seven membered cyclic monomer PTDO was prepared via a two-step synthesis with an overall yield of 44% (FIG. 1).^{33,}⁴¹ The monomer was then subjected to the Grubbs initiator (IMesH₂)(C₅H₅N)₂(Cl)₂Ru=CHPh (I) at different reaction temperatures (Table 1). This initiator was chosen due to its fast initiation rate and high reactivity towards less active olefins. ^{24,}⁴² Initial screening was performed with 0.3 M PTDO (Table 1, Entries 1-2). Despite the nearly 50% monomer conversion at 20° C., we only observed the formation of oligomers with a broad dispersity of 1.62. A secondary peak at 25.8 min on size-exclusion chromatography (SEC) indicated the presence of side reactions such as adverse backbiting and early termination (FIG. 6). By decreasing the reaction temperature to 2° C., a high molecular weight polymer with narrow dispersity was obtained (Mₙ = 19.3 kDa, Ð = 1.10). An increase in initial monomer concentration to 0.5 M did not lead to changes in Mₙ or Ð, but significantly reduced side reactions (FIG. 6). As such, ROMP with 0.5 M PTDO at 2° C. proved to be optimal, resulting in 55% PTDO conversion in 5 h (Mₙ = 14.2 kDa, D = 1.16, Table 1, Entry 5). Further decreases in reaction temperature led to a reduction in monomer conversion (Table 1, Entries 6-7). At -20° C., more than 95% of PTDO was retrieved after quenching the reaction with ethyl vinyl ether (EVE), indicating a failure to initiate.²⁴ Polymerizations with the bromopyridine modified Grubbs initiator⁴² (IMesH₂)(C₅H₄NBr)₂(Cl)₂Ru=CHPh were also performed, affording a similar trend with respect to the effect of temperature on the polymerization (Table 3, FIG. 7).

TABLE 1

ROMP of PTDO at Varying Temperatures^{a}

| Entry | T (°C) | [M]₀ (M) | Conv.^{b} | Mₙ, ₜₕₑₒ (kDa)^{c} | Mₙ, _{MALS} (kDa)^{d} | Ð^{d} |
|---|---|---|---|---|---|---|
| 1 | 20 | 0.3 | 48% | 10.7 | 5.1 | 1.62 |
| 2 | 2 | 0.3 | 58% | 13.1 | 19.3 | 1.10 |
| 3 | 20 | 0.5 | 42% | 9.4 | 7.3 | 1.26 |
| 4 | 10 | 0.5 | 47% | 10.5 | 14.6 | 1.19 |
| 5 | 2 | 0.5 | 55% | 12.4 | 14.2 | 1.16 |
| 6 | -5 | 0.5 | 44% | 9.9 | 12.6 | 1.16 |
| 7 | -20 | 0.5 | <5% | N/A | N/A | N/A |

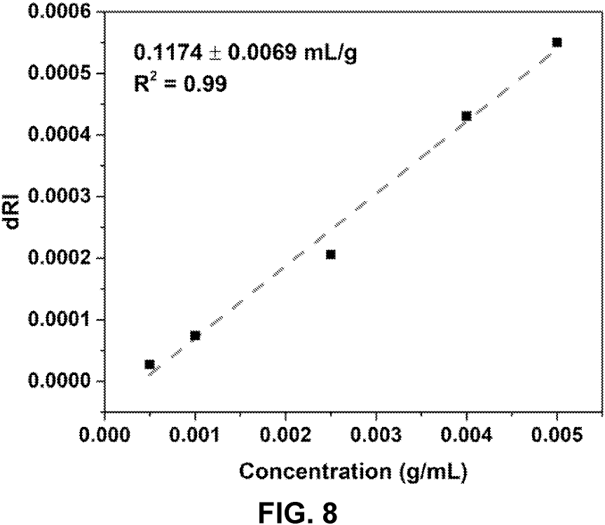

^{a}ROMP was performed in 10/90 v/v MeOH in DCM under N₂ for 5 h and quenched with ethyl vinyl ether. A feed ratio of 100:1 [M]₀:[I] was used for all reactions. ^{b}Monomer conversion was determined by ¹H-NMR spectroscopy. ^{c}Theoretical molecular weight M_{n,theo} = DPₘₒₙₒₘₑᵣ × MWₘₒₙₒₘₑᵣ_{.}where DP = feed ratio × conv. ^{d}Molecular weight and dispersity were determined by size exclusion chromatography with multiangle light scattering (SEC-MALS) with a measured dn/dc of 0.1174 mL/g (FIG. 8 ).

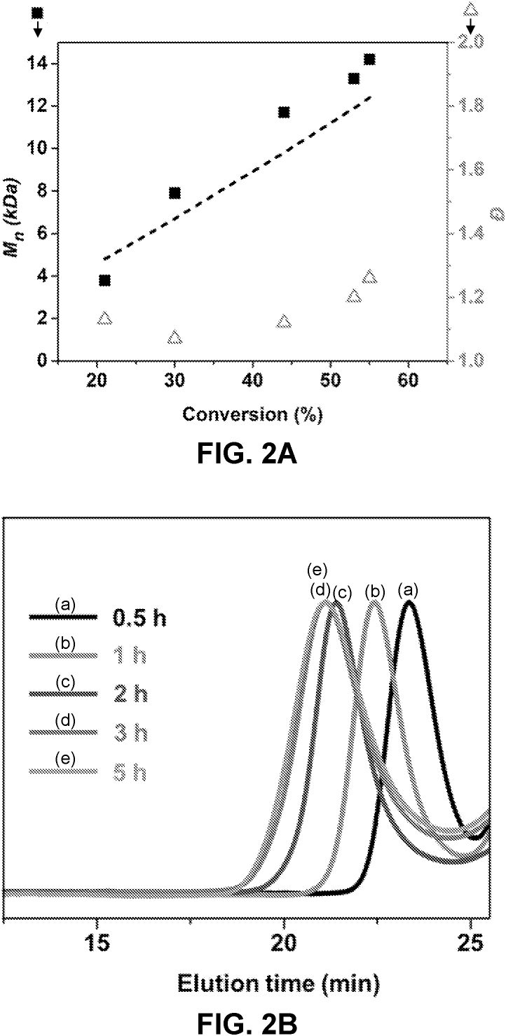

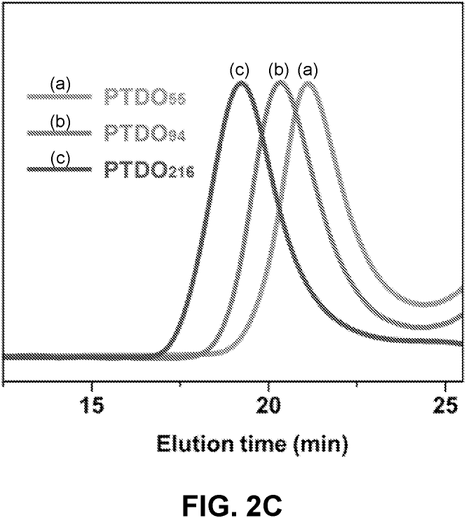

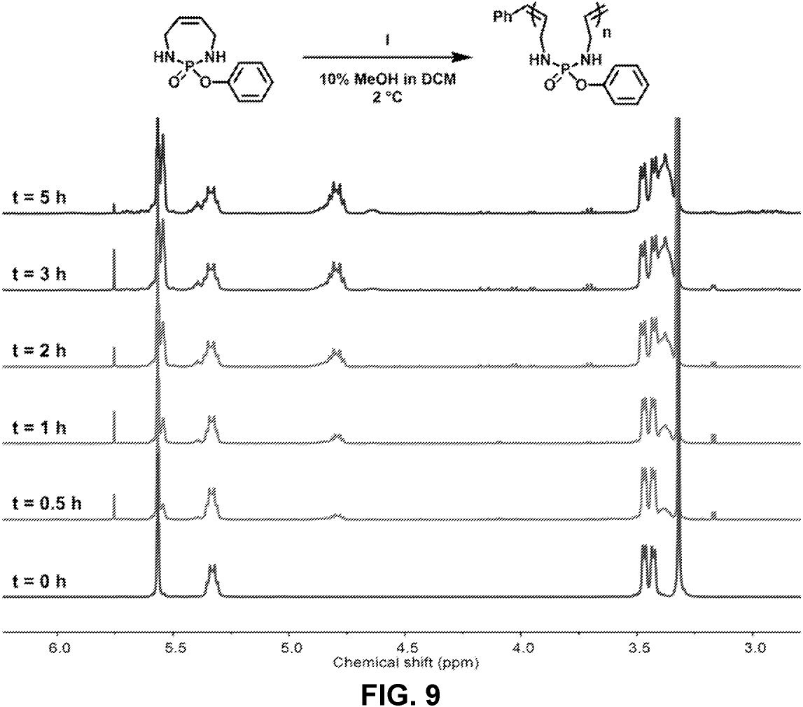

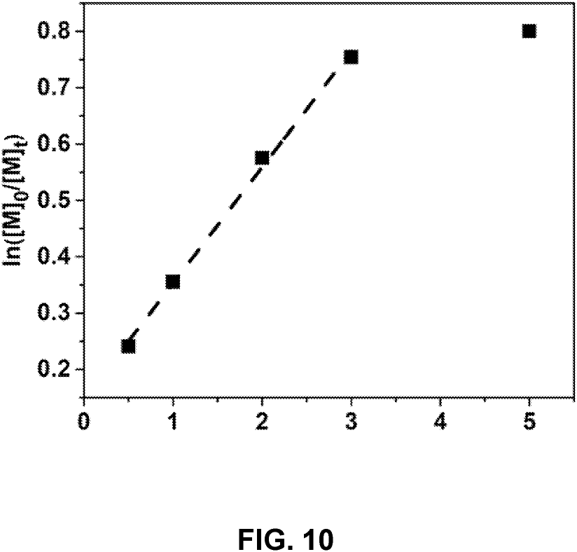

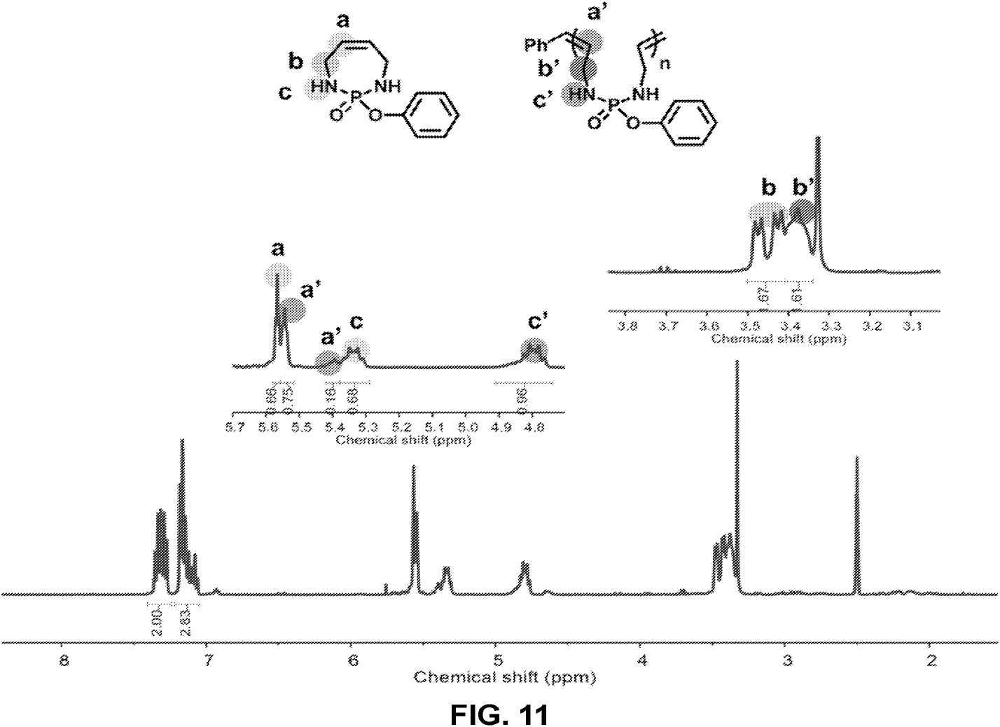

To examine the chain growth nature of PTDO polymerization, parallel reactions were setup and quenched at different times (FIGS. 2A-2C, Table 2, Entries 1-5). Polymer molecular weight increased linearly with respect to monomer conversion and maintained a low D (1.07-1.26), indicative of good control over the polymerization. (FIG. 2A, FIGS. 9-11). A plot of In([M]₀/[M]ₜ) versus time revealed a linear relationship until 3 h, indicating a pseudo first-order kinetics consistent with controlled polymerization (FIG. 10). At 5 h, no significant increase in PTDO conversion and Mₙ was observed as the reaction reached equilibrium between monomer and polymer (FIG. 2B). However, broadening of the SEC peaks was noticed at equilibrium, indicating chain transfer and backbiting events at high monomer conversion. Throughout the polymerizations, both E and Z alkene configurations were observed according to ¹H-NMR analysis. An E/Z ratio of 5:1 was determined for the backbone olefins based on the integration of olefin signals, suggesting the predominant formation of trans-olefin under the investigated polymerization conditions (FIGS. 9 and 11). By increasing the [M]₀:[I] ratio, a series of PPTDOs with different molecular weights and consistently low Ð were synthesized (FIG. 2C, Table 2, Entries 5-7). The theoretical molecular weights were in good agreement with the measured Mₙ from SEC-MALS. These results unequivocally indicate that PTDO undergoes controlled ROMP before reaching equilibrium. Terminating the reaction at early times (3-5 h) enables access to well-defined PPTDO with predictable molecular weight.

TABLE 2

Kinetics of PTDO Homopolymerization and Synthesis of Different Molecular Weight PPTDO^{a}

| Entry | [M]₀:[I] | Time (h) | Conv.^{b} | M_{n,} ₜₕₑₒ (kDa)^{c} | Mₙ, _{MALS} (kDa)^{d} | Ð^{d} |
|---|---|---|---|---|---|---|
| 1 | 100:1 | 0.5 | 21% | 4.8 | 3.8 | 1.13 |
| 2 | 100:1 | 1 | 30% | 6.7 | 7.9 | 1.07 |
| 3 | 100:1 | 2 | 44% | 9.8 | 11.7 | 1.12 |
| 4 | 100:1 | 3 | 53% | 11.9 | 13.3 | 1.20 |
| 5 | 100:1 | 5 | 55% | 12.4 | 14.2 | 1.26 |
| 6 | 200:1 | 5 | 47% | 21.1 | 19.4 | 1.20 |
| 7 | 400:1 | 5 | 54% | 48.4 | 44.3 | 1.17 |

^{a}Polymerization condition: 2° C. under N₂. ^{b}Conversion was determined by¹H-NMR spectroscopy. ^{c}Theoretical Mₙ was calculated from monomer conversion. ^{d}Molecular weight and dispersity were determined via SEC-MALS.

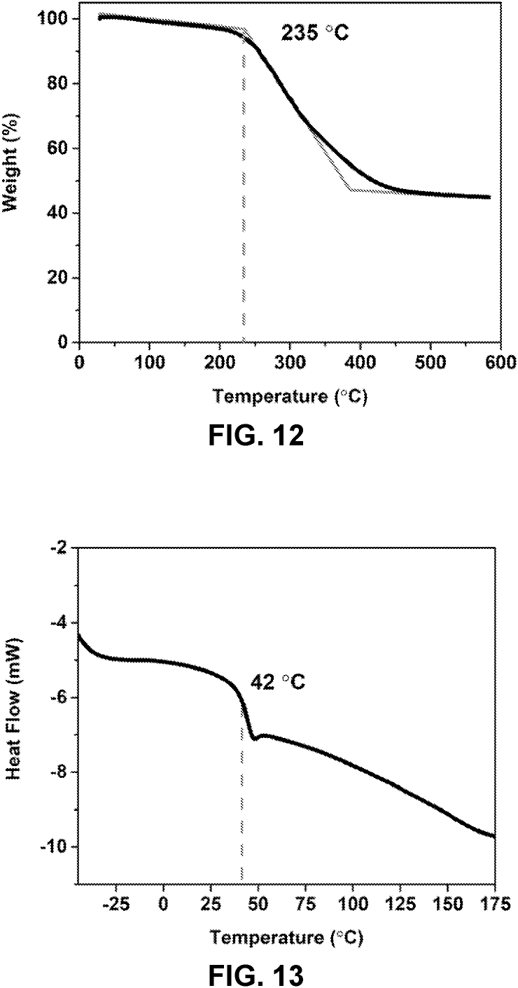

The thermal properties of PPTDO (DP = 94, E/Z = 7:1) were then investigated. At room temperature, PPTDO appeared as a yellow, brittle solid. The polymer became rubbery when left open to air, possible due to the plasticizing effect of moisture. Thermogravimetric analysis revealed that the polymer decomposes at 235° C. (FIG. 12). By differential scanning calorimetry, only the glass transition temperature of 42° C. was observed, indicating the amorphous and non-crystalline nature of the polymer (FIG. 13). In combination, the thermal analyses show PPTDO is thermally stable and should have a long shelf life at room temperature or lower, under anhydrous conditions.

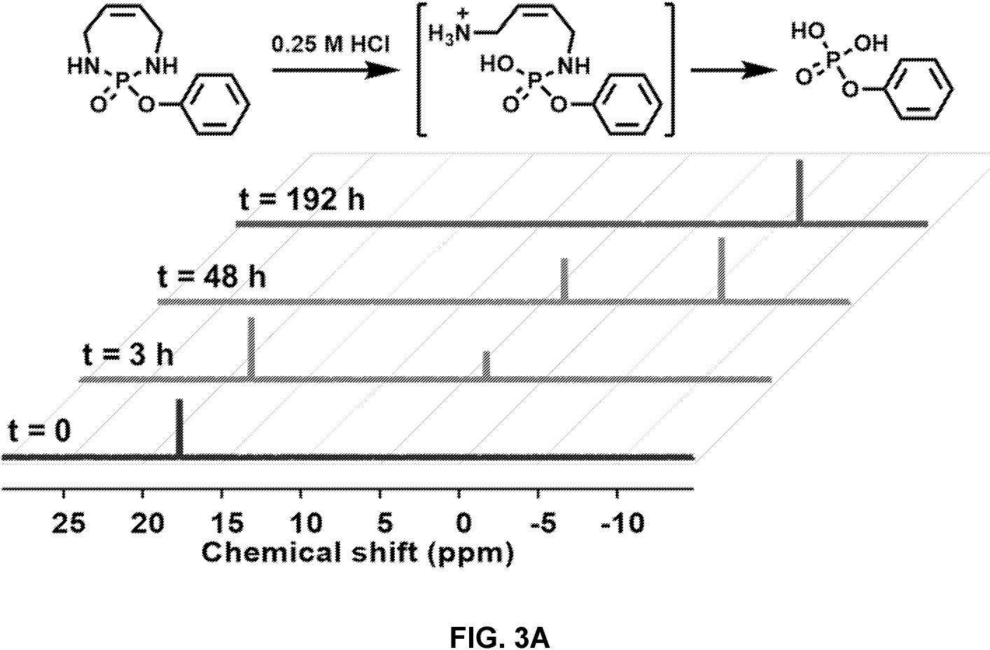

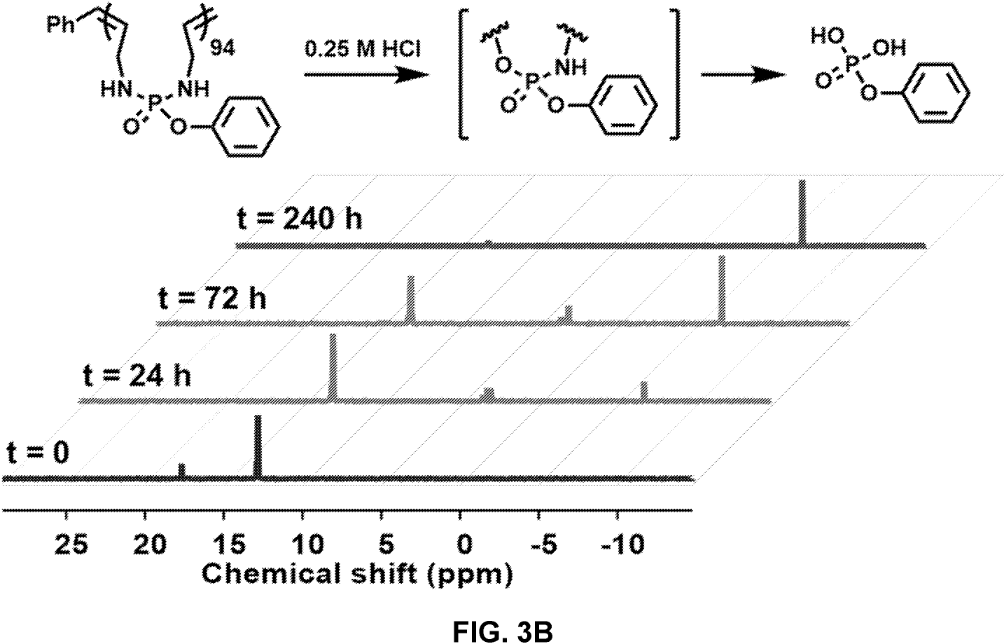

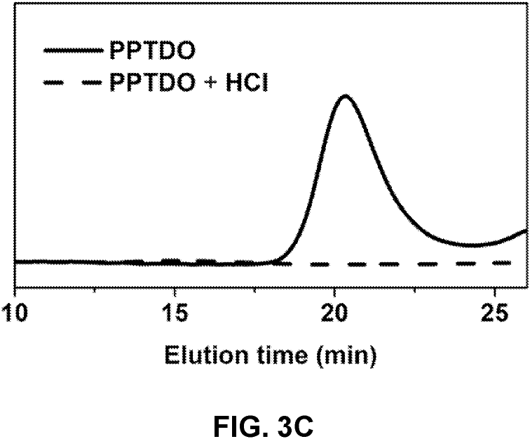

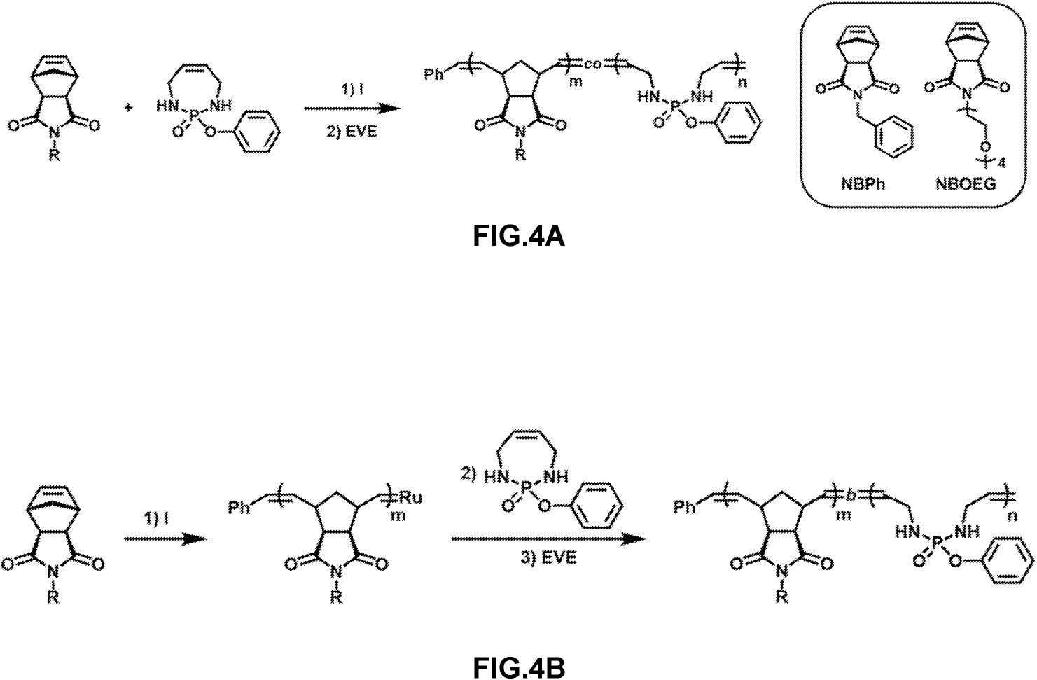

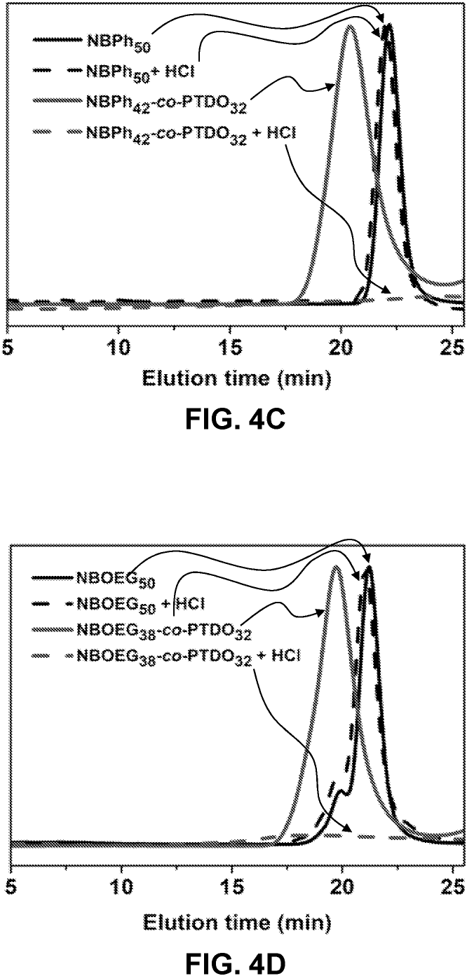

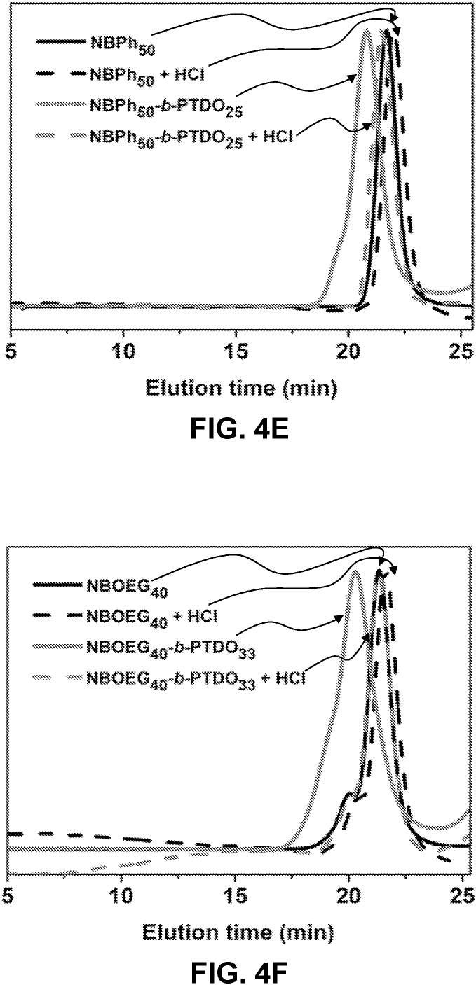

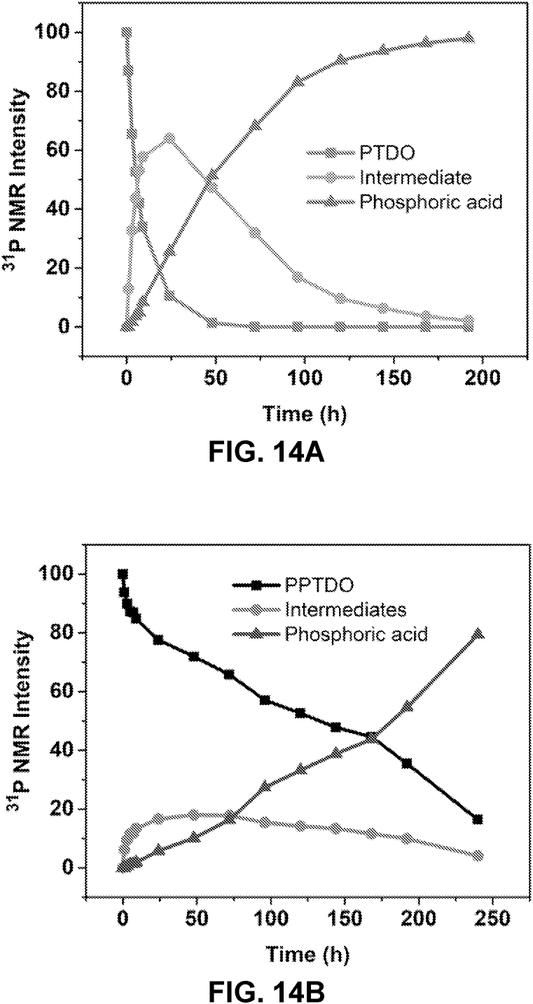

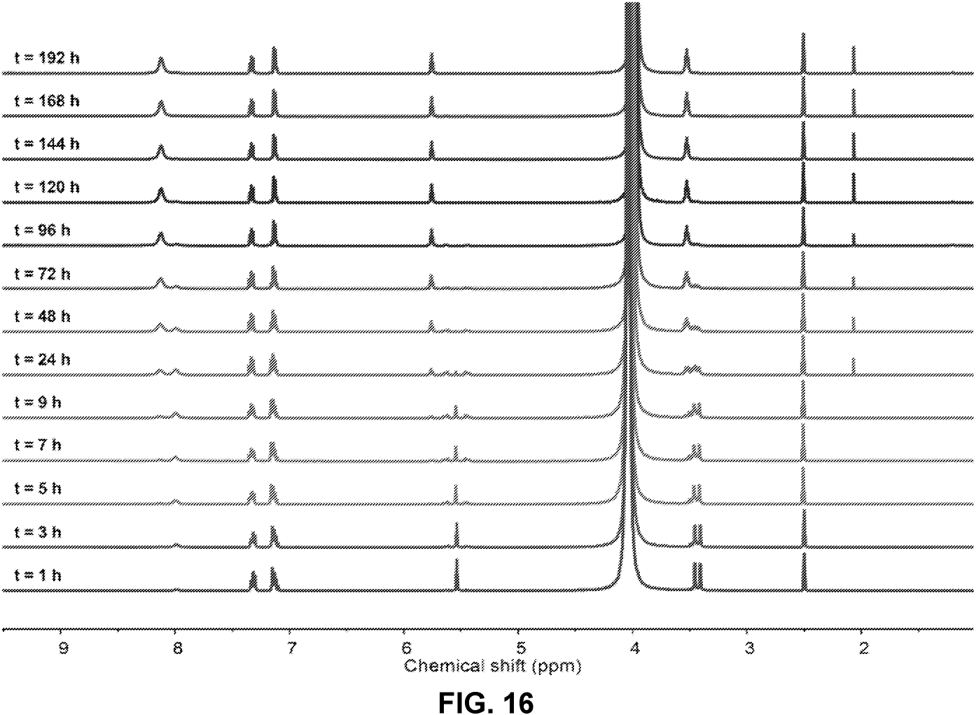

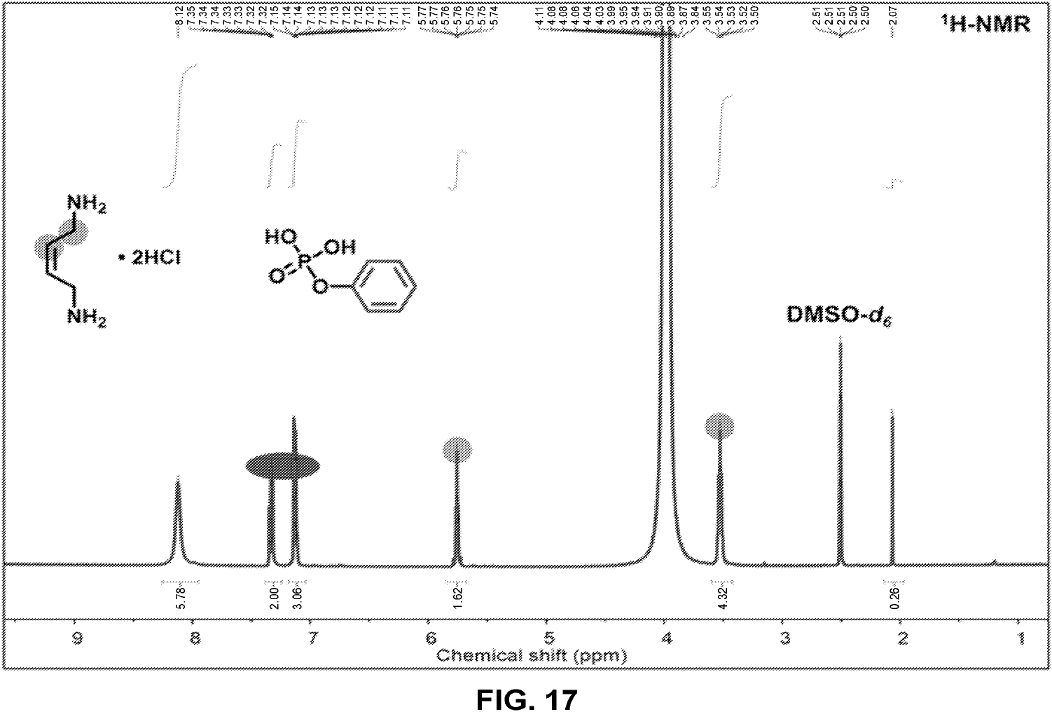

To understand the degradation mechanism of the material, both PTDO and PPTDO were subjected to a mixture of 0.25 M HCl in DMSO-d₆. Both ¹H- and ³¹P-NMR spectroscopy were used to monitor the degradation kinetics (FIGS. 14A-14B, 15-19). Over 48 h, PTDO monomer completely degraded as indicated by the disappearance of the ³¹P resonance at 18.07 ppm (FIG. 3A). The appearance of a peak at 3.20 ppm attributed to be the single phosphoramidate linkage cleavage product. The signal at -6.72 ppm is well aligned with phenylphosphoric acid (δ = - 6.23 ppm). The minor difference in chemical shift is caused by different protonation state. The full PTDO to phenylphosphoric acid conversion was achieved in 192 h. ¹H-NMR spectroscopy further confirmed the identities of the degraded products as phenyl phosphoric acid and 1,4-diamino-2-butene (FIG. 17). Notably, the degradation of PPTDO was slower than that of monomer (FIGS. 14A-14B). At 240 h, more than 80% of the polymer degraded into phenylphosphoric acid as the ³¹P resonance at 13.00 ppm disappeared and a signal at -6.72 ppm emerged (FIG. 3B). The peaks between 2.8 and 3.5 ppm represent the intermediate degraded polymers with different degrees of backbone hydrolysis. Finally, no high molecular weight species were detected by SEC-MALS, further confirming complete backbone degradation (FIG. 3C). We expected that by modifying the molar mass of the polymer and solution pH, different backbone degradation rates could be achieved. Motivated by these results, we then moved on to investigate the possibility of using PTDO as a comonomer to introduce degradability into other ROMP derived polymers (FIGS. 4A-4F).

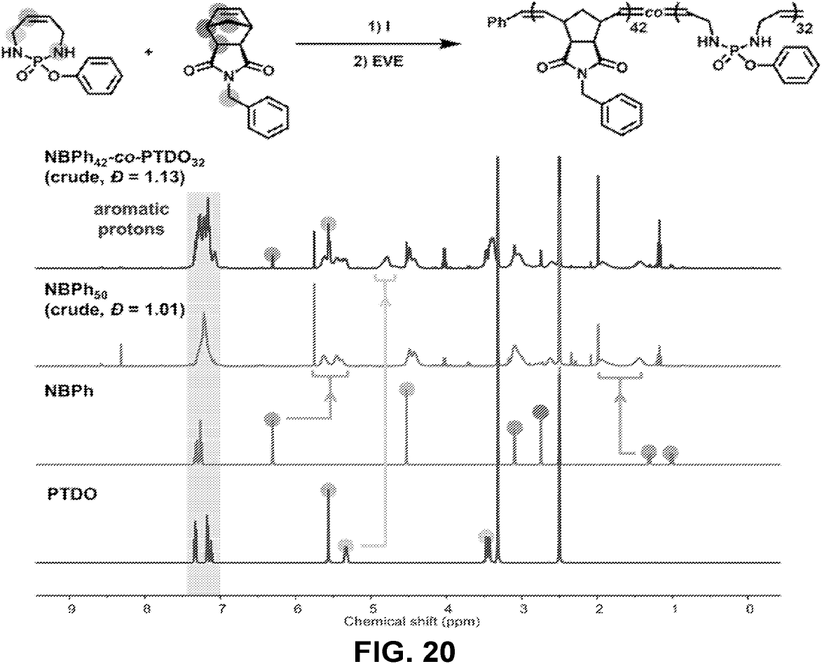

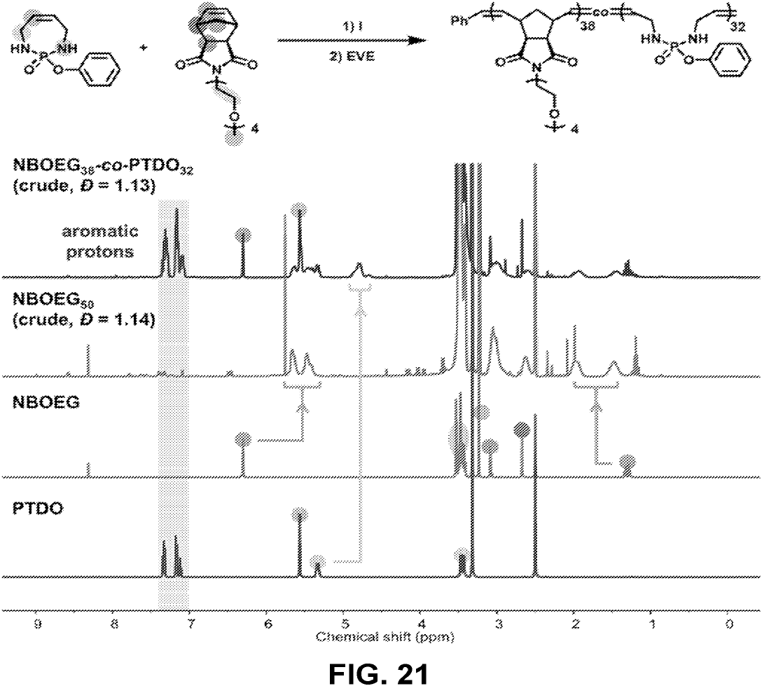

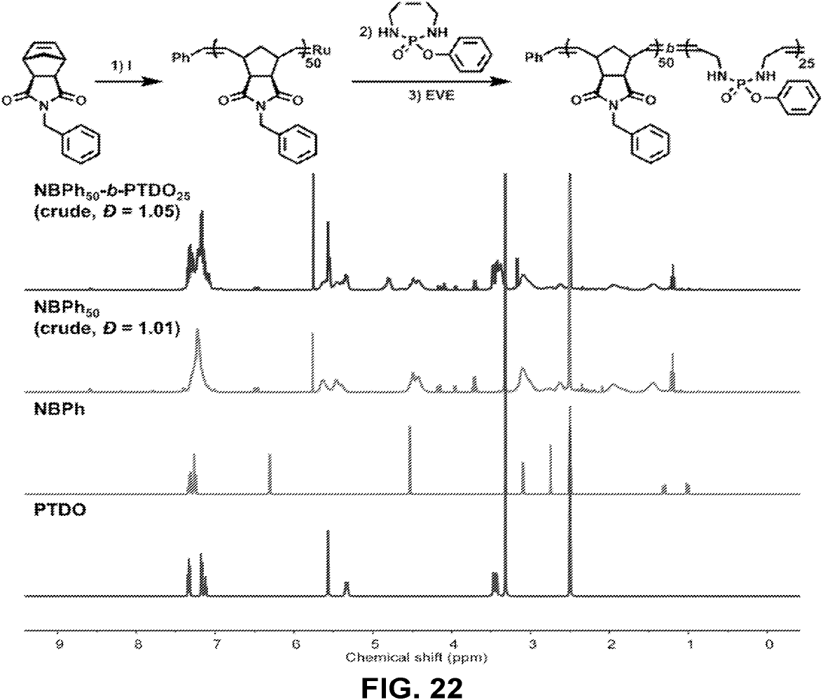

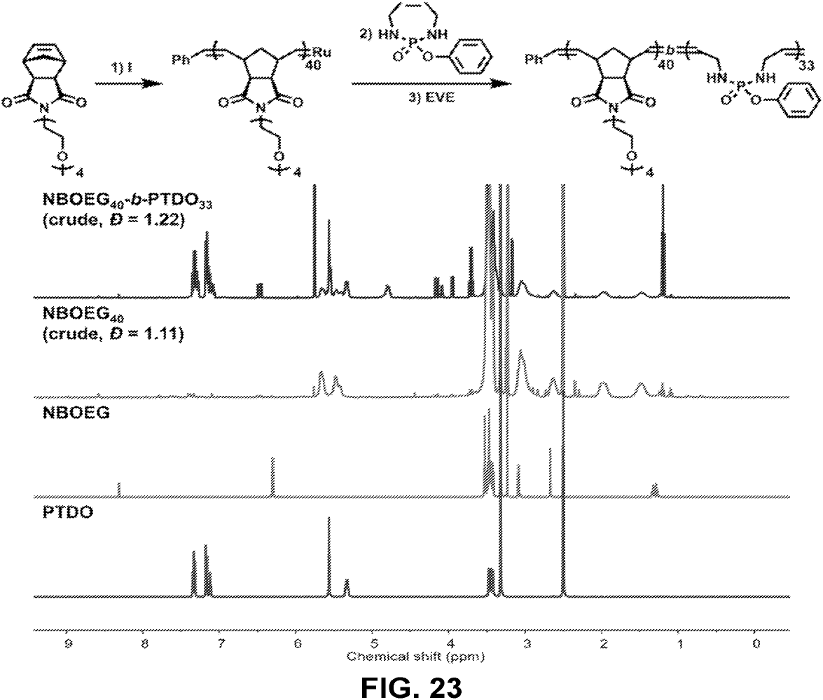

Random copolymerization of PTDO with norbornenes bearing phenyl and oligo(ethylene glycol) (NBPh and NBOEG) were performed (FIG. 4A). A 1: 1 ratio of PTDO: NB was dissolved in a mixture of MeOH/DCM and cooled to 2° C. before the addition of 0.02 equivalents of I. The reaction was quenched after 5 h with EVE. ¹H-NMR revealed an 84% conversion of NBPh and a 64% conversion of PTDO, yielding the polymer NBPh₄₂-co-PTDO₃₂ with Ð of 1.13 (FIG. 20). Similarly, NBOEG copolymerized with PTDO to give the polymer NBOEG₃₈-co-PTDO₃₂ with Ð of 1.13 (FIG. 21). In both cases, PTDO conversion (~64%) was higher than that for PTDO homopolymerization (vide supra), possibly because of a more active chain end post norbornene incorporation. Both copolymers and their corresponding norbornene homopolymers were analyzed by SEC-MALS before and after 0.5 M HCl treatment (FIGS. 4C-4D). In both cases, the copolymers completely degraded into small molecules, indicating a statistical incorporation of PTDO. The norbornene homopolymers remained unchanged post acid treatment. Next, two block copolymers of PTDO and norbornene were synthesized (FIG. 4B). Norbornene was first polymerized with I at room temperature to yield the first block. Then the reaction mixture was cooled to 2° C., followed by PTDO addition for chain extension. ¹H-NMR revealed a PTDO conversion between 40 ~ 50% (FIGS. 22-23). After treating the block copolymers NBPh₅₀-b-PTDO₂₅ and NBOEG₄₀-b-PTDO₃₃ with acid, SEC traces shifted towards longer retention times overlapping with signals from the polynorbornene controls (FIGS. 4E-4F). These results show that by controlling the PTDO feed ratio and position in the backbone, we can achieve controlled degradation, either partial or complete, of ROMP derived polymers.

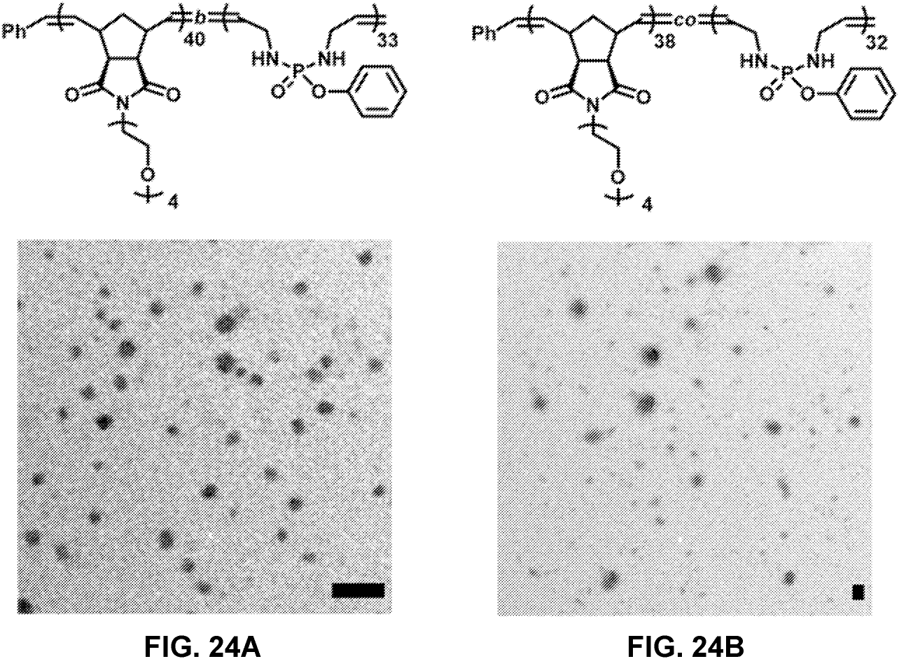

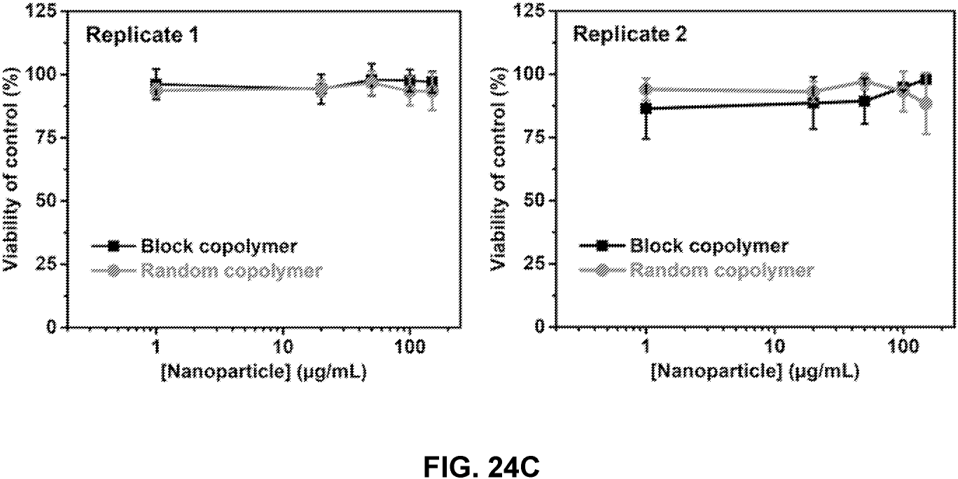

A potential application of PTDO containing amphiphilic copolymers is to produce biodegradable nanoparticles for biomedical applications, such as drug delivery. Both the block and random copolymers NBOEG₄₀-b-PTDO₃₃ and NBOEG₃₈-co-PTDO₃₂ self-assembled into spherical nanoparticles in aqueous solution, as evidenced by dry state transmission electron microscopy.⁴³ The nanoparticles assembled from the block copolymer NBOEG₄₀-b-PTDO₃₃ were uniform in size with a diameter of 24 ± 4 nm, whereas two separate populations were observed in NBOEG₃₈-co-PTDO₃₂ based nanoparticles: 55 ± 8 nm and 133 ± 27 nm (FIGS. 24A-24B). Cytotoxicity of the NBOEG-PTDO nanoparticles against human cervical carcinoma HeLa cells was evaluated by a CellTiter-Blue assay. No appreciable cytotoxicity was observed even at a high concentration of nanoparticles at 150 µg/mL, highlighting the potential of these nanoparticles as non-toxic nanocarriers (FIG. 24C).

In summary, we demonstrate an approach to generate degradable polymers featuring phosphoramidate linkages in their backbones. ROMP of the low strain diazaphosphepine based monomer, PTDO, at low temperatures proceeded in a controlled manner, affording high molecular weight polyphosphoramidates that undergo complete backbone degradation upon acid treatment. We also showed that the PTDO monomer copolymerized efficiently with norbornenes, introducing partial or complete degradability into those polymer backbones. Furthermore, the amphiphilic copolymers of PTDO and oligo(ethylene glycol) bearing norbornene self-assembled into micellar nanoparticles and showed no discernable cell cytotoxicity. Moving forward, we expect a plurality of cyclic diazaphosphepine based monomers can be generated via ring-closing metathesis and subsequently polymerized via ROMP.⁴⁴ Future studies, including the synthesis and polymerization of functionalized phosphoramidates, modifying the degradation rates of polymers and nanoparticles, as well as applications in drug delivery and recyclable materials are underway.

References corresponding to Example 1A:

1. Delplace, V.; Nicolas, J. Degradable vinyl polymers for biomedical applications. Nat. Chem. 2015, 7, 771-784.

2. Hillmyer, M. A.; Tolman, W. B. Aliphatic Polyester Block Polymers: Renewable, Degradable, and Sustainable. Acc. Chem. Res. 2014, 47, 2390-2396.

3. Semsarilar, M.; Perrier, S. ‘Green’ reversible addition-fragmentation chain-transfer (RAFT) polymerization. Nat. Chem. 2010, 2, 811-820.

4. Feig, V. R.; Tran, H.; Bao, Z. N. Biodegradable Polymeric Materials in Degradable Electronic Devices. ACS Cent. Sci. 2018, 4, 337-348.

5. Farah, S.; Anderson, D. G.; Langer, R. Physical and mechanical properties of PLA, and their functions in widespread applications - A comprehensive review. Adv. Drug. Deliv. Rev. 2016, 107, 367-392.

6. Wilson, J. A.; Luong, D.; Kleinfehn, A. P.; Sallam, S.; Wesdemiotis, C.; Becker, M. L. Magnesium Catalyzed Polymerization of End Functionalized Poly(propylene maleate) and Poly(propylene fumarate) for 3D Printing of Bioactive Scaffolds. J. Am. Chem. Soc. 2018, 140, 277-284.

7. Becker, G.; Wurm, F. R. Functional biodegradable polymers via ring-opening polymerization of monomers without protective groups. Chem. Soc. Rev. 2018, 47, 7739-7782.

8. Tardy, A.; Nicolas, J.; Gigmes, D.; Lefay, C.; Guillaneuf, Y. Radical Ring-Opening Polymerization: Scope, Limitations, and Application to (Bio)Degradable Materials. Chem. Rev. 2017, 117, 1319-1406.

9. Fu, C. K.; Xu, J. T.; Boyer, C. Photoacid-mediated ring opening polymerization driven by visible light. Chem. Commun. 2016, 52, 7126-7129.

10. Hill, M. R.; Kubo, T.; Goodrich, S. L.; Figg, C. A.; Sumerlin, B. S. Alternating Radical Ring-Opening Polymerization of Cyclic Ketene Acetals: Access to Tunable and Functional Polyester Copolymers. Macromolecules. 2018, 51, 5079-5084.

11. Agarwal, S. Chemistry, chances and limitations of the radical ring-opening polymerization of cyclic ketene acetals for the synthesis of degradable polyesters. Polym. Chem. 2010, 1, 953-964.

12. Lv, A.; Cui, Y.; Du, F. S.; Li, Z. C. Thermally Degradable Polyesters with Tunable Degradation Temperatures via Postpolymerization Modification and Intramolecular Cyclization. Macromolecules. 2016, 49, 8449-8458.

13. Shearouse, W. C.; Lillie, L. M.; Reineke, T. M.; Tolman, W. B. Sustainable Polyesters Derived from Glucose and Castor Oil: Building Block Structure Impacts Properties. ACS Macro Lett. 2015, 4, 284-288.

14. Bhaumik, A.; Peterson, G. I.; Kang, C.; Choi, T. L. Controlled Living Cascade Polymerization to Make Fully Degradable Sugar-Based Polymers from D-Glucose and D-Galactose. J. Am. Chem. Soc. 2019, 141, 12207-12211.

15. Fu, L. B.; Sui, X. L.; Crolais, A. E.; Gutekunst, W. R. Modular Approach to Degradable Acetal Polymers Using Cascade Enyne Metathesis Polymerization. Angew. Chem. Int. Edit. 2019, 58, 15726-15730.

16. Bielawski, C. W.; Grubbs, R. H. Living ring-opening metathesis polymerization. Prog. Polym. Sci. 2007, 32, 1-29.

17. Grubbs, R. H.; Khosravi, E., Handbook of metathesis: Polymer synthesis. 2 ed.; Wiley-VCH: 2015.

18. Varlas, S.; Keogh, R.; Xie, Y. J.; Horswell, S. L.; Foster, J. C.; O′Reilly, R. K. Polymerization-Induced Polymersome Fusion. J. Am. Chem. Soc. 2019, 141, 20234-20248.

19. Fu, L. B.; Zhang, T. Q.; Fu, G. Y.; Gutekunst, W. R. Relay Conjugation of Living Metathesis Polymers. J. Am. Chem. Soc. 2018, 140, 12181-12188.

20. Tan, X. Y.; Lu, H.; Sun, Y. H.; Chen, X. Y.; Wang, D. L.; Jia, F.; Zhang, K. Expanding the Materials Space of DNA via Organic-Phase Ring-Opening Metathesis Polymerization. Chem. 2019, 5, 1584-1596.

21. Lee, P. W.; Isarov, S. A.; Wallat, J. D.; Molugu, S. K.; Shukla, S.; Sun, J. E. P.; Zhang, J.; Zheng, Y.; Dougherty, M. L.; Konkolewicz, D.; Stewart, P. L.; Steinmetz, N. F.; Hore, M. J. A.; Pokorski, J. K. Polymer Structure and Conformation Alter the Antigenicity of Virus-like Particle-Polymer Conjugates. J. Am. Chem. Soc. 2017, 139, 3312-3315.

22. Ogba, O. M.; Warner, N. C.; O′Leary, D. J.; Grubbs, R. H. Recent advances in ruthenium-based olefin metathesis. Chem. Soc. Rev. 2018, 47, 4510-4544.

23. Sutthasupa, S.; Shiotsuki, M.; Sanda, F. Recent advances in ring-opening metathesis polymerization, and application to synthesis of functional materials. Polym. J. 2010, 42, 905-915.

24. Song, K.; Kim, K.; Hong, D.; Kim, J.; Heo, C. E.; Kim, H. I.; Hong, S. H. Highly active ruthenium metathesis catalysts enabling ring-opening metathesis polymerization of cyclopentadiene at low temperatures. Nat. Commun. 2019, 10, 3860.

25. Fishman, J. M.; Kiessling, L. L. Synthesis of Functionalizable and Degradable Polymers by Ring-Opening Metathesis Polymerization. Angew. Chem. Int. Edit. 2013, 52, 5061-5064.

26. Shieh, P.; Nguyen, H. V. T.; Johnson, J. A. Tailored silyl ether monomers enable backbone-degradable polynorbornene-based linear, bottlebrush and star copolymers through ROMP. Nat. Chem. 2019, 11, 1124-1132.

27. Fraser, C.; Hillmyer, M. A.; Gutierrez, E.; Grubbs, R. H. Degradable Cyclooctadiene Acetal Copolymers - Versatile Precursors to 1,4-Hydroxytelechelic Polybutadiene and Hydroxytelechelic Polyethylene. Macromolecules. 1995, 28, 7256-7261.

28. Steinbach, T.; Alexandrino, E. M.; Wurm, F. R. Unsaturated poly(phosphoester)s via ring-opening metathesis polymerization. Polym. Chem. 2013, 4, 3800-3806.

29. Chang, C. C.; Emrick, T. Functional Polyolefins Containing Disulfide and Phosphoester Groups: Synthesis and Orthogonal Degradation. Macromolecules. 2014, 47, 1344-1350.

30. Debsharma, T.; Behrendt, F. N.; Laschewsky, A.; Schlaad, H. Ring-Opening Metathesis Polymerization of Biomass-Derived Levoglucosenol. Angew. Chem. Int. Edit. 2019, 58, 6718-6721.

31. McGuire, T. M.; Perale, C.; Castaing, R.; Kociok-Kohn, G.; Buchard, A. Divergent Catalytic Strategies for the Cis/Trans Stereoselective Ring-Opening Polymerization of a Dual Cyclic Carbonate/Olefin Monomer. J. Am. Chem. Soc. 2019, 141, 13301-13305.

32. Feist, J. D.; Xia, Y. Enol Ethers Are Effective Monomers for Ring-Opening Metathesis Polymerization: Synthesis of Degradable and Depolymerizable Poly(2,3-dihydrofuran). J. Am. Chem. Soc. 2020, 142, 1186-1189.

33. Nagarkar, A. A.; Crochet, A.; Fromm, K. M.; Kilbinger, A. F. M. Efficient Amine End-Functionalization of Living Ring-Opening Metathesis Polymers. Macromolecules. 2012, 45, 4447-4453.

34. Schleyer, P. V.; Williams, J. E.; Blanchard, K. R. Evaluation of Strain in Hydrocarbons - Strain in Adamantane and Its Origin. J. Am. Chem. Soc. 1970, 92, 2377-2386.

35. Hlil, A. R.; Balogh, J.; Moncho, S.; Su, H. L.; Tuba, R.; Brothers, E. N.; Al-Hashimi, M.; Bazzi, H. S. Ring Opening Metathesis Polymerization (ROMP) of Five-to Eight-Membered Cyclic Olefins: Computational, Thermodynamic, and Experimental Approach. J. Polym. Sci. Pol. Chem. 2017, 55, 3137-3145.

36. Hejl, A.; Scherman, O. A.; Grubbs, R. H. Ring-opening metathesis polymerization of functionalized low-strain monomers with ruthenium-based catalysts. Macromolecules. 2005, 38, 7214-7218.

37. Neary, W. J.; Kennemur, J. G. Variable Temperature ROMP: Leveraging Low Ring Strain Thermodynamics to Achieve Well-Defined Polypentenamers. Macromolecules. 2017, 50, 4935-4941.

38. Tuba, R.; Grubbs, R. H. Ruthenium catalyzed equilibrium ring-opening metathesis polymerization of cyclopentene. Polym. Chem. 2013, 4, 3959-3962.

39. Neary, W. J.; Isais, T. A.; Kennemur, J. G. Depolymerization of Bottlebrush Polypentenamers and Their Macromolecular Metamorphosis. J. Am. Chem. Soc. 2019, 141, 14220-14229.

40. Martin, B.; Posseme, F.; Le Barbier, C.; Carreaux, F.; Carboni, B.; Seiler, N.; Moulinoux, J. P.; Delcros, J. G. (Z)-1,4-diamino-2-butene as a vector of boron, fluorine, or iodine for cancer therapy and imaging: Synthesis and biological evaluation. Bioorg. Med. Chem. 2002, 10, 2863-2871.

41. Huang, W. M.; Zhu, Z. S.; Wen, J.; Wang, X.; Qin, M.; Cao, Y.; Ma, H. B.; Wang, W. Single Molecule Study of Force-Induced Rotation of Carbon-Carbon Double Bonds in Polymers. ACS Nano. 2017, 11, 194-203.

42. Love, J. A.; Morgan, J. P.; Trnka, T. M.; Grubbs, R. H. A practical and highly active ruthenium-based catalyst that effects the cross metathesis of acrylonitrile. Angew. Chem. Int. Edit. 2002, 41, 4035-4037.

43. Li, L. Y.; Raghupathi, K.; Song, C. F.; Prasad, P.; Thayumanavan, S. Self-assembly of random copolymers. Chem. Commun. 2014, 50, 13417-13432.

44. Sprott, K. T.; McReynolds, M. D.; Hanson, P. R. Ring-closing metathesis strategies to amino acid-derived P-heterocycles. Synthesis-Stuttgart. 2001, 4, 612-620.

### Example 1B: Degradable Polyphosphoramidate via Ring-Opening Metathesis Polymerization - Supporting Information

### 1. Materials, According to Certain Embodiments

Organic solvents, including methanol (MeOH), ethanol, dimethyl sulfoxide (DMSO) and diethyl ether were purchased from either Fisher Scientific or Sigma-Aldrich and used without purification. Anhydrous solvents, including dichloromethane (DCM) and dimethyformamide (DMF) were obtained from a Grubb’s type solvent drying system prior to use. The reagents were acquired from commercial vendors, including Sigma-Aldrich, Thermo Fisher Scientific, Acros Organics, and Cambridge Isotope Laboratories Inc. All the chemicals were used as received. Phenyl and oligo(ethylene glycol) bearing norbornenes, as well as Grubbs initiator (IMesH₂)(C₅H₅N)₂(Cl)₂Ru=CHPh (I) were prepared as previously described.¹ Flash column chromatography was performed using silica gel 60 (40-63 µm, 230-400 mesh, 60 Å) purchased from Fisher Scientific. Analytical thin-layer chromatography (TLC) was carried out on silica gel 60G F254 glass plates purchased from EMD Millipore and visualized by observation of fluorescence under ultraviolet light and staining with KMnO₄ as a developing agent. Dulbecco’s phosphate buffered saline (without Ca²⁺, Mg²⁺) was purchased from Corning. Transmission electron microscopy (TEM) was performed on 400 mesh carbon grids purchased from Ted Pella, Inc. For cell studies, CellTiter-Blue® was purchased from Promega Corporation and HeLa cells were purchased from American Type Culture Collection (ATCC).

### 2. Instrumentation, According to Certain Embodiments

Nuclear Magnetic Resonance (NMR): ¹H-NMR and ³¹P-NMR spectra were recorded either on a 500 MHz Bruker Advance III HD system equipped with a TXO Prodigy probe or on a 400 MHz Bruker Advance III HD Nanobay system with SampleXpress autosampler. The residual solvent peaks were used as the reference signals (D₂O: δ 4.79 for ¹H-NMR; DMSO-d₆: δ 2.50 for ¹H-NMR).

Electrospray Ionization Mass Spectrometry (ESI-MS): ESI-MS spectra were acquired on a Bruker AmaZon SL configured with an ESI source in both negative and positive ionization mode.

Transmission Electron Microscope (TEM): Five microliters of sample were applied to a 400 mesh carbon grid (Ted Pella, Inc.) that had been glow discharged for 15 seconds. Five microliters of 2 wt.% uranyl acetate solution was then applied and wicked away for staining. Dry state TEM of nanoparticles were conducted on a Hitachi HT-7700 biological TEM at an acceleration voltage of 120 kV. The images were recorded with a slow-scan charge-coupled device (CCD) camera (Veleta 2 k × 2 k).

Thermal Analysis: Thermogravimetric analysis (TGA) was performed using Netzsch’s Simultaneous Thermal Analysis (STA) system 449 F1 “Jupiter” simultaneous thermal analyzer under helium (50 mL/min) with a heating rate of 10° C./min. DSC measurements were performed using Mettler Toledo Polymer DSC under nitrogen. Two thermal cycles (-50 to 200° C.) with heating and cooling rates of 10° C./min were performed. Glass transition temperature was obtained from the second heating scan after the thermal history was removed.

Size-Exclusion Chromatography (SEC): SEC measurements were carried out in HPLC grade dimethylformamide (DMF) with 0.05 M LiBr at 60° C. on a Phenomenex Phenogel 5, 1 K-75 K, 300 × 7.80 mm column in series with a Phenomex Phenogel 5, 10 K-1000 K, 300 × 7.80 mm column. The detection system consisted of a L-2420 Hitachi UV-Vis Detector operating at 280 nm, a Wyatt Optilab T-rEX refractive index detector operating at 658 nm and a Wyatt DAWN® HELEOS® II light scattering detector operating at 659 nm. Absolute molecular weight and dispersity were calculated using the Wyatt ASTRA software with dn/dc values determined by assuming 100% mass recovery during SEC analysis. The dn/dc of polyphosphoramidate (PPTDO) in DMF with 0.05 M LiBr was measured to be 0.1174 mL/g.

Fluorescence Measurement: CellTiter-Blue® fluorescence measurements were recorded using a Perkin Elmer EnSpire multimode Plate Reader.

### 3. Experimental Procedures, According to Certain Embodiments

### 3.1. Synthesis of Diazaphosphepine Based Cyclic Olefin Monomer

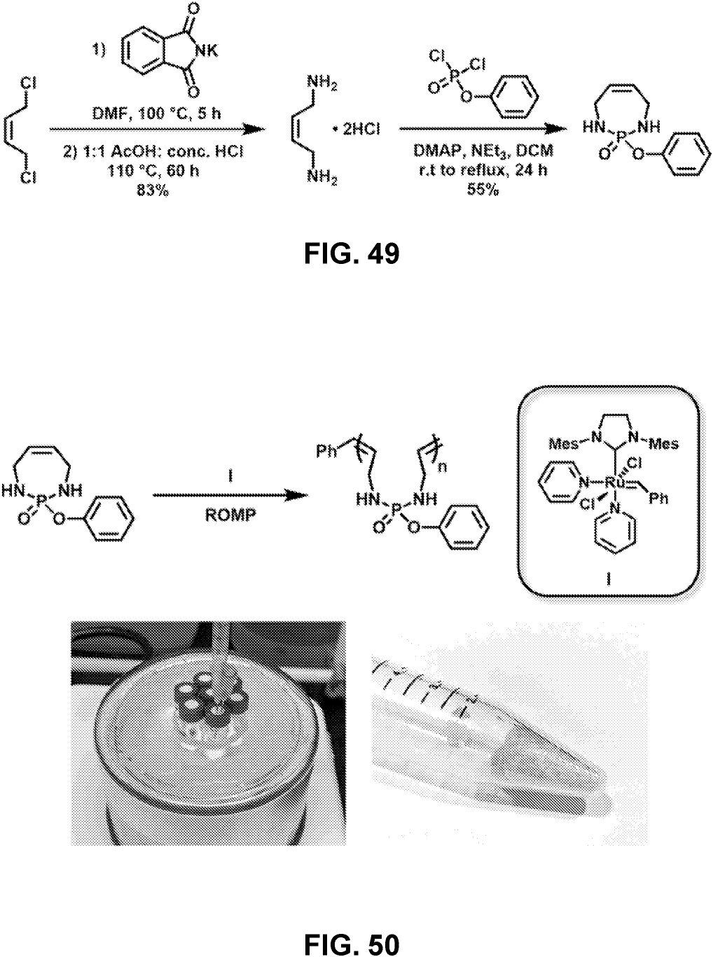

FIG. 49, which shows a schematic showing features of the synthesis of PTDO monomer, is best viewed together with the following descriptions of this subsection 3.1.

cis-1,4-diamino-2-butene▪2HCl preparation, according to certain embodiments: The compound was prepared following a procedure slightly modified from the literature.² To a suspension of potassium phthalimide (23.7 g, 128 mmol, 2.0 equiv.) in 90 mL of DMF at 0° C., cis-1,4-dichloro-2-butene (8.0 g, 64 mmol, 1.0 equiv.) was added dropwise over 30 min. The mixture was stirred at room temperature (r.t) for 10 min and then heated to 100° C. for 5 h. The reaction mixture was cooled to r.t, poured into 400 mL of ice/water and filtered to collect the solid. The residue was transferred to a 250 mL round bottom flask where 120 mL of acetic acid: concentrated HCl (1:1 v/v) solution was added and then heated to reflux for 60 h. After the precipitate was removed by filtration, the filtrate was concentrated under vacuum and recrystallized from warm ethanol to yield the product as a slightly brown solid (8.49 g, 83%). ¹H-NMR (500 MHz, D₂O): δ (ppm) 5.90 (ddt, J = 5.4, 4.4, 1.0 Hz, 2H), 3.78 - 3.76 (m, 4H).

2-phenoxy-1,3,4,7-tetrahydro-1,3,2-diazaphosphepine 2-oxide (PTDO), according to certain embodiments: The compound was prepared following a procedure slightly modified from the literature.³ A 2 L round bottom flask was flame dried, cooled and charged with 800 mL of dry DCM. To the flask, phenyl dichlorophosphate (2.20 g, 10.4 mmol, 1.0 equiv.) was added with stirring and cooled to 0° C. DMAP (127 mg, 1.04 mmol, 0.1 equiv.) and triethylamine (10.9 mL, 78.1 mmol, 7.5 equiv.) were slowly added. After 5 min, the ice bath was removed, and the solution was stirred at room temperature (r.t) for another 15 min until a slightly yellow color was observed. Cis-1,4-diamino-2-butene·2HCl (2.00 g, 12.5 mmol. 1.2 equiv.) was separately dissolved in 50 mL of dry DCM and triethylamine (5.08 mL, 36.4 mmol, 3.5 equiv.). The mixture was slowly added to the phenyl dichlorophosphate solution over 30 min. The resulting mixture was stirred at r.t for 30 min and heated to reflux under N₂ for 24 h. The reaction was then cooled and concentrated under vacuum to about 200 mL. Water was added and the aqueous layer was extracted three times with DCM. The combined organic layer was dried over MgSO₄ and concentrated to dryness. The residue was purified via column chromatography (10% MeOH in DCM) to yield the product as a slightly yellow solid (1.24 g, 53%). ¹H-NMR (500 MHz, DMSO-d₆): δ (ppm) 7.37 - 7.30 (m, 2H), 7.17 (dq, J = 7.7, 1.2 Hz, 2H), 7.12 (ddd, J = 8.4, 6.8, 1.0 Hz, 1H), 5.57 (t, J = 2.3 Hz, 2H), 5.38 -5.28 (m, 2H), 3.45 (ddt, J = 19.7, 7.0, 2.2 Hz, 4H). ¹³C-NMR (126 MHz, DMSO-d₆): δ (ppm) 151.90, 151.85, 129.82, 129.42, 124.26, 121.19, 121.15, 38.68. ³¹P-NMR (202 MHz, DMSO-d₆): δ (ppm) 17.67. ESI-MS: calculated for C₁₀H₁₃N₂O₂P [M+Na]⁺ 247.06; found 246.99.

### 3.2. Representative Procedure for PTDO Homopolymerization, According To Certain Embodiments

FIG. 50 is a schematic showing features of a synthesis of a polymer’s repeating units, according to embodiments herein, using a PTDO monomer and a Grubbs initiator (“I”) (IMesH₂)(C₅H₅N)₂(Cl)₂Ru=CHPh. PTDO has limited solubility in pure DCM, thus MeOH was doped in to achieve desired monomer concentrations. A mixed solvent of MeOH/DCM (10/90, v/v) was dried over 3 Å molecular sieves overnight and freeze-pump-thawed three times to degas immediately prior to polymerization. Grubbs initiator (IMesH₂)(C₅H₅N)₂(Cl)₂Ru=CHPh (I) (1.64 mg, 1.0 equiv.) and PTDO (50.4 mg, 100 equiv.) were weighed separately in two HPLC type vials containing stir bars. Both vials and the solvent were transferred to a glovebox operated under N₂. Initiator I was dissolved in 150 µL of solvent, giving a green solution. PTDO was dissolved in 300 µL of solvent under stirring, resulting in a clear solution. Both solutions (with the caps on to prevent contact with air) were removed from the glovebox. The initiator solution was cooled in an ice/water bath (2° C.) for 5 min before the addition of the PTDO solution. A color change from green to slightly brown was observed 5 min post addition. After 5 h, 100 µL of ethyl vinyl ether (EVE) was added and the solution was stirred for 30 min to terminate the polymerization. An aliquot of the reaction was taken out, reduced under vacuum and dissolved in DMSO-d₆ for NMR analysis. The rest of the reaction mixture was precipitated in ice-cold diethyl ether and centrifuged to collect the solid. The resulting solid was re-dissolved in a mixed solvent of MeOH/DCM (10/90, v/v) and precipitated in diethyl ether again. The same procedure was repeated two times to remove unreacted monomers. The product was dried under vacuum to yield the PPTDO as a yellow solid.

### 3.3. Representative Procedure for Random Copolymerization of PTDO with Norbornene, According to Certain Embodiments

A mixed solvent of MeOH/DCM (5/95, v/v) was dried over 3 Å molecular sieves overnight and freeze-pump-thawed three times immediately prior to polymerization. The phenyl bearing norbornene NBPh (18.8 mg, 50 equiv.), and PTDO (16.6 mg, 50 equiv.) monomers were added into a HPLC vial. Initiator I (1.08 mg, 1.0 equiv.) was weighed in a separate HPLC vial. The reagents and solvent were transferred to the glovebox operated under N₂. Each of the reagents were completely dissolved with the solvent (I: 200 µL, NBPh and PTDO mixture: 300 µL), capped and removed from the glovebox. The initiator solution was cooled in an ice/water bath (2° C.) for 5 min and then the monomer mixture was added. After 5 h, the reaction was terminated with 100 µL of EVE. After 30 min, an aliquot of the reaction was taken out, concentrated under vacuum and dissolved in DMSO-d₆ for NMR analysis. The rest of the reaction mixture was precipitated in ice-cold diethyl ether and centrifuged to collect the solid. The resulting solid was re-dissolved in a mixed solvent of MeOH/DCM (5/95, v/v) and precipitated in diethyl ether again. The same procedure was repeated two times to remove the unreacted monomers. The solid was dried under vacuum to yield the NBPh₄₂-co-PTDO₃₂ random copolymer.

### 3.4. Representative Procedure for Block Copolymerization of PTDO with Norbornene, According to Certain Embodiments

A mixed solvent of MeOH/DCM (10/90, v/v) was dried over 3 Å molecular sieves overnight and freeze-pump-thawed three times immediately prior to polymerization. Initiator I (1.96 mg, 1.0 equiv.), phenyl bearing norbornene NBPh (34.1 mg, 50 equiv.), and PTDO (30.2 mg, 50 equiv.) were weighed in separate HPLC vials. The reagents and solvent were transferred to the glovebox operated under N₂. Each of the reagents were completely dissolved with the solvent (I: 100 µL; NBPh: 150 µL; PTDO: 200 µL). NBPh was added to I, resulting in an immediate color change from green to brown. After 1 h, both the reaction mixture and PTDO solution were removed from the glovebox. The reaction mixture was cooled in an ice/water bath (2° C.) for 5 min, followed by addition of the PTDO solution. After 3 h, the reaction was quenched with 100 µL of EVE. After 30 min, an aliquot of the reaction was removed, concentrated under vacuum and dissolved in DMSO-d₆ for NMR analysis. The NBPh₅₀-b-PTDO₂₅ block copolymer was precipitated and dried following the same procedures as the random copolymer (vide supra).

### 3.5. Synthesis of Polynorbornene Controls, According to Certain Embodiments

Homopolymerizations of the norbornene monomers were setup in parallel with each of the copolymerizations outlined above. The same feed ratio of I to norbornene was used in each case. A solution of the norbornene monomer was added to a solution of I in the glovebox with the reaction being terminated with EVE after 1 h. An aliquot of the polymerization was removed, concentrated under vacuum and dissolved in DMSO-d₆ for NMR analysis. The polymer was precipitated and dried following the same procedures as the random copolymer (vide supra).

### 3.6. Degradation of PTDO and PPTDO via Acid Hydrolysis, According To Certain Embodiments

PTDO and PPTDO were dissolved separately in 0.6 mL DMSO-d₆ at a concentration of 4 mg/mL. 40 µL of 4 M HCl was added to each solution to yield a final concentration of 0.25 M HCl in DMSO-d₆. The solution was transferred to an NMR tube for ¹H- and ³¹P-NMR analysis.

### 3.7. Degradation of NB-PTDO Copolymer and Polynorbornene via Acid Hydrolysis, According to Certain Embodiments

Each of the NB-PTDO copolymers and polynorbornenes were dissolved in 0.45 mL DMSO-d₆ at a concentration of 4 mg/mL. 20 µL of 12 M HCl was added to each solution to yield a final concentration of 0.5 M HCl in DMSO-d₆. The resulting solution was stirred at room temperature for 24 h. Excess MgSO₄ was added and the mixture was vortexed. The mixture was allowed to sit for 10 min then centrifuged. The clear top layer was collected, filtered and concentrated under vacuum. The residue was dissolved in DMF with 0.05 M LiBr for SEC-MALS analysis.

### 3.8. Nanoparticle Formulation, According to Certain Embodiments

2.5 mg of polymer was dissolved in 0.6 mL DMSO. 1X Dulbecco’s phosphate-buffered saline (DPBS) was added via a syringe pump at the speed 50 µL/h until reaching 30% DPBS in DMSO (v/v). The solution was left stirring overnight then transferred into SnakeSkin™ Dialysis Tubing (3.5 K MWCO) and dialyzed against DPBS for 48 h with three buffer changes. The resulting solution had a 1.3 mg/mL polymer concentration based on initial polymer loading and final solution volume.

### 3.9. Cell Viability Assay, According to Certain Embodiments

HeLa cells were grown in Dulbecco’s Modified Eagle’s Medium (DMEM) supplemented with 10% fetal bovine serum (FBS), and 1% penicillin-streptomycin. Cells were maintained at 37° C. and 5% CO₂ with a relative humidity of 95%. HeLa cells were plated in 96-well plates at a density of 7500 cells per well and then left to attach for 24 h. Subsequently, the cells were treated with the nanoparticles at various concentrations for 24 h followed by washing 3 times with phosphate-buffered saline (PBS). CellTiter-Blue® at 10% (v/v) in complete media was added to each well and incubated for 2 h to allow the metabolic cells to convert resazurin to fluorescent resorufin. The fluorescent signal (Excitation wavelength: 560 nm; Emission wavelength: 600 nm) was then analyzed by a plate reader. Four replicates were performed for each independent sample. 10% DMSO was used as a positive control and untreated cells in complete medium was used as a negative control. Viability is reported as a percentage of untreated cells.

### 4. Ring Strain via Density Functional Theory Calculation, According to Certain Embodiments

(See also FIG. 5.) Density functional theory (DFT) calculations were performed using Spartan 14.^{4,}⁵ Geometry optimizations of reactants and product were performed at the B3LYP/6-31 g(d) level of theory. The conventional B3LYP functional has been proven to generate adequate geometries but perform poorly in energy calculations. Therefore, the energies were refined with the ω B97X-D functional including dispersion corrections and a 6-31 g(d) basis set. The enthalpy or heat of formation has been estimated as the energy difference between the total energy of the ring-opened molecule and the energy of the isolated reactants (PTDO + ethylene). DCM was used as the solvent for geometry optimizations and energy calculations.

### 5. Tables and SEC Traces, According to Certain Embodiments: See FIGS. 6-8

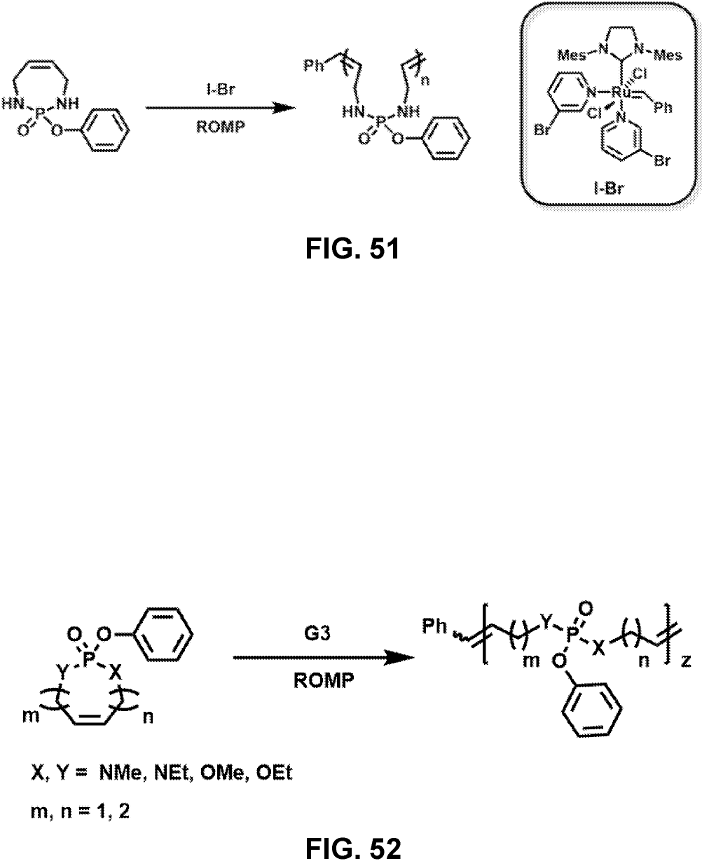

FIG. 51 is a schematic showing features of a synthesis of a polymer’s repeating units, according to embodiments herein, using a PTDO monomer and a bromopyridine modified Grubbs initiator (“I-Br”) [(IMesH₂)(C₅H₄NBr)₂(Cl)₂Ru=CHPh].

TABLE 3

ROMP of PTDO under varying temperatures initiated with I-Br

| Entry | T (°C) | [M]₀ (M) | [M]:[cat] | Time (h) | Conv. | M_{n,} ₜₕₑₒ (kDa) | Mₙ, _{MALS} (kDa) | Ð |
|---|---|---|---|---|---|---|---|---|
| 1 | 40 | 0.3 | 100:1 | 5 | 30% | 6.7 | 3.1 | 1.44 |
| 2 | 20 | 0.3 | 100:1 | 5 | 41% | 9.2 | 3.5 | 1.62 |
| 3 | 2 | 0.3 | 100:1 | 5 | 62% | 14.0 | 12.5 | 1.36 |

### 6. Kinetics of PTDO Homopolymerization, According to Certain Embodiments

### 6.1. Reaction Kinetics by NMR, According to Certain Embodiments: See FIGS. 9-10

6.2. Example of Monomer Conversion Calculation, according to certain embodiments: Calculation of monomer conversion for the polymerizations of PTDO was made based on the assumption that the chemical shift of the aromatic protons at δ = 7.33 ppm did not change before and after polymerization, giving a total integration of 2 which can serve as an internal standard. Thus, the integrations of other signals are as following:

$${\text{I}}_{\text{vinyl}} = {\text{I}}_{\text{a}} \left(\text{unreacted monomer}\right) + {\text{I}}_{{\text{a}}^{′}} \left(\text{polymer}\right) \approx 2$$

$${\text{I}}_{\text{methylene}} = {\text{I}}_{\text{b}} \left(\text{unreacted monomer}\right) + {\text{I}}_{{\text{b}}^{′}} \left(\text{polymer}\right) \approx 4$$

$${\text{I}}_{\text{NH}} = {\text{I}}_{\text{c}} \left(\text{unreacted monomer}\right) + {\text{I}}_{{\text{c}}^{′}} \left(\text{polymer}\right) \approx 2$$

The monomer conversion M% was calculated based on the following equation:

$$\text{M\% =} \frac{\left[\left(\frac{{I}_{a}}{{I}_{a} + {I}_{{a}^{′}}}\right) + \left(\frac{{I}_{b}}{{I}_{b} + {I}_{{b}^{′}}}\right) + \left(\frac{{I}_{c}}{{I}_{c} + {I}_{{c}^{′}}}\right)\right]}{3}$$

See also FIG. 11.

### 7. Thermal Characterization of PPTDO: See FIGS. 12-13

### 8. Kinetics of PTDO and PPTDO Degradation via Acid Hydrolysis: See FIGS. 14A-14B

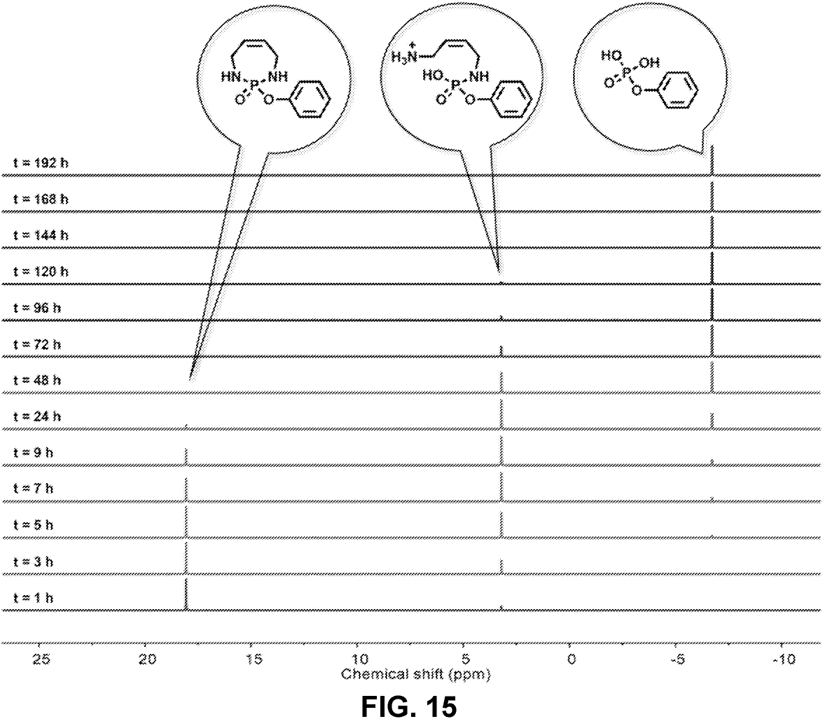

8.1. Kinetics of PTDO Degradation via Acid Hydrolysis: see FIGS. 15-17.

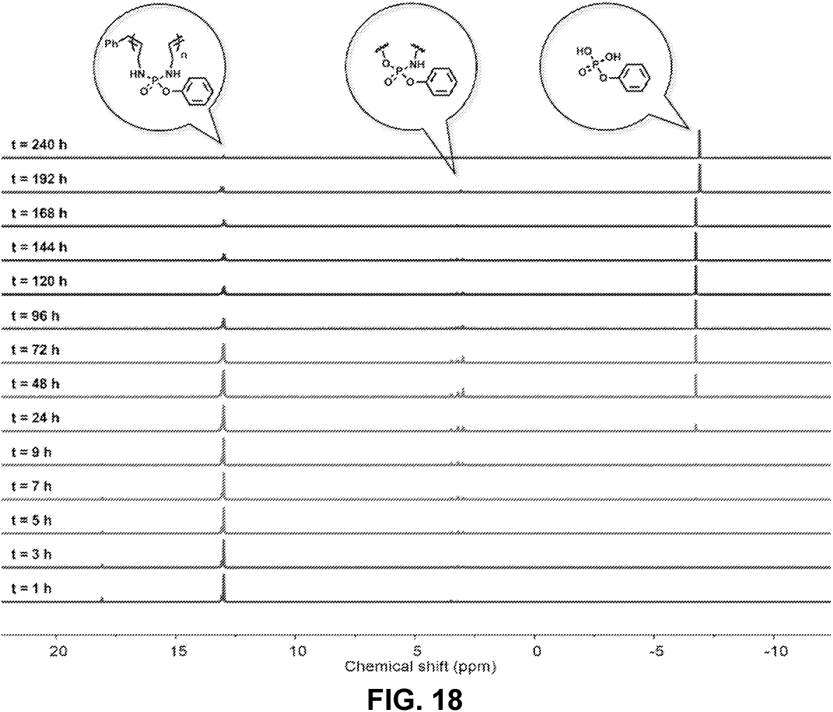

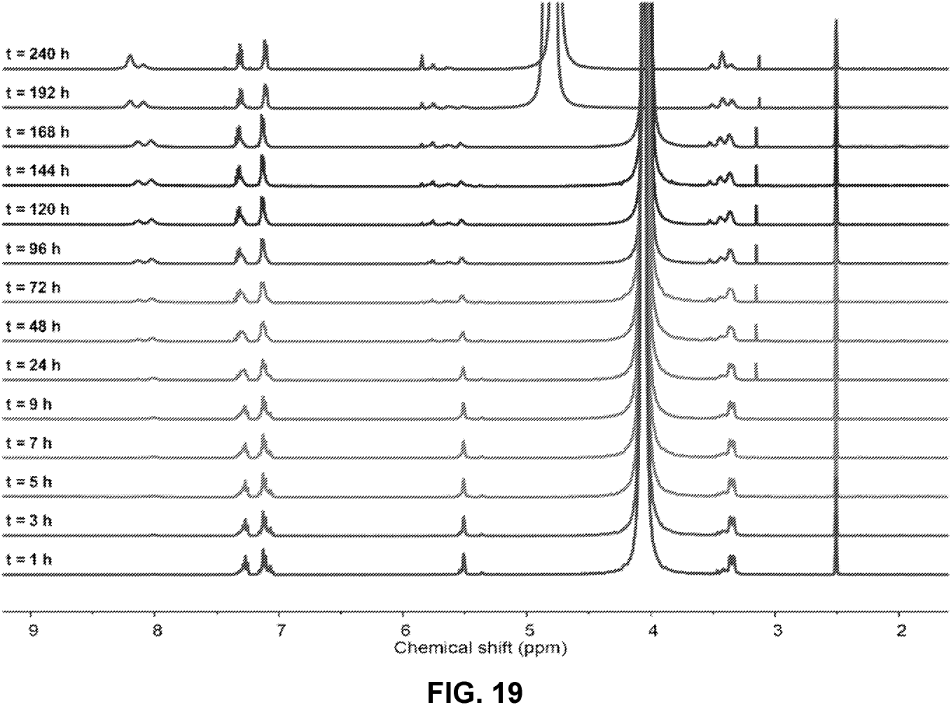

8.2. Kinetics of PPTDO Degradation via Acid Hydrolysis: see FIGS. 18-19.

### 9. Copolymerization of PTDO With Norbornenes

9.1. Random Copolymerization of PTDO with Norbornenes: see FIGS. 20-21.

9.2. Block Copolymerization of PTDO with Norbornenes: see FIGS. 22-23.

### 10. Micellar Nanoparticle Characterization and Cytotoxicity: See FIGS. 24A-24C

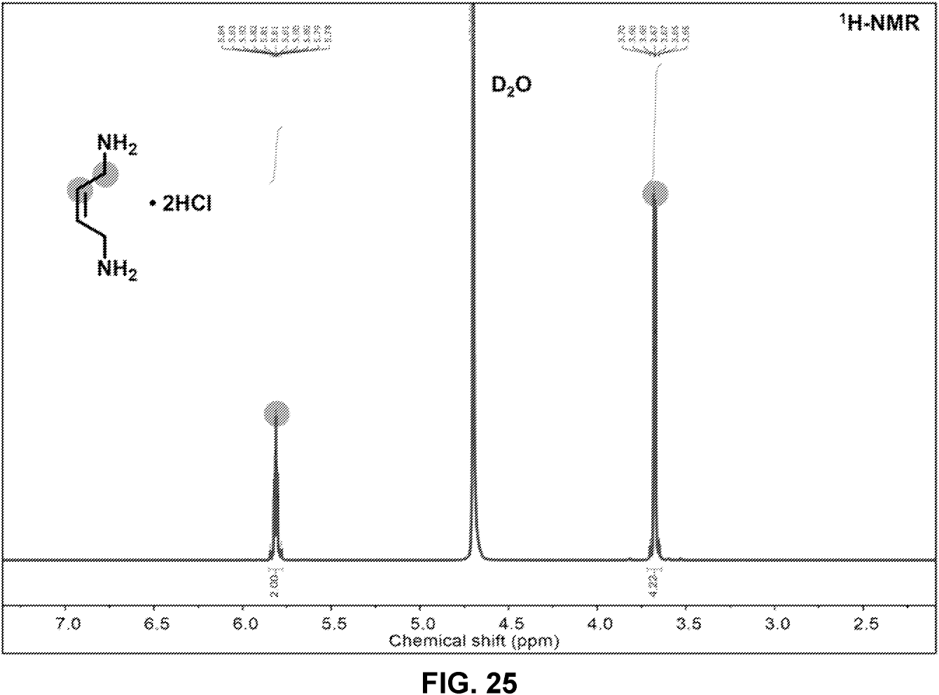

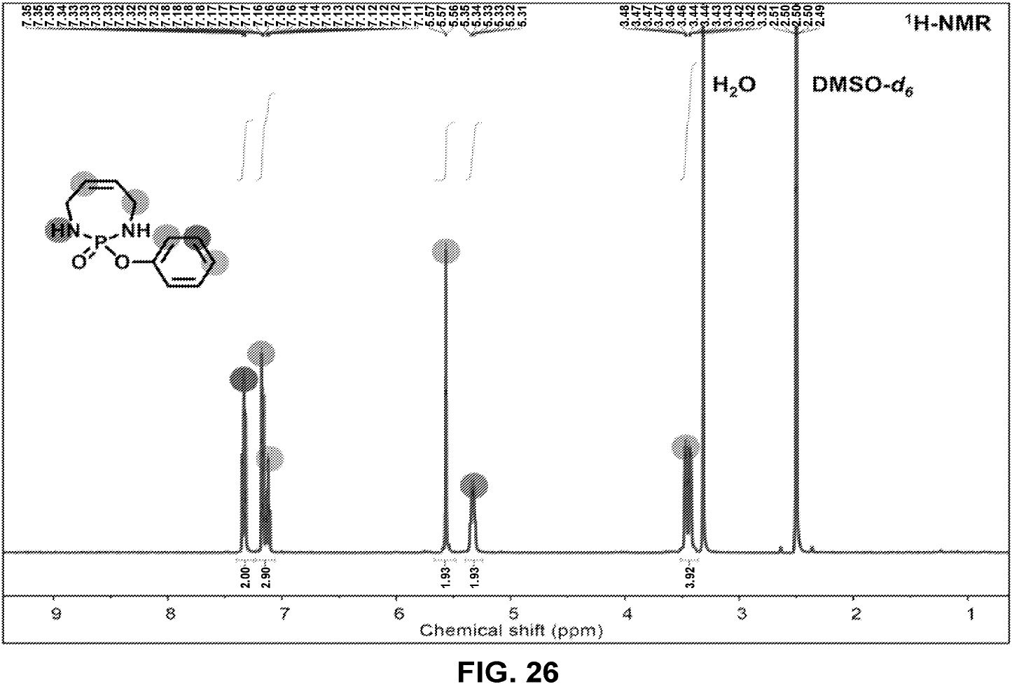

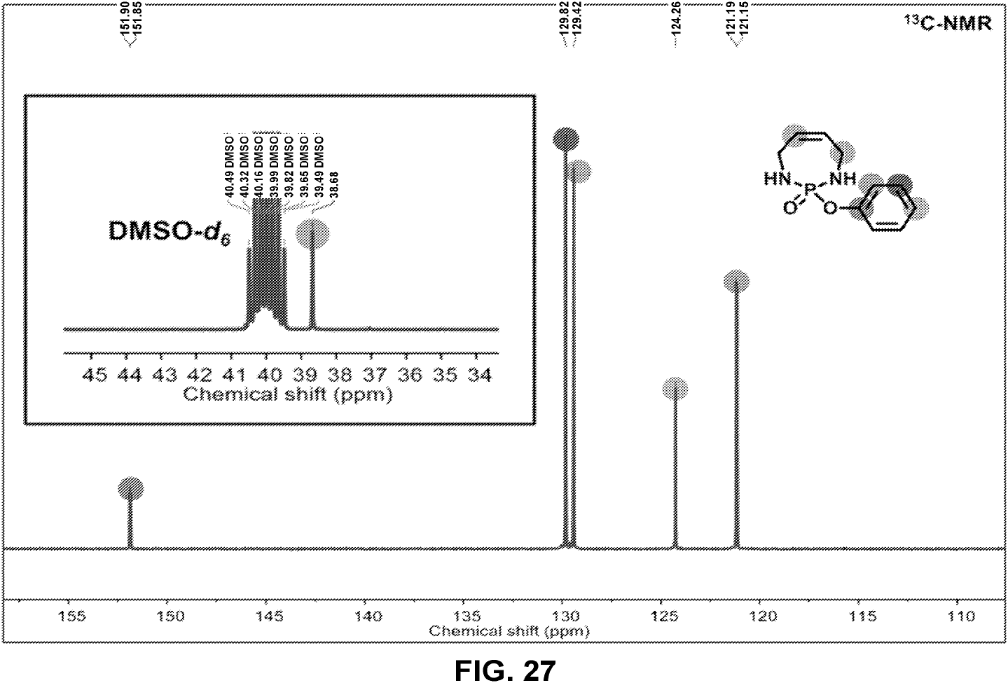

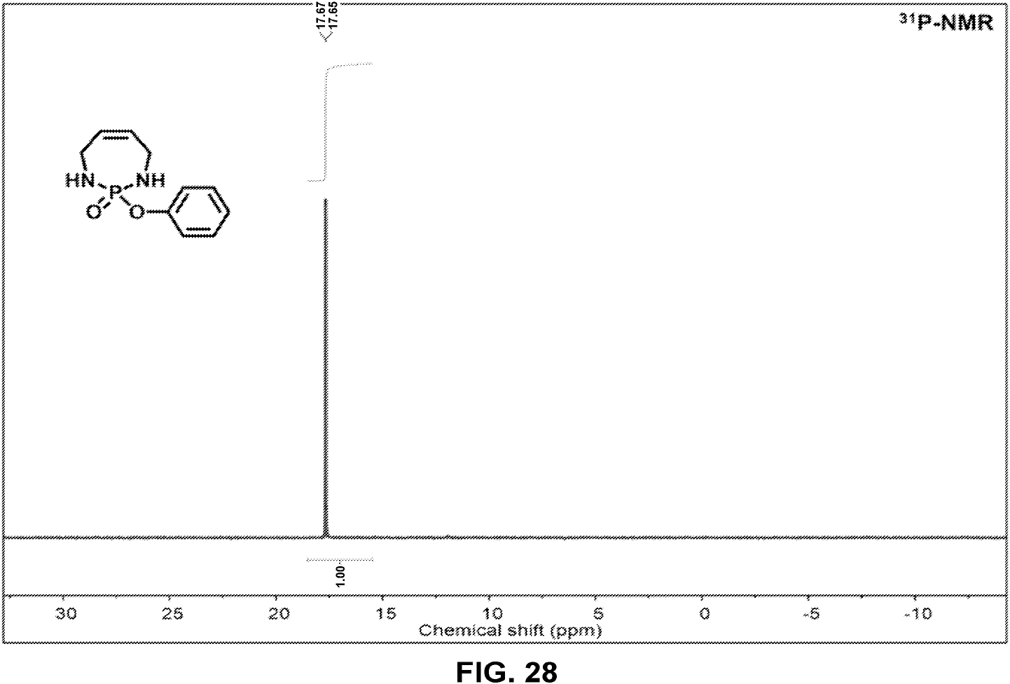

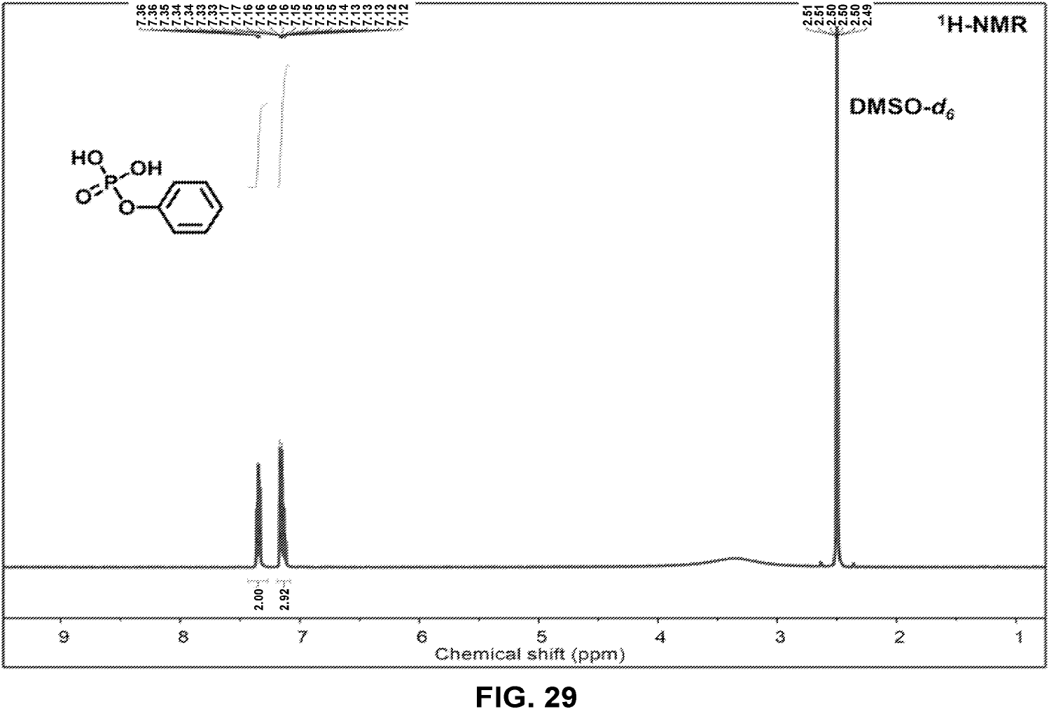

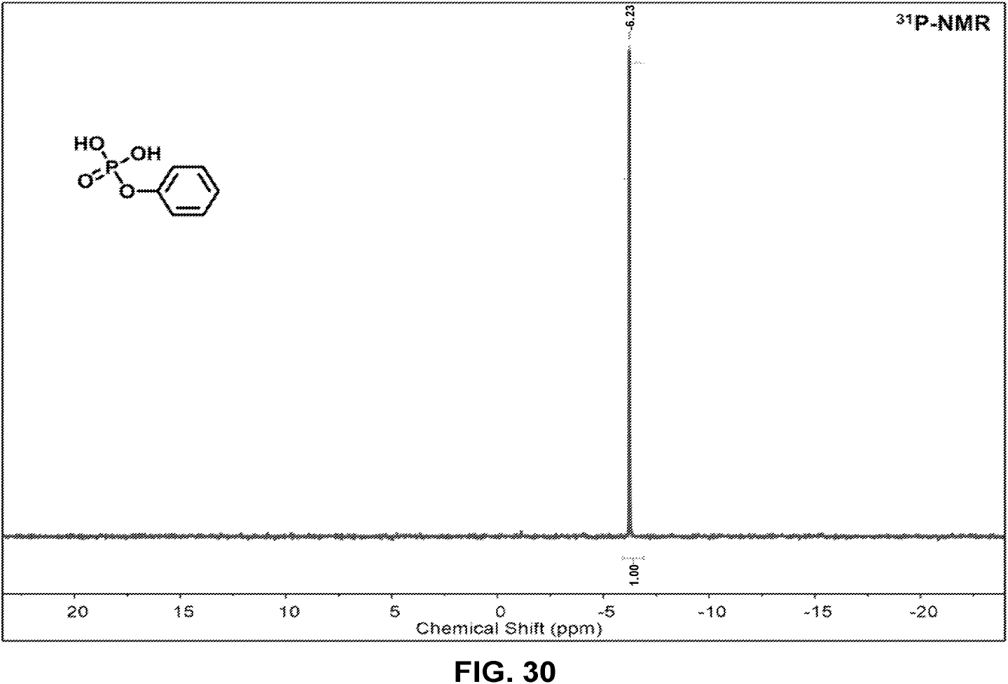

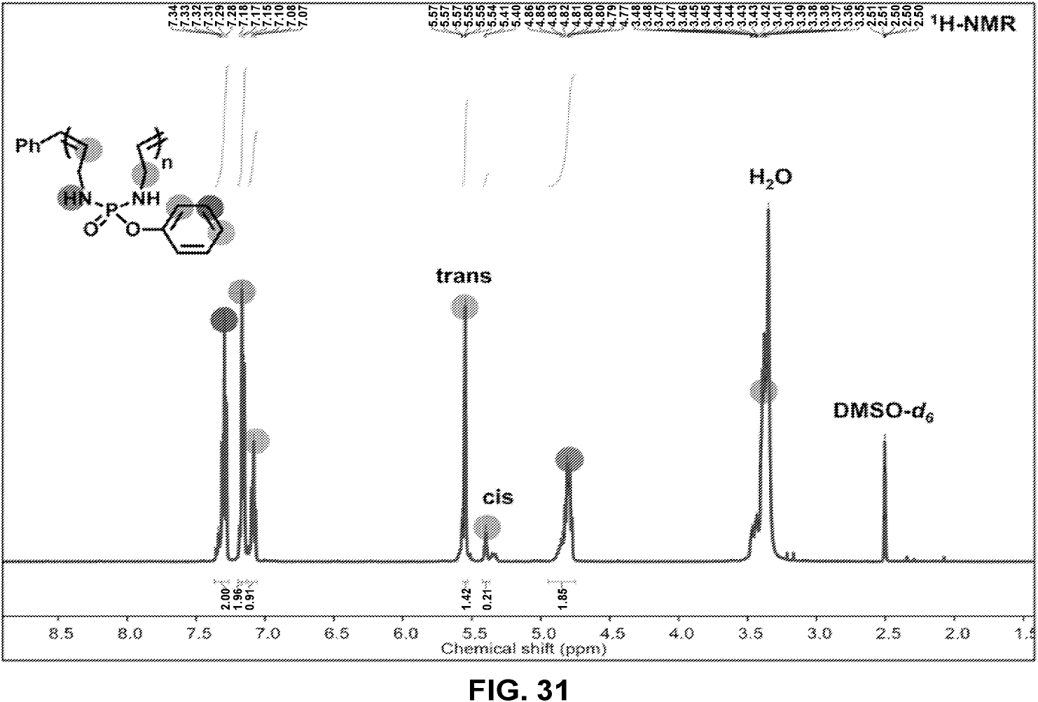

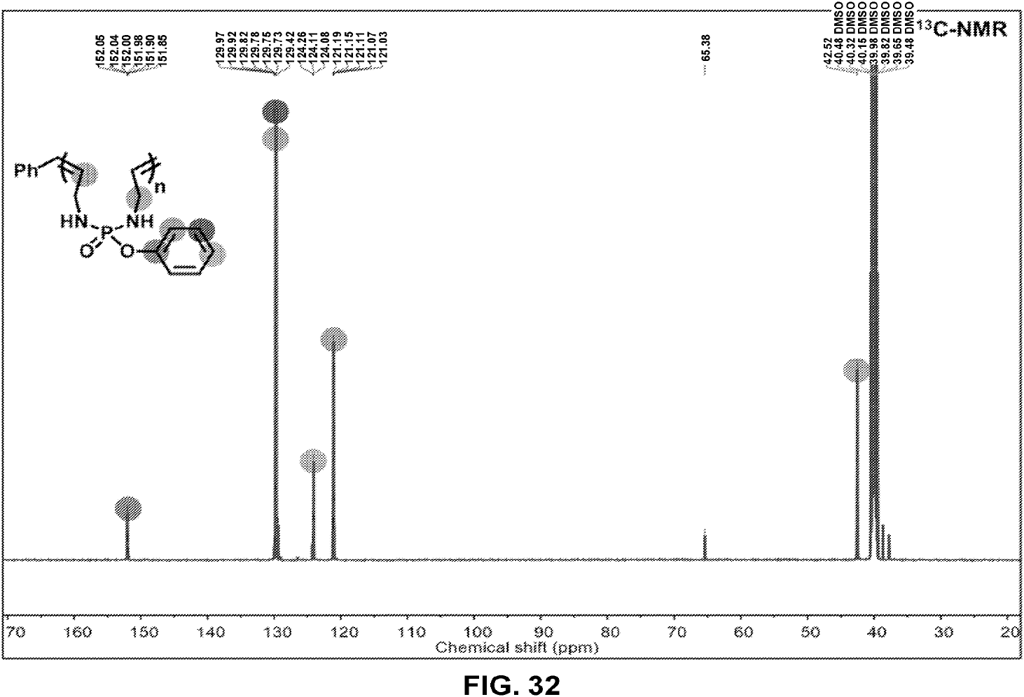

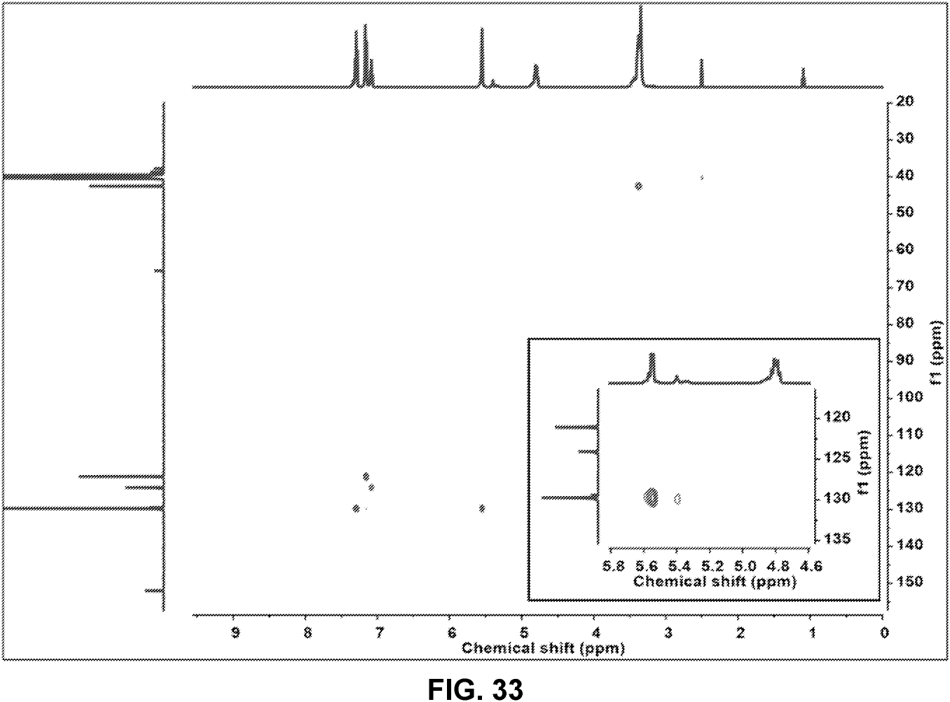

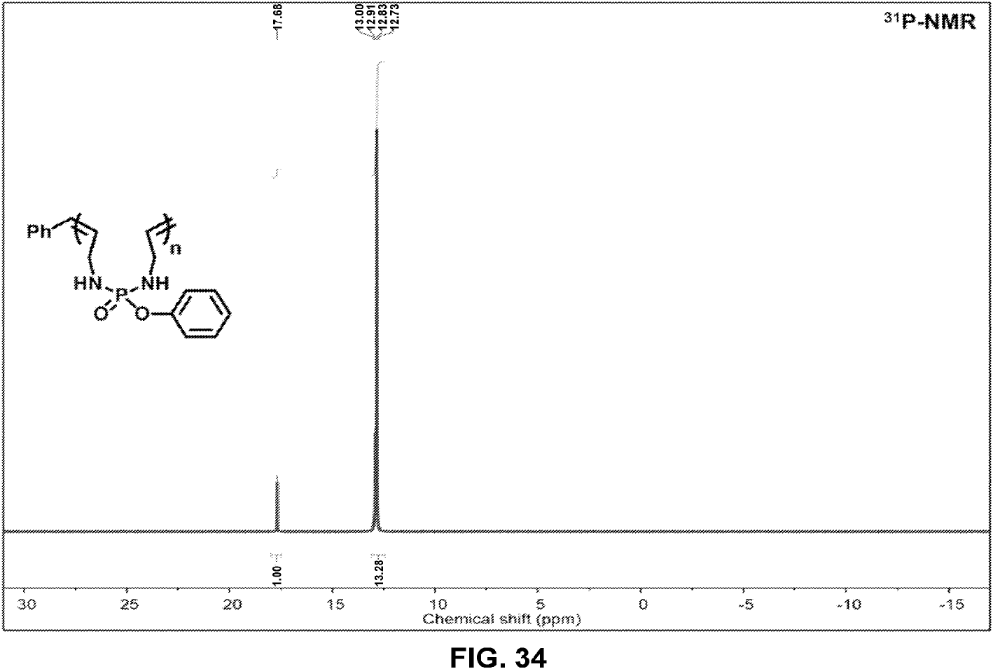

### 11. NMR Spectra: See FIGS. 25-34

References corresponding to Example 1B:
1. Thompson, M. P.; Randolph, L. M.; James, C. R.; Davalos, A. N.; Hahn, M. E.; Gianneschi, N. C. Labelling polymers and micellar nanoparticles via initiation, propagation and termination with ROMP. Polym. Chem. 2014, 5, 1954-1964.
2. Huang, W. M.; Zhu, Z. S.; Wen, J.; Wang, X.; Qin, M.; Cao, Y.; Ma, H. B.; Wang, W. Single Molecule Study of Force-Induced Rotation of Carbon-Carbon Double Bonds in Polymers. ACS Nano. 2017, 11, 194-203.
3. Nagarkar, A. A.; Crochet, A.; Fromm, K. M.; Kilbinger, A. F. M. Efficient Amine End-Functionalization of Living Ring-Opening Metathesis Polymers. Macromolecules. 2012, 45, 4447-4453.
4. Sun, H.; Kabb, C. P.; Dai, Y. Q.; Hill, M. R.; Ghiviriga, I.; Bapat, A. P.; Sumerlin, B. S. Macromolecular metamorphosis via stimulus-induced transformations of polymer architecture. Nat. Chem. 2017, 9, 817-823.
5. Shao, Y.; Molnar, L. F.; Jung, Y.; Kussmann, J.; Ochsenfeld, C.; Brown, S. T.; Gilbert, A. T. B.; Slipchenko, L. V.; Levchenko, S. V.; O′Neill, D. P.; DiStasio, R. A.; Lochan, R. C.; Wang, T.; Beran, G. J. O.; Besley, N. A.; Herbert, J. M.; Lin, C. Y.; Van Voorhis, T.; Chien, S. H.; Sodt, A.; Steele, R. P.; Rassolov, V. A.; Maslen, P. E.; Korambath, P. P.; Adamson, R. D.; Austin, B.; Baker, J.; Byrd, E. F. C.; Dachsel, H.; Doerksen, R. J.; Dreuw, A.; Dunietz, B. D.; Dutoi, A. D.; Furlani, T. R.; Gwaltney, S. R.; Heyden, A.; Hirata, S.; Hsu, C. P.; Kedziora, G.; Khalliulin, R. Z.; Klunzinger, P.; Lee, A. M.; Lee, M. S.; Liang, W.; Lotan, I.; Nair, N.; Peters, B.; Proynov, E. I.; Pieniazek, P. A.; Rhee, Y. M.; Ritchie, J.; Rosta, E.; Sherrill, C. D.; Simmonett, A. C.; Subotnik, J. E.; Woodcock, H. L.; Zhang, W.; Bell, A. T.; Chakraborty, A. K.; Chipman, D. M.; Keil, F. J.; Warshel, A.; Hehre, W. J.; Schaefer, H. F.; Kong, J.; Krylov, A. I.; Gill, P. M. W.; Head-Gordon, M. Advances in methods and algorithms in a modern quantum chemistry program package. Phys. Chem. Chem. Phys. 2006, 8, 3172-3191.

### Example 2: Examples of Phosphoramidate Type Degradable Monomers

TABLE 4

Examples of phosphoramidate type degradable monomers

| | | |
|---|---|---|
| Formula | Name | Notes |
| 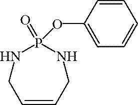 [SMILES: O=P1(Oc2ccccc2)NCC=CCN1] | 2-phenoxy-1,3,4,7-tetrahydro-1,3,2-diazaphosphepine 2-oxide | Synthesized and polymerized at 2° C. (~60% monomer conversion in 10% v/v MeOH/DCM) |
| 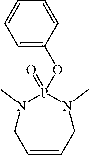 | 1,3-dimethyl-2-phenoxy-1,3,4,7-tetrahydro-1,3,2-diazaphosphepine 2-oxide | Synthesized and polymerized at room temperature (>80% monomer conversion in DCM and DMF) |
| 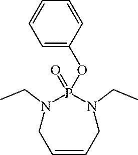 [SMILES: CCN1CC=CCN(CC)P1(=O)Oc1ccccc1] | 1,3-diethyl-2-phenoxy-1,3,4,7-tetrahydro-1,3,2-diazaphosphepine 2-oxide | Synthesized |
| 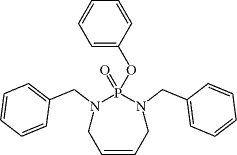 [SMILES: O=P1(Oc2ccccc2)N(Cc2ccccc2)CC=CCN1Cc1ccccc1] | 1,3-dibenzyl-2-phenoxy-1,3,4,7-tetrahydro-1,3,2-diazaphosphepine 2-oxide | Synthesized |
| 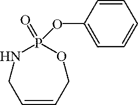 [SMILES: O=P1(Oc2ccccc2)NCC=CCO1] | 2-phenoxy-3,4,7-trihydro-1,3,2-oxazaphosphepine 2-oxide | Prophetic example |
| 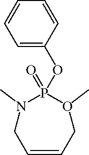 | 1,3-dimethyl-2-phenoxy-3,4,7-trihydro-1,3,2-oxazaphosphepine 2-oxide | Prophetic example |
| 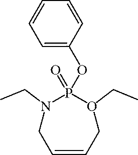 | 1,3-diethyl-2-phenoxy-3,4,7-trihydro-1,3,2-oxazaphosphepine 2-oxide | Prophetic example |
| 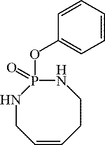 [SMILES: O=P1(Oc2ccccc2)NC/C=C\CCN1] | (Z)-2-phenoxy-1,3,4,5,8-pentahydro-1,3,2-diazaphosphocine 2-oxide | Prophetic example |
| 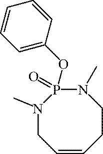 [SMILES: CN1C/C=C\CCN(C)P1(=O)Oc1ccccc1] | (Z)-1,3-dimethyl-2-phenoxy-1,3,4,5,8-pentahydro-1,3,2-diazaphosphocine 2-oxide | Prophetic example |
| 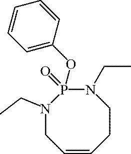 [SMILES: CCN1C/C=C\CCN(CC)P1(=O)Oc1ccccc1] | (Z)-1,3-diethyl-2-phenoxy-1,3,4,5,8-pentahydro-1,3,2-diazaphosphocine 2-oxide | Prophetic example |
| 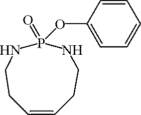 [SMILES: O=P1(Oc2ccccc2)NCC/C=C\CCN1] | (Z)-2-phenoxy-1,3,4,5,8,9-hexahydro-1,3,2-diazaphosphonine 2-oxide | Prophetic example |
| 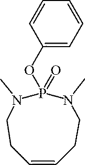 | (Z)- 1,3-dimethyl-2-phenoxy-1,3,4,5,8,9-hexahydro-1,3,2-diazaphosphonine 2-oxide | Prophetic example |
| 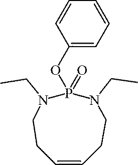 [SMILES: CCN1CC/C=C\CCN(CC)P1(=O)Oc1ccccc1] | (Z)- 1,3-diethyl-2-phenoxy-1,3,4,5,8,9-hexahydro-1,3,2-diazaphosphonine 2-oxide | Prophetic example |
| Phosphoroester variations of above | (E¹ and E² are O or O-R⁷) | Prophetic examples |

### Example 3: Examples of Comonomer Species

TABLE 5

Examples of comonomer species (e.g., second or third monomers for polymerizing to second or third repeating units)

| | |
|---|---|
| Formulas | Names and Notes |
| 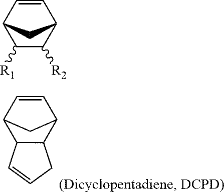 | Norbornene and its derivatives. For example, dicyclopentadiene (DCPD) is a commercially available monomer whose polymer is commonly used in the fabrication of paints and adhesives. |
| 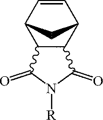 | Norbornene dicarboxylic imide and its derivatives |
| 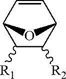 | Oxanorbornene and its derivatives |
| 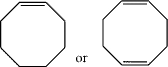 | cyclooctene, 1,5-cyclooctadiene and their derivatives |
| 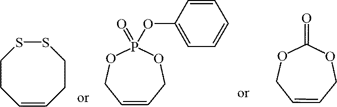 | Other low ring strain monomers reported in the literature, such as disulfide, phosphoester, and carbonate containing cyclic olefins. This can lead to the formation of block polymers with sequential degradation rates. |

### Example 4: Exemplary General Synthesis Scheme

FIG. 52 is a schematic of a generalized method, according to some embodiments herein, for forming a polymer, or portion thereof, having degradable repeating units, according to certain embodiments herein. Experimental data suggests that the phenoxy group on phosphorous is important to stabilize the cyclized ring structure and maintain the glass transition temperature of the resulting polymer. X and Y groups (in scheme shown immediately adjacent to this paragraph) can be heteroatoms such as N, O and their substituted derivatives. The size of the ring can potentially be expanded from seven membered ring to nine membered ring, for example.

### Example 5: Discussion of Aspects and Embodiments Concerning Polymerization of PTDO or Derivatives Thereof

The molecule 2-phenoxy-1,3,4,7-tetrahydro-1,3,2-diazaphosphepine 2-oxide (PTDO) was originally reported by Kilbinger group (Nagarkar, A. A.; Crochet, A.; Fromm, K. M.; Kilbinger, A. F. M. Efficient Amine End-Functionalization of Living Ring-Opening Metathesis Polymers. Macromolecules. 2012, 45, 4447-4453) as an end-capping agent for amine functionalization of living ROMP polymers. In that report, the researchers claimed the formation of a very unreactive carbene post PTDO incorporation. However, Kilbinger did not observe initiation when the first generation Grubbs catalyst (G1) was used and only dimers or trimers were formed when the third generation Grubbs catalyst (G3) was used. A similar result was reported by Wurm (“Unsaturated poly(phosphoester)s via ring-opening metathesis polymerization” Steinbach, T.; Alexandrino, E. M.; Wurm, F. R. Unsaturated poly(phosphoester)s via ring-opening metathesis polymerization. Polym. Chem. 2013, 4, 3800- 3806, DOI: 10.1039/c3py00437f), which failed to polymerize a structurally similar phosphoester based cyclic olefin via ROMP either at room temperature or higher.

Instead, however, the above missing features or failures of the above characterized prior reports are overcome by embodiments disclosed herein. It is contemplated that selection of the following multiple parameters contribute to the success or failure of polymerizing PTDO (especially for obtaining DP greater than 3): (1) temperature selection; (2) catalyst selection; (3) monomer concentration; and (4) solvent. As confirmed by Density Functional Theory (DFT) calculation, PTDO has a relatively low ring strain (10.86 kcal/mol, which is significantly lower than the 27.2 kcal/mol strain energy for commonly used norbornenes). Since ROMP is majorly a thermodynamically driven process, for low strain system, the enthalpy gain post ring opening is not high enough to offset the entropy loss, leading to an equilibrium between monomer and polymer as indicated by the Gibbs Free Energy and Van’t Hoff equations below.

$$Δ G = Δ H - T Δ S \left(Δ H < 0 , Δ S < 0 \text{for polymerization}\right)$$

In

$$\left[{M}_{e}\right] = \frac{Δ {H}_{p}}{R T} - \frac{Δ {S}^{°}}{R}$$

where Mₑ is the equilibrium monomer concentration and R is ideal gas constant

Thus, it is contemplated herein that performing polymerization at low temperature should minimize the unfavorable entropy term and drive the equilibrium towards polymer formation. This is not obvious to one of ordinary skill since the initiation efficiency of Grubbs catalyst decreases with temperature and those of skill in the art typically choose to perform polymerization at high temperature to promote this initiation step. Therefore, choosing the ideal reaction temperature and a catalyst that stays active at the selected temperature is key for successful polymerization. It was also determined herein to perform polymerization with G3 catalyst (either the pyridine or the bromopyridine version) which yielded high molecular weight polymers with narrow dispersity at 2° C., while the G1 and G2 only offered oligomers under same condition. For low strain cyclic olefins, high initial monomer concentration (usually 1~2 M) is also important to favor polymer formation. However, it was found that PTDO is highly crystalline and has limited solubility in pure DCM or chloroform (less than 0.3 M). Fortunately, it was discovered herein that by doping in 5~10% MeOH, for example, the monomer concentration can be increased, to 0.5 M for example, without hampering the monomer structural integrity or reactivity. As compared to the reaction with 0.3 M initial monomer concentration, it was discovered herein that polymerization reaction with 0.5 M showed improved monomer to polymer conversion and less secondary metathesis reactions such as chain transfer and backbiting, leading to a more controlled reaction. Using this optimized polymerization condition, which, according to exemplary embodiments, is 2° C. with 0.5 M initial monomer concentration in 10% v/v MeOH/DCM, controlled PTDO homopolymerization into high molecular weight polymers and copolymerizations with example comonomers phenyl, and oligo(ethylene glycol) bearing norbornenes is demonstrated. As just discussed, each of these parameters alone is nonobvious and especially the combination these parameters, particularly low temperature and additive (MeOH) to achieve high enough monomer concentration and use of the G3 (e.g., rather than G1 or G2), is nonobvious, prior to this application, in view of the state of the art.

### Example 6: Discussion of Aspects and Embodiments Concerning Polymerization of Substituted-PTDO

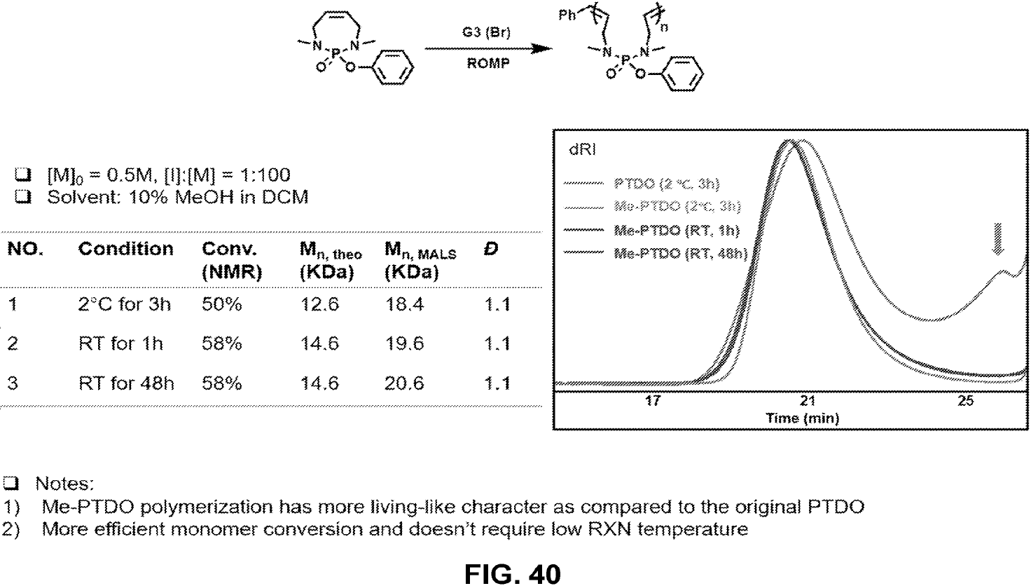

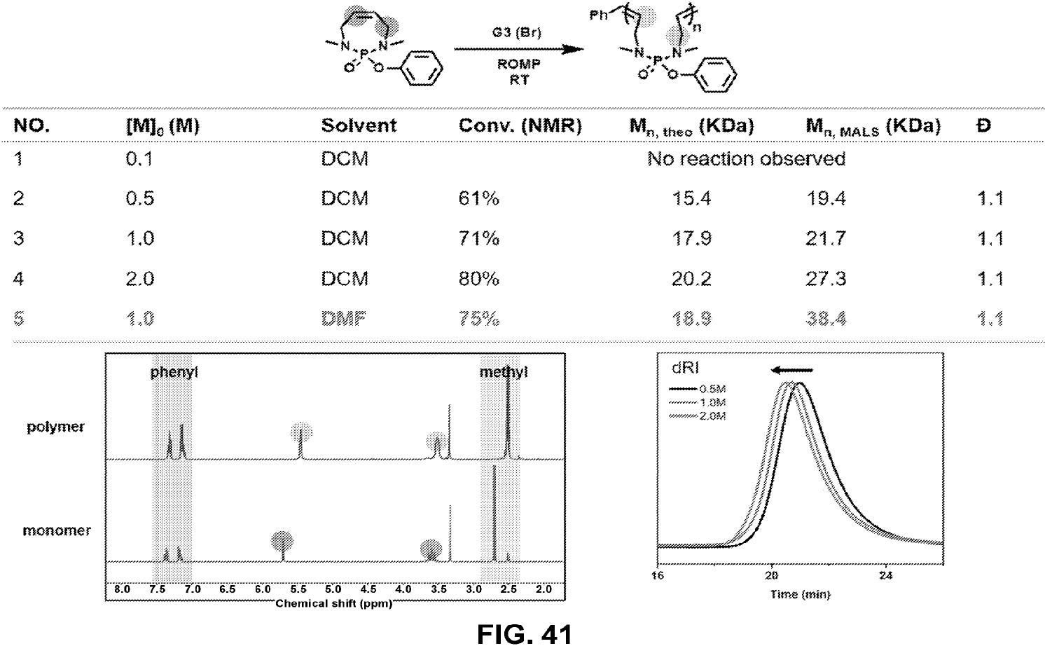

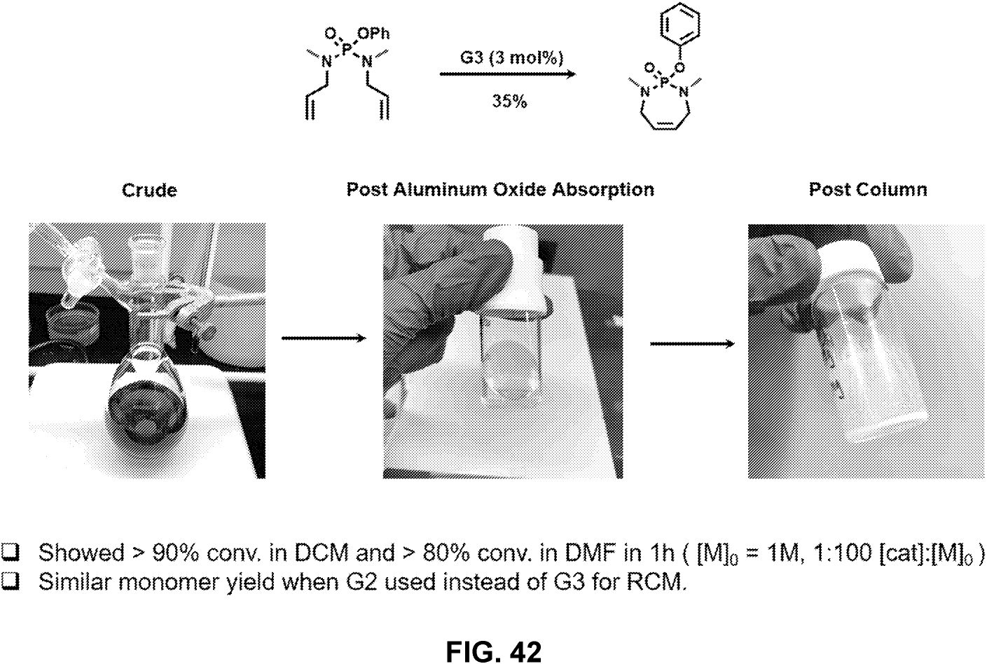

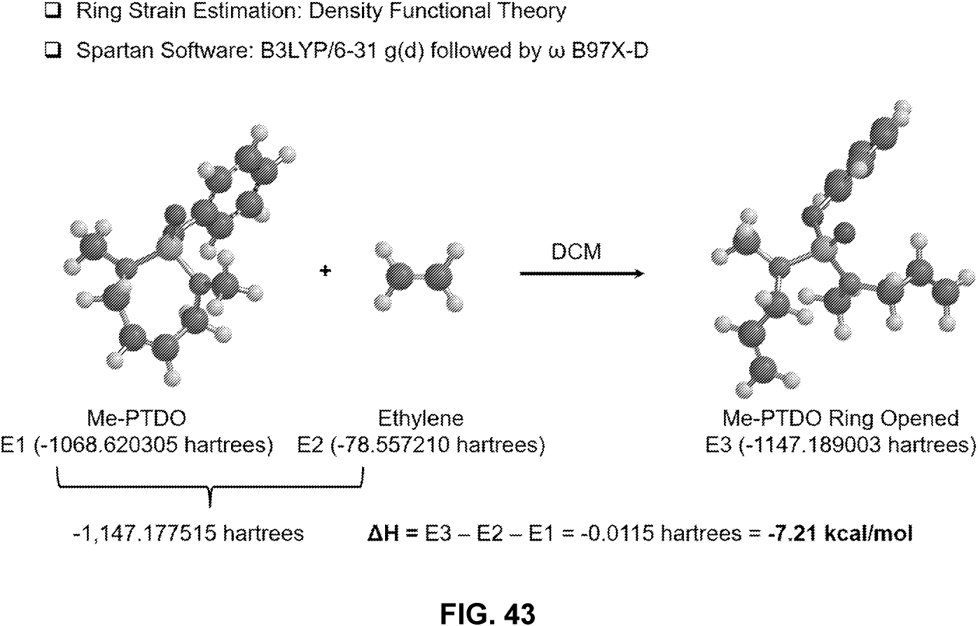

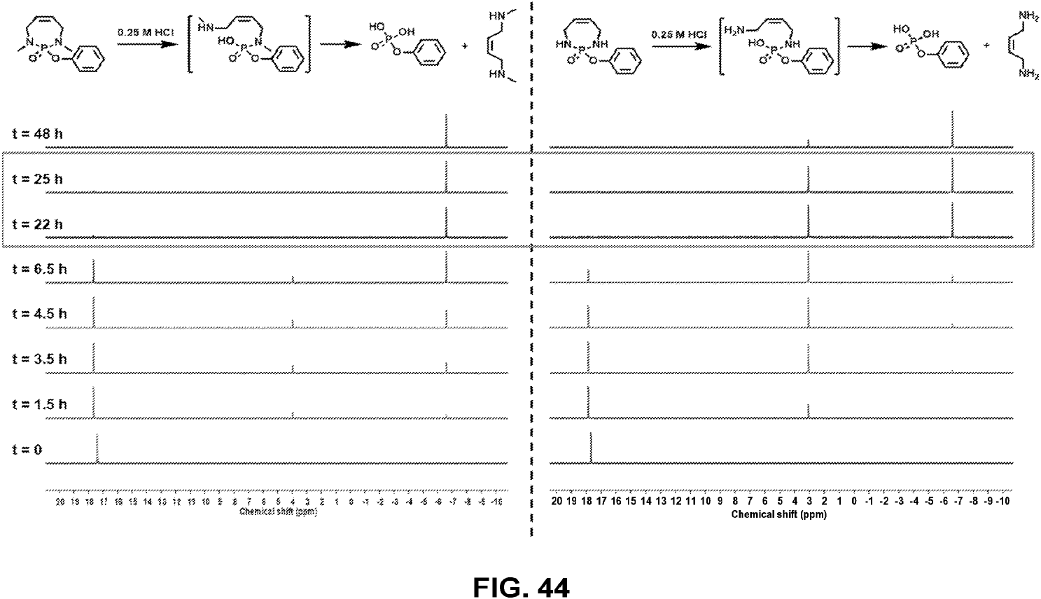

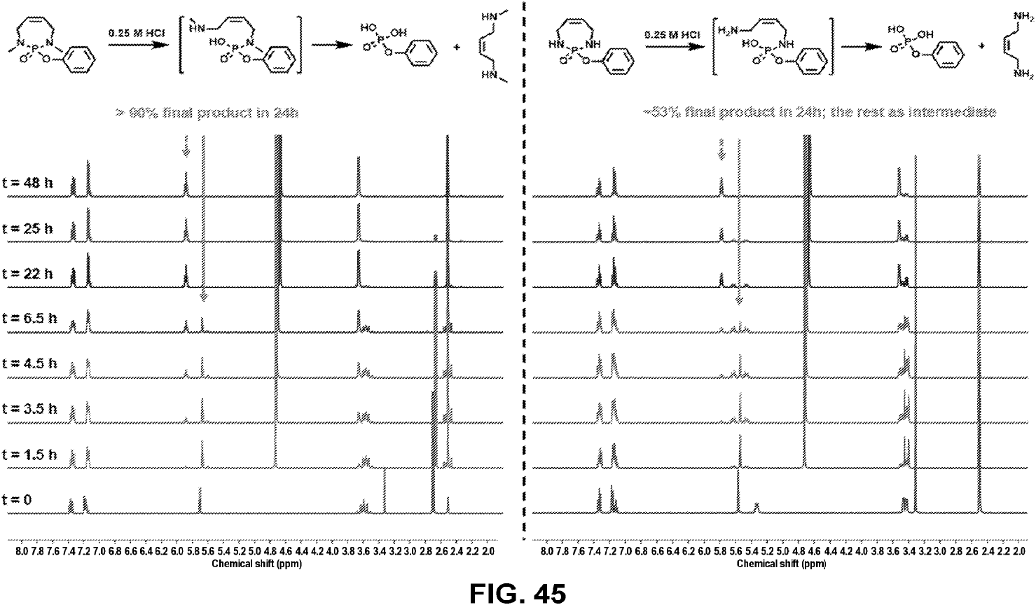

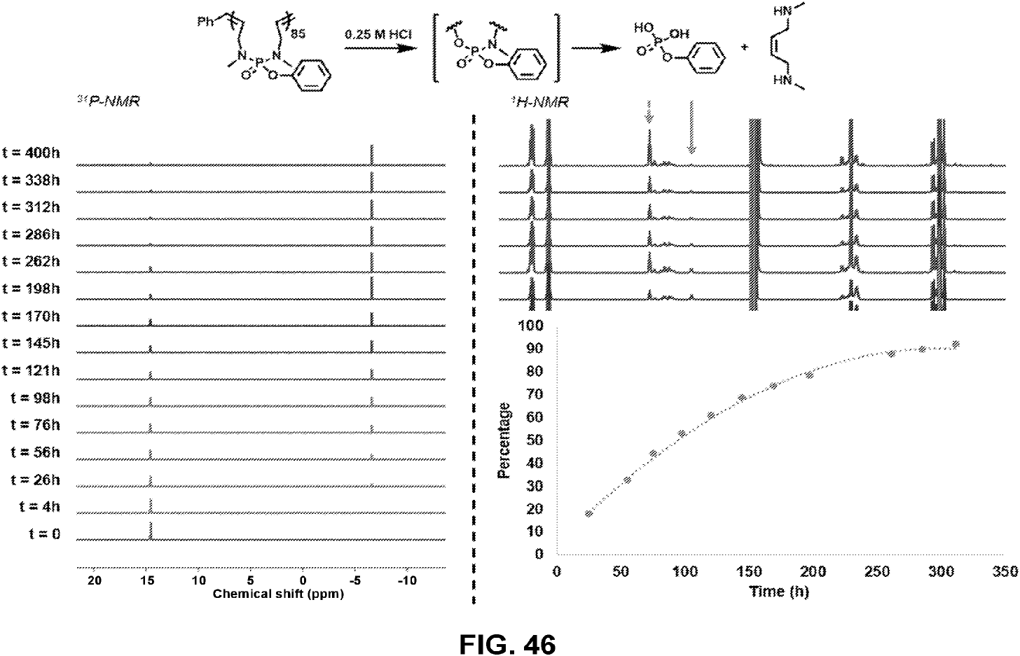

It is believed that synthesis and polymerization of substituted-PTDO (e.g., monomer of FX20 with the provisio that one or both of E¹ and E² is other than NH) has not been reported in the literature. (For example, substituted-PTDO refers to a monomer according to formula FX20, wherein one or both of E¹ and E² is other than NH; or wherein one or both of E¹ and E² is NR⁶ where each of R⁶ and R⁷ is independently a substituted or unsubstituted methyl group, a substituted or unsubstituted ethyl group, a substituted or unsubstituted phenyl group, or any combination of these; or wherein one or both of E¹ and E² is NR⁶, O, or OR⁷where each of R⁶ and R⁷ is independently a substituted or unsubstituted methyl group, a substituted or unsubstituted ethyl group, a substituted or unsubstituted phenyl group, or any combination of these.) Instead of using the direct coupling approach of Examples 1A-1B, for example, exemplary substituted-PTDO monomers were formed using a ring close metathesis approach, according to certain embodiments, which is more generalizable and enables us to introduce various R groups onto the amine. It was contemplated that this R substitution can: 1) decrease the ability of amine to coordinate onto the Grubbs catalyst, promoting the catalyst initiation efficiency; 2) add torsional strain to the cyclized ring, increasing ring strain and facilitating ring opening; 3) shield the propagating carbene during polymerization and slow down decomposition/ secondary metathesis pathways; and 4) modulate the degradation kinetics of the resulting polymer backbone. The change from secondary to tertiary amine on the ring should also reduce the intermolecular hydrogen bonding, alleviating the solubility issue in solvent. The following description is best read concurrently with FIGS. 40-46. Indeed, the Me-PTDO can be dissolved at > 2 M in DCM and showed superior performance towards polymerization as compared to the original PTDO. Starting with 1 M initial monomer Me-PTDO, more than 80% monomer conversion was achieved at room temperature within 1 hour, yielding high molecular weight polymers (in the preliminary test, obtained polymer with MW > 20 KDa and Ð = 1.1). No backbiting or chain transfer was observed in 48 h. Me-PTDO and the resulting polymer also showed faster degradation rate with quick turnover from intermediate species to final degradation products as compared to the original non-substituted PTDO. It is worthwhile to note that Me-PTDO can be polymerized in DMF, making it compatible with peptide bearing norbornenes for functionalization. Other substitutions (at sites E¹ and E² of FX20) are also contemplated (e.g., from Me to Et and Bn), as well as various acid sensitive linkages (e.g., from diazaphosphepine to oxazaphosphepine), and sizes of the ring (e.g., from seven membered to eight or nine membered ring). These changes allow for tunability of the degradation profile of the polymer and the identity of the resulting degradation products.

### Example 7: Exemplary Applications

The following references provide useful background information and embodiments, particularly with respect to some applications of the compositions and methods herein. All of these references are incorporated herein by reference in their entirety, to the extent not inconsistent herewith: (1) Callman, et al. “Poly(peptide): Synthesis, Structure, and Function of Peptide-Polymer Amphiphiles and Protein-like Polymers” Acc. Chem. Res. 2020, 53, 2, 400-413, DOI 10.1021/acs.accounts.9b00518; (2) Callman, et al. “Therapeutic Enzyme-Responsive Nanoparticles for Targeted Delivery and Accumulation in Tumors” Advanced Materials Volume27, Issue31, Pages 4611-4615, 2015, DOI: 10.1002/adma.201501803; and (3) Battistella, et al. “Delivery of Immunotherapeutic Nanoparticles to Tumors via Enzyme-Directed Assembly” Advanced Healthcare Materials, Volume8, Issue23, 2019, 1901105, DOI: 10.1002/adhm.201901105.

### Example 7A: Exemplary Applications: Enzyme Responsive Nanoparticles for Targeted Delivery of Hydrophobic Drugs Through Encapsulation

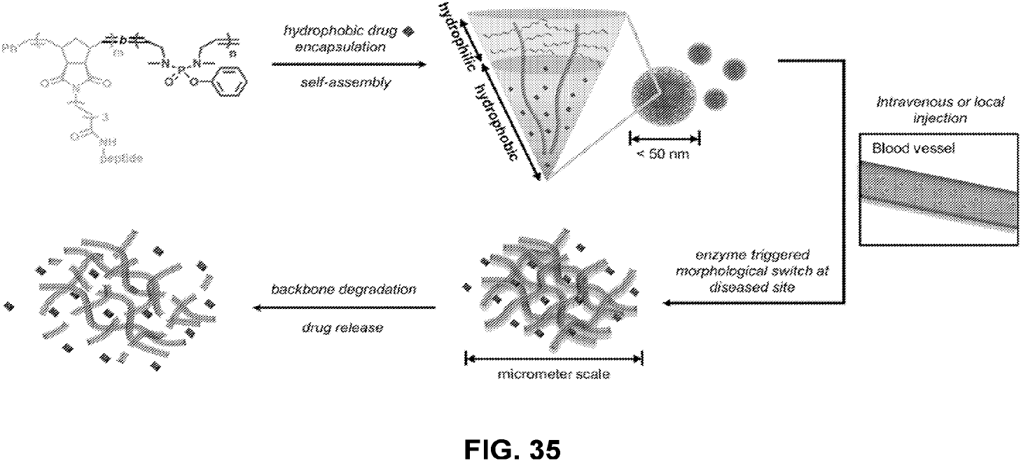

This example is best read concurrently with viewing FIG. 35. Amphiphilic block copolymers generated using norbornene with enzyme cleavable peptide (usually matrix metalloproteinase, a family of overexpressed enzymes that are associated with various inflammatory diseases, such as cancer, myocardial infarction, and periodontitis) and Me-PTDO as the drug delivery platform. These polymers can self-assemble to micellar nanoparticles to encapsulate hydrophobic drugs into the core. The resulting nanoparticles can be delivered through either intravenous or local injection. In the presence of enzymes (e.g., MMPs) at the diseased site, the peptide shell is cleaved, leading to a morphological switch from nanoparticles to micro-scale aggregate that can serve as a drug depot for sustained drug release. The polymer is then gradually degraded into small molecules to get cleared from body.

### Example 7B: Enzyme Responsive Nanoparticles for Targeted Delivery of Hydrophobic Drugs

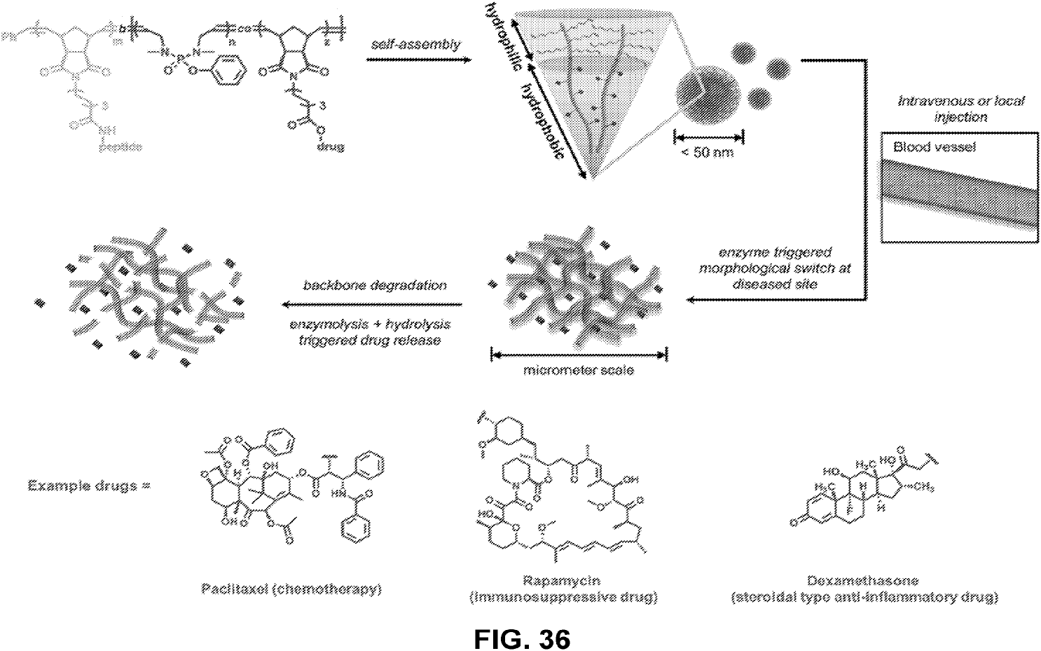

This example is best read concurrently with viewing FIG. 36. Polymer synthesized via graft through polymerization using functionalized norbornene drug monomer. The drug is linked to the polymer backbone through hydrolytically labile ester linkages, which can be degraded through enzymolysis or hydrolysis for drug release. For example, a small molecule drug may be connected to the norbornene via an ester bond, which can be cleaved by water (hydrolysis) and/or enzymes (for example, esterase). This bond may need to be cleaved to release the free drug for function/efficacy (e.g., see FIG. 36). For example, a peptide moiety, such as in the polymer of formula FX17, can be a matrix metalloproteinases (MMP) responsive sequence, which is linked to the norbornene via an amide bond. Each L³ can independently be, but is not limited to, a covalent linkage comprising an amide, an ester, a carbonate, etc. An ester bond, as characterized by formula —COO—, can be split/cleaved by a water molecule (the hydrolysis process) to yield carboxylic acid and alcohol. Therefore, this type of bond may be referred to as “hydrolytically labile”, meaning that it can be split by water. If a drug is connected to the norbornene monomer/backbone through ester bond, it can be released free in the presence of water or enzyme such as esterase. The presence of acid (many diseased sites actually has lower pH like 6 or 6.5) or base can further accelerate this hydrolysis process

### Example 7C

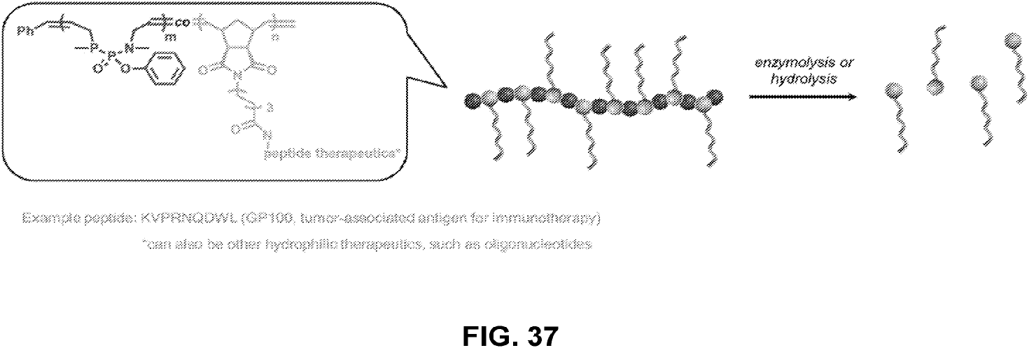

Protein like polymer for the delivery of hydrophilic peptide- or oligonucleotide-based therapeutics. See FIG. 37.

### Example 7D: Recyclable Materials

The cyclic phosphoramidate monomer can be used as comonomer to incorporate degradable linkages into otherwise non-degradable polymer backbone to remediate environmental concern. For example, we anticipate it to copolymerize with dicyclopentadiene (DCPD), whose polymer is utilized in agriculture and automobile industries, to generate the degradable and reprocessable version of pDCPD.

The final degradation products (phosphoric acid and diamine) can be recycled to synthesize the cyclic phosphoramidate monomer, or be used as precursors to produce fertilizers, such as MAP (NH₄⁺ H₂PO₄⁻).

### Example 8: Additional Embodiments and Experimental Data

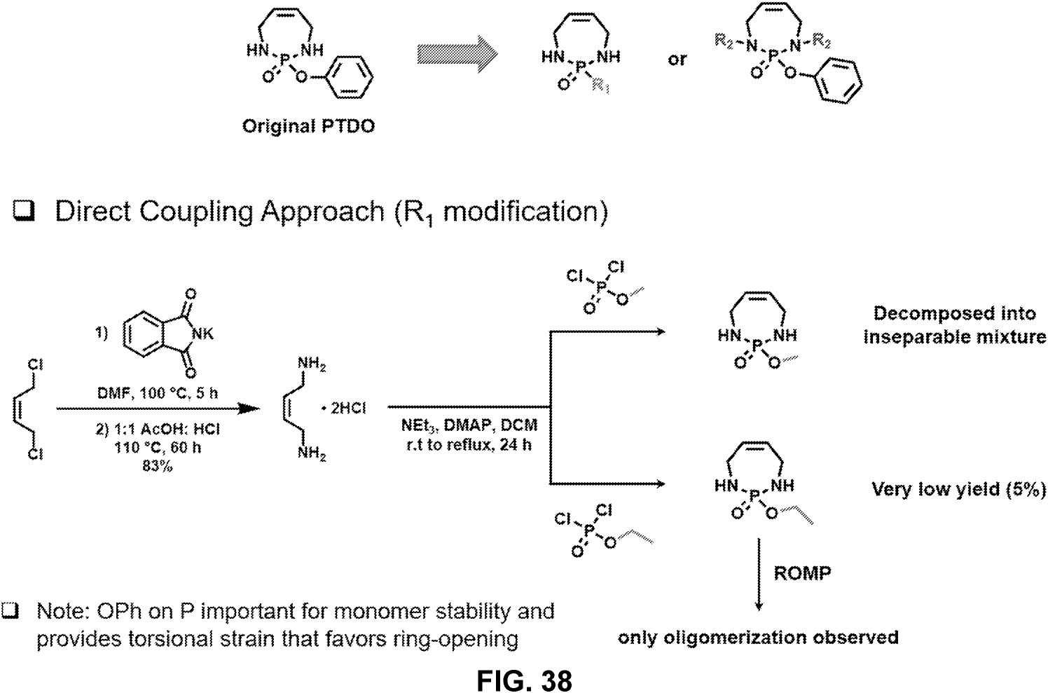

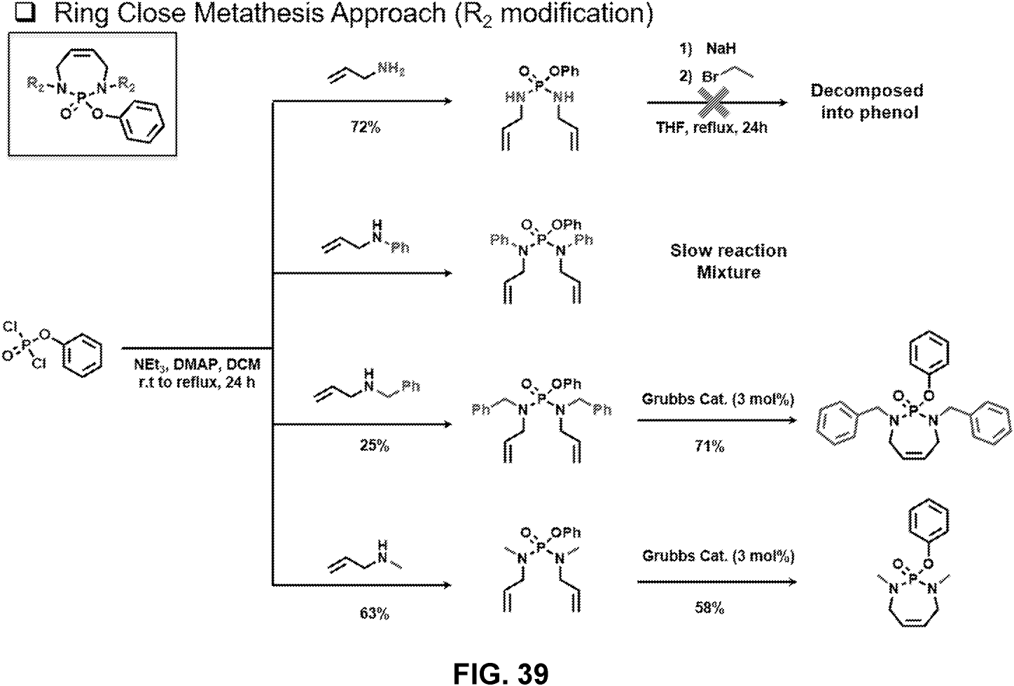

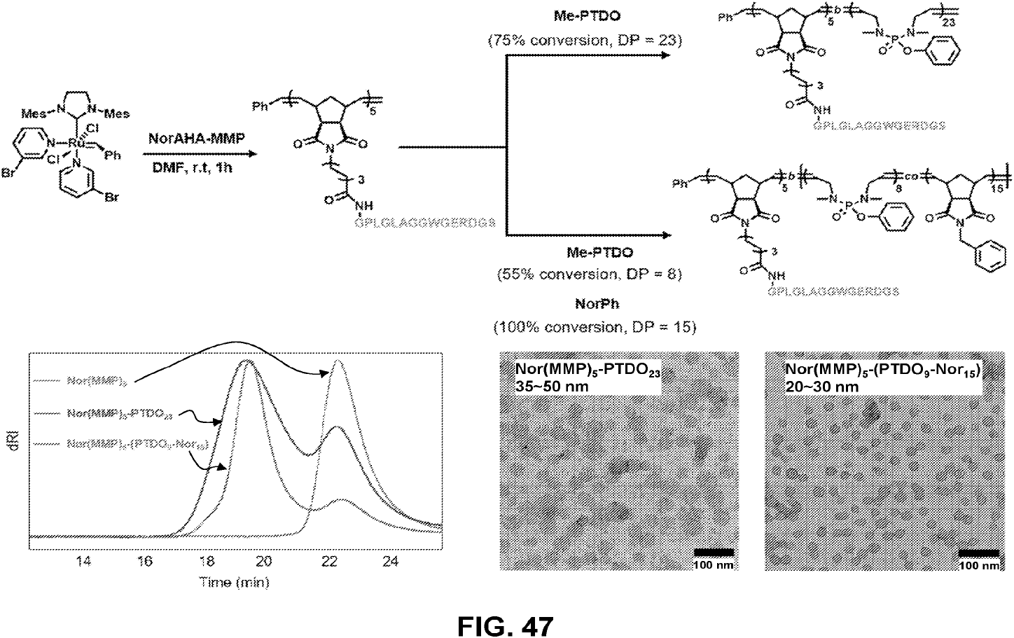

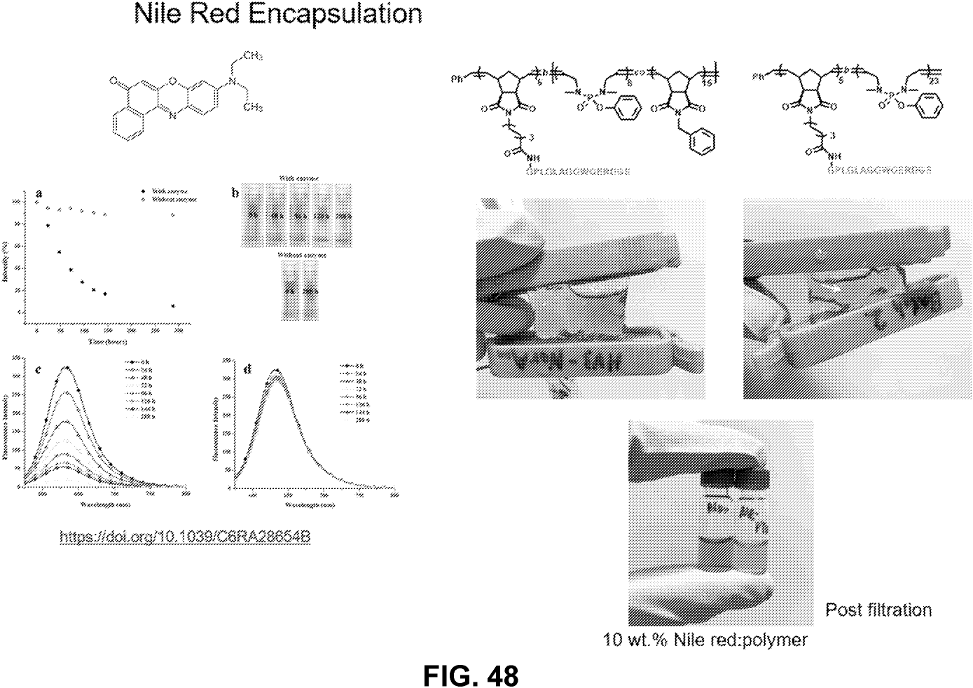

See FIGS. 38-49 for exemplary compositions and methods according to certain embodiments disclosed herein. For example, FIGS. 38-49 include embodiments and characterizations pertaining to synthesis of substituted-PTDO monomers, for example using ring-closing metathesis.

### Example 9: Additional Embodiments

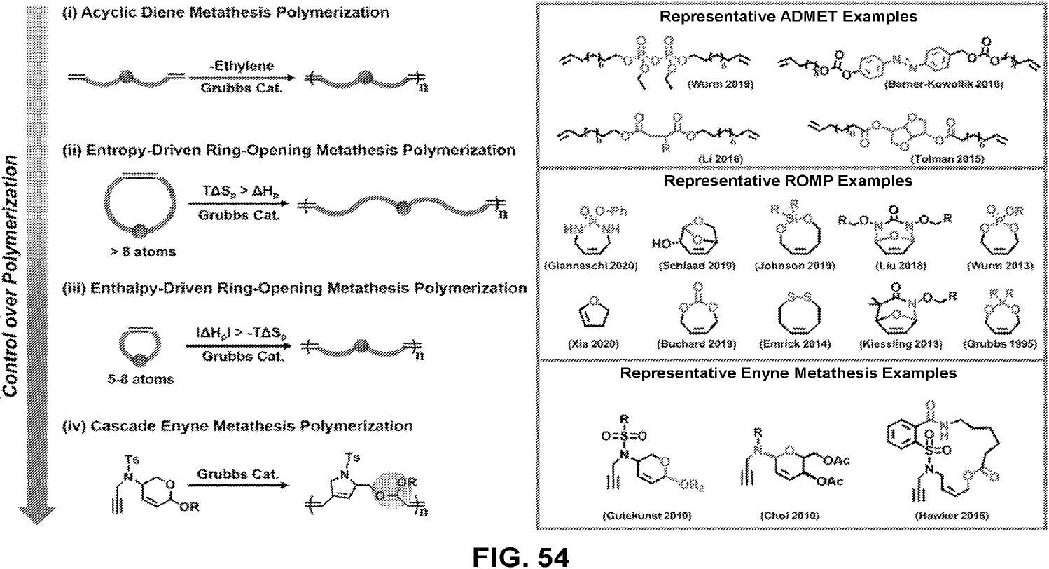

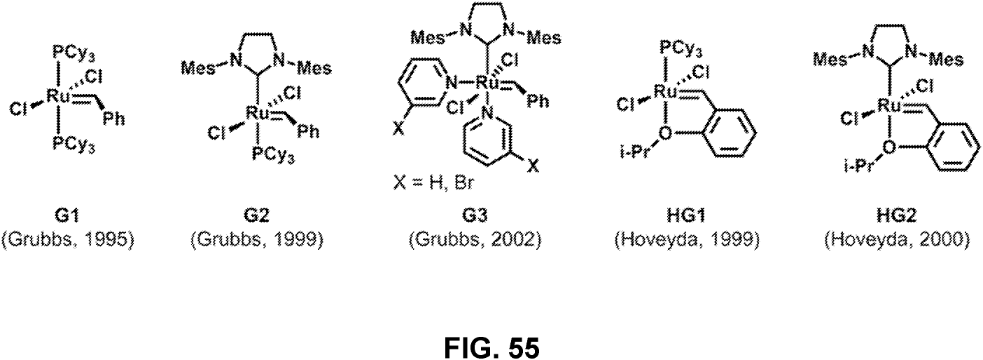

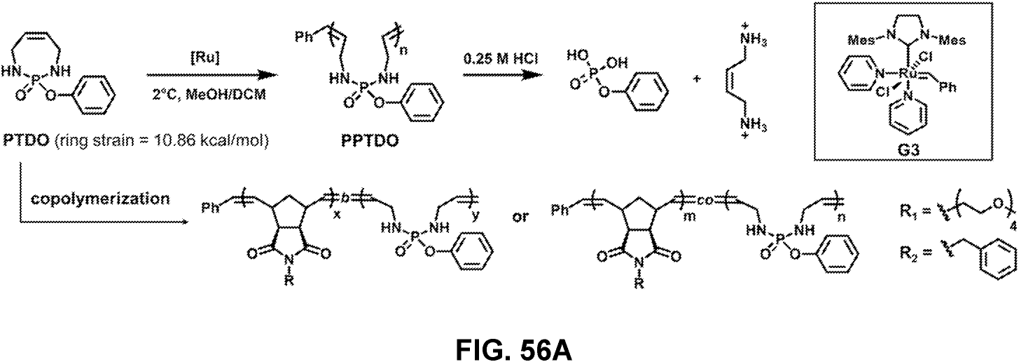

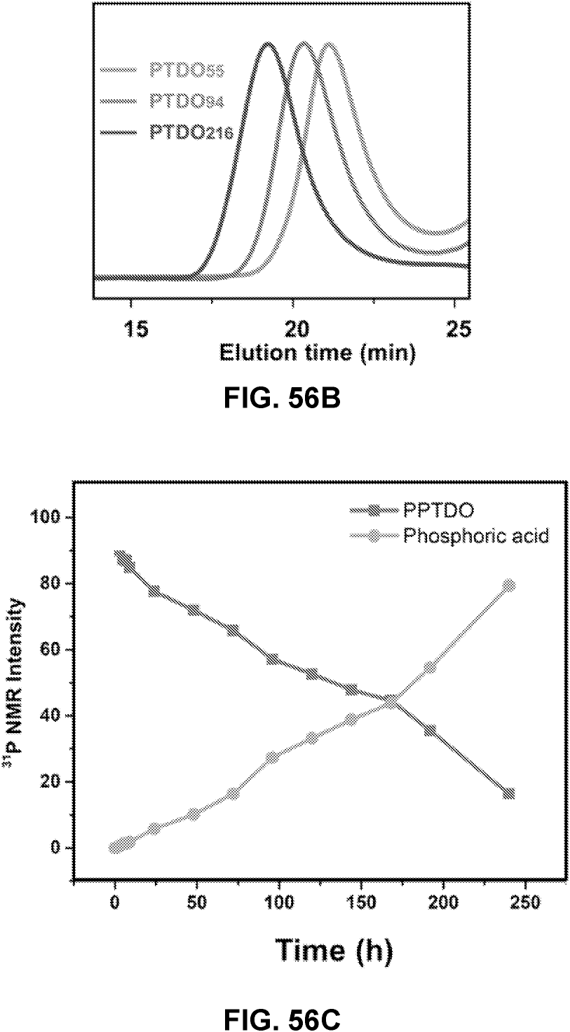

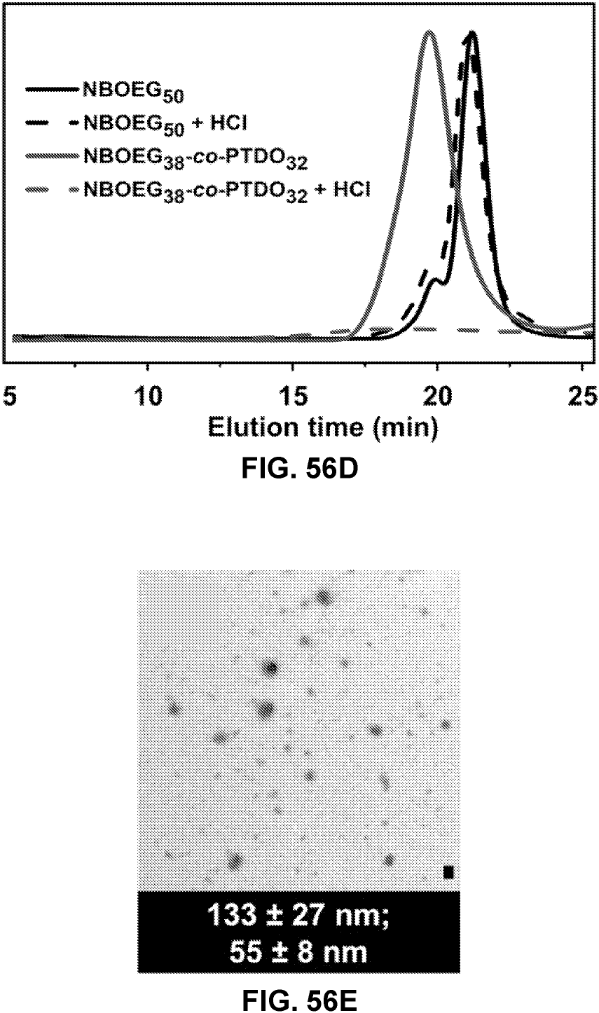

Various potentially useful descriptions, background information, applications of embodiments herein, terminology (to the extent not inconsistent with the terms as defined herein), mechanisms, compositions, methods, definitions, and/or other embodiments may be found in Sun, et al (“Degradable Polymers via Olefin Metathesis Polymerization”, Progress in Polymer Science, Volume 120, 2021, 101427, doi: 10.1016/j.progpolymsci.2021.101427), which is incorporated herein in its entirety to the extent not inconsistent herewith. See also FIGS. 54, 55, and 56A-56E.

Additional discussion, including pertain to applications for degradable polymers, such as those disclosed herein, such as recyclability, is included in the following reference, which is incorporated herein in its entirety to the extent not inconsistent herewith: Husted, et al. “Molecularly Designed Additives for Chemically Deconstructable Thermosets without Compromised Thermomechanical Properties” ACS Macro Lett. 2021, 10, 805-810, DOI: 10.1021/acsmacrolett.1c00255.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.” The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every polymer, monomer, formulation, species, and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant’s invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### SEQUENCE LISTING

<110> Northwestern University
<120> FULLY AND PARTIALLY BACKBONE-DEGRADABLE POLYMERS VIA LOW TEMPERATURE RING-OPENING METATHESIS POLYMERIZATION (ROMP)
<130> 338857: 76-20 WO
<150> 63/047,799
<151> 2020-07-02
<160> 7
<170> PatentIn version 3.5
<210> 1
<211> 7
<212> PRT
<213> Artificial sequence
<220>
<223> Synthetic construct
<400> 1

Gly Gly Ser Gly Ser Gly Ser
1 5

<210> 2
<211> 7
<212> PRT
<213> Artificial sequence
<220>
<223> Synthetic construct
<400> 2

Gly Gly Ser Gly Ser Gly Glu
1 5

<210> 3
<211> 7
<212> PRT
<213> Artificial sequence
<220>
<223> Synthetic construct
<400> 3

Gly Gly Ser Gly Ser Gly Lys
1 5

<210> 4
<211> 7
<212> PRT
<213> Artificial sequence
<220>
<223> Synthetic construct
<400> 4

Gly Gly Ser Gly Ser Gly Arg
1 5

<210> 5
<211> 8
<212> PRT
<213> Artificial sequence
<220>
<223> Synthetic construct
<400> 5

Gly Gly Ser Gly Ser Gly Arg Arg
1 5

<210> 6
<211> 9
<212> PRT
<213> Artificial sequence
<220>
<223> Synthetic construct
<400> 6

Lys Val Pro Arg Asn Gln Asp Trp Leu
1 5

<210> 7
<211> 15
<212> PRT
<213> Artificial sequence
<220>
<223> Synthetic construct
<400> 7

Gly Pro Leu Gly Leu Ala Gly Gly Trp Gly Glu Arg Asp Gly Ser
1 5 10 15

We claim:

1. A fully or partially degradable polymer comprising:
a plurality of first repeating units; wherein each first repeating unit is characterized by formula FX1A; 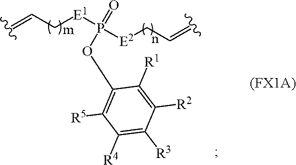
wherein:
each of E¹ and E² is independently NR⁶, O, or OR⁷;
each of R¹-R⁵ is independently a hydrogen, a halogen, a methyl group, or any combination of these;
each of R⁶ and R⁷ is independently hydrogen, a substituted or unsubstituted methyl group, a substituted or unsubstituted ethyl group, a substituted or unsubstituted phenyl group, or any combination of these; and
each of m and n is independently 1 or 2.

2. The polymer of claim 1, wherein each first repeating unit is chemically degradable in the presence of an acid.

3. The polymer of any one of the preceding claims, wherein each first repeating unit comprises a ROMP-polymerized monomer group.

4. The polymer of any one of the preceding claims, wherein the entire polymer is characterized by a total degree of polymerization selected from the range of 2 to 10,000.

5. The polymer of any one of the preceding claims comprising at least 4 of the first repeating units.

6. The polymer of any one of the preceding claims being a homopolymer, wherein each repeating unit of said homopolymer is independently the first repeating unit.

7. The polymer of any one of the preceding claims, wherein:
each of E¹ and E² is independently NH, each of R¹-R⁵ is independently a hydrogen, m is 1, and n is 1; or
each of E¹ and E² is independently NH, each of R¹-R⁵ is independently a hydrogen, m is 1, and n is 2; or
each of E¹ and E² is independently N(CH₃), each of R¹-R⁵ is independently a hydrogen, m is 1, and n is 2; or
each of E¹ and E² is independently N(CH₃), each of R¹-R⁵ is independently a hydrogen, m is 1, and n is 1; or
each of E¹ and E² is independently N(C₂H₆), each of R¹-R⁵ is independently a hydrogen, m is 1, and n is 2; or
each of E¹ and E² is independently N(C₂H₆), each of R¹-R⁵ is independently a hydrogen, m is 1, and n is 1; or
each of E¹ and E² is independently NH, each of R¹-R⁵ is independently a hydrogen, m is 2, and n is 2; or
each of E¹ and E² is independently NH, each of R¹-R⁵ is independently a hydrogen, m is 1, and n is 2; or
each of E¹ and E² is independently N(CH₃), each of R¹-R⁵ is independently a hydrogen, m is 2, and n is 2; or
each of E¹ and E² is independently N(CH₃), each of R¹-R⁵ is independently a hydrogen, m is 1, and n is 2; or
each of E¹ and E² is independently N(C₂H₆), each of R¹-R⁵ is independently a hydrogen, m is 2, and n is 2; or
each of E¹ and E² is independently N(C₂H₆), each of R¹-R⁵ is independently a hydrogen, m is 1, and n is 2; or
each of E¹ and E² is independently NR⁶, each R⁶ is independently —(CH₂)—(phenyl), each of R¹-R⁵ is independently a hydrogen, m is 1, and n is 1; or
E¹ or E² is N(CH₃) and the other of E¹ or E² is O, each of R1-R⁵ is independently a hydrogen, m is 1, and n is 1; or
E¹ or E² is N(CH₃) and the other of E¹ or E² is O(CH₃), each of R1-R⁵ is independently a hydrogen, m is 1, and n is 1; or
E¹ or E² is N(C₂H₆) and the other of E¹ or E² is O(C₂H₆), each of R¹-R⁵ is independently a hydrogen, m is 1, and n is 1.

8. The polymer of any one of the preceding claims being characterized by characterized by formula FX30B, FX31B, FX32B, FX33B, FX34B, FX35B, FX36B, FX37B, FX38B, FX39B, FX40B, FX41B, or FX42B: 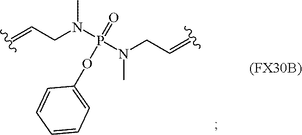 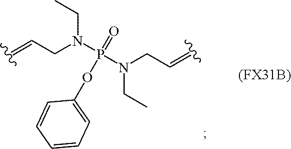 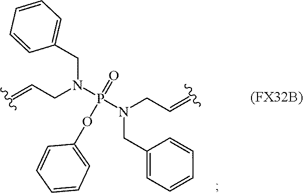 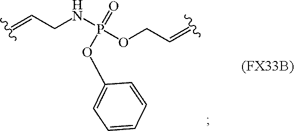 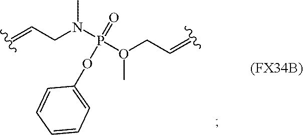 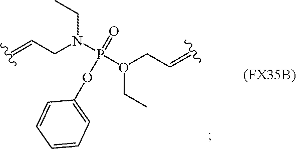 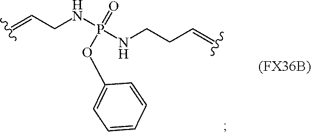 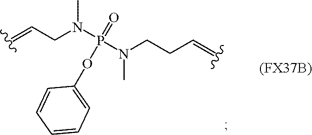 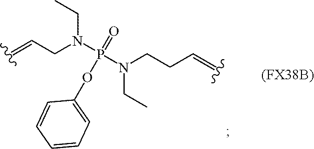 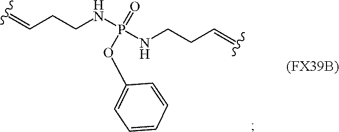 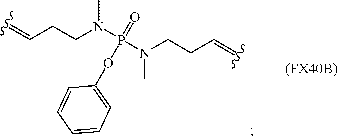 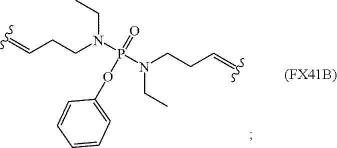
or 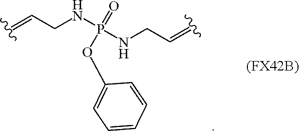
.

9. The polymer of any one of the preceding claims being a copolymer and comprising:
a plurality of second repeating units, each second repeating unit comprising a ROMP-polymerized monomer group;
wherein at least one second repeating unit is covalently attached to a first repeating unit.

10. The polymer of claim 9, wherein a ratio of the degree of polymerization of all first repeating units to the degree of polymerization of the entire polymer is selected from the range of 0.15 to 0.95.

11. The polymer of claim 9 or 10, wherein each second repeating unit comprises the ROMP-polymerization product of a monomer comprising: a substituted or unsubstituted norbornene group, a substituted or unsubstituted dicyclopentadiene group, a substituted or unsubstituted norbornene-imide group, a substituted or unsubstituted oxanorbornene-imide group, a substituted or unsubstituted oxanorbornene group, a substituted or unsubstituted cyclooctene group, a substituted or unsubstituted 1,5-cyclooctadiene group, a substituted or unsubstituted dithiocine group, a substituted or unsubstituted dioxaphosphepine group, a substituted or unsubstituted dioxepinone group, any derivative thereof, or any combination of these.

12. The polymer of any one of claims 9-11, being a block copolymer, an alternating copolymer, a random copolymer, a graft copolymer, or any combination of these.

13. The polymer of any one of claims 9-12 being characterized by formula FX3: 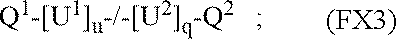
wherein:
each U¹ is independently the first repeating unit;
each U² is independently the second repeating unit;
each of u and q is independently an integer selected from the range of 2 to 10,000;
each of Q¹ and Q² is independently a polymer terminating group; and
the symbol “/” indicates that the units separated thereby are covalently linked randomly or in any order.

14. The polymer of any one of claims 9-13, wherein each second repeating unit comprises a polymer backbone group directly or indirectly covalently linked to one or more side chain moieties; wherein each second repeating unit is characterized by formula FX4: 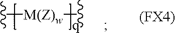
wherein:
each M is independently the polymer backbone group of one of the second repeating units and each M independently comprises a ROMP-polymerized monomer group;
each Z is independently one of the one or more side chain moieties of each second repeating unit;
q is an integer selected from the range of 2 to 10000;
w is an integer selected from the range of 1 to 4; and
the polymer backbone group of each second repeating unit is directly or indirectly covalently attached to the polymer backbone group of a different second repeating and/or to a first repeating unit.

15. The polymer of claim 14, wherein each second repeating unit is characterized by formula FX5: 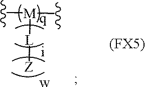
wherein:
L is a covalent linking group;
each of i and w is independently an integer selected from the range of 1 to 4.

16. The polymer of any one of claims 9-15, wherein second repeating unit is characterized by formula FX21B, FX22B, FX23B, FX24B, FX25B, FX26B, FX27B, FX28B, FX29B, any substituted version thereof, or any combination thereof: 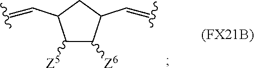 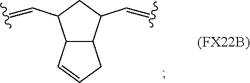 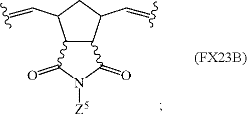 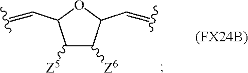 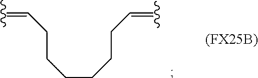 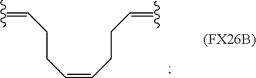 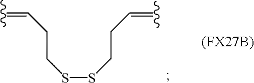 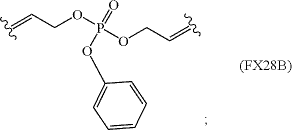 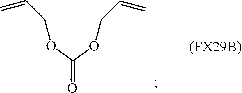
wherein:
each of Z5 and Z6 is independently a side chain moiety or a combination of a covalent linking group and a side chain moiety.

17. The polymer of any one of claims 9-16, wherein each second repeating unit is characterized by formula FX6, FX7, FX8, FX9, FX10, FX11, FX12, or FX13: 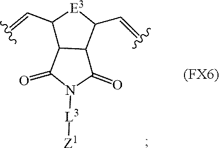 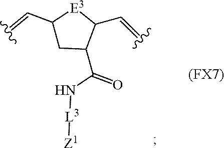 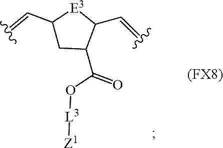 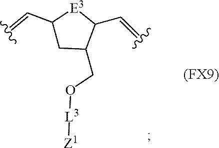 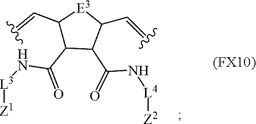 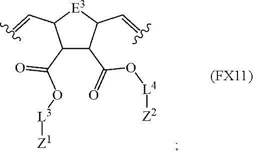 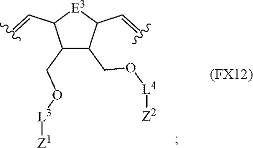
or 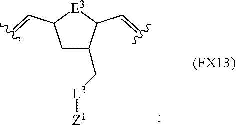
wherein E³ is C or O;
wherein each of L³ and L⁴ is independently the covalent linking group; and
wherein each of Z¹ and Z² is independently one of the one or more side chain moieties of a second repeating unit.

18. The polymer of any one of claims 9-17 further comprising:
a plurality of third repeating units, each third repeating unit comprising a ROMP-polymerized monomer group;
wherein at least one third repeating unit is covalently attached to a first repeating unit, a second repeating unit, or both.

19. The polymer of any one of claims 15-18, wherein each covalent linking group is independently a single bond, an oxygen, or one or more substituted or substituted groups having an alkyl group, an alkenylene group, an arylene group, an alkoxy group, an acyl group, a carboxyl group, an aliphatic group, an amide group, an aryl group, an amine group, an ether group, a ketone group, an ester group, a triazole group, a diazole group, a pyrazole group, or combinations thereof.

20. The polymer of any one of claims 9-19, wherein at least one side chain moiety of the polymer comprises a therapeutic moiety, a peptide moiety, a therapeutic peptide moiety, a non-peptide therapeutic moiety, or any combination thereof.

21. The polymer of any one of claims 9-20, wherein at least one second repeating unis and/or at least one third repeating unit, if present, independently comprises at least one side chain moiety having a therapeutic moiety, a peptide moiety, a therapeutic peptide moiety, a non-peptide therapeutic moiety, or any combination thereof.

22. The polymer of any one of claims 9-21, wherein the polymer comprises at least one non-peptide therapeutic moiety having a cell growth or proliferation inhibitory agent, an anti-inflammatory agent, an anti-tumor or anti-cancer agent, an antiapoptotic agent, anti-diabetic agent, anti-obesity agent, anti-infective agent, antibacterial agent, anti-viral agent, an agent for promoting cell growth and differentiation, an agent for preventing pain, an agent for preventing or treating neural degeneration, an agent for promoting neurogenesis; an immunosuppressant agent, an immunostimulant agent, an MMP-inhibitor agent, a corticosteroid, an anti-angiogenic agent, a pro-angiogenic agent, an NSAID, paclitaxel, rapamycin, dexamethasone, or any combination of these.

23. The polymer of any one of claims 9-22, wherein the polymer comprise at least one peptide moiety comprising a sequence having 80% or greater (e.g., 90% or greater) sequence homology with GGSGSGS (SEQ ID NO:1), GGSGSGE (SEQ ID NO:2), GGSGSGK (SEQ ID NO:3), GGSGSGR (SEQ ID NO:4), GGSGSGRR (SEQ ID NO:5), KVPRNQDWL (SEQ ID NO:6), GPLGLAGGWGERDGS (SEQ ID NO:7), or a combination of these.

24. The polymer of any one of claims 9-23, wherein the polymer is an amphiphilic block copolymer having a hydrophilic block and a hydrophobic block.

25. The polymer of any one of claims 9-24, wherein a plurality of the first repeating units forms the hydrophobic block and wherein a plurality of the second repeating units forms the hydrophilic block.

26. The polymer of claim 24 or 25, the amphiphilic block copolymer being in the form of a particle or micelle in a solution.

27. The polymer of any one of claim 9-26, wherein 4% to 25% of the second repeating units independently comprises an enzyme-cleavable peptide moiety.

28. The polymer of claim 27, wherein the enzyme-cleavable peptide moiety is cleavable by a matrix metalloproteinase.

29. The polymer of claim 27 or 28, wherein the polymer is an amphiphilic block copolymer having at least one hydrophilic block and at least one hydrophobic block; wherein a plurality of the first repeating units forms a hydrophobic block and wherein a plurality of the second repeating units forms a hydrophilic block; and wherein the amphiphilic block copolymer is in the form of a particle or micelle in a solution.

30. The polymer of claim 26 or 29, wherein the particle or micelle encapsulates a hydrophobic therapeutic agent.

31. The polymer of claim 30, the polymer being an amphiphilic block copolymer characterized by formula FX14: 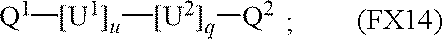
wherein:
each U¹ is independently the first repeating unit being hydrophobic;
each U² is independently the second repeating unit being hydrophilic and comprising a peptide moiety;
each of u and q is independently an integer selected from the range of 2 to 1000; and
each of Q¹ and Q² is independently a polymer terminating group.

32. The polymer of claim 31 being characterized by formula FX15: 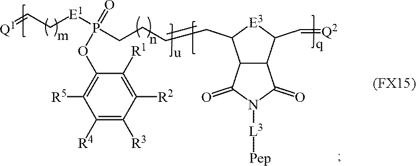
wherein:
E³ is C or O;
each of u and q is independently an integer selected from the range of 2 to 1000;
each L³ is independently a covalent linking group;
each of Q¹ and Q² is independently a polymer terminating group; and
each “Pep” is a peptide moiety.

33. The polymer of any one of claims 9-26, the polymer being an amphiphilic block copolymer characterized by formula FX16: 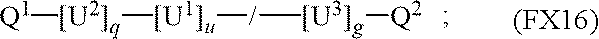
wherein:
each U¹ is independently the first repeating unit being hydrophobic;
each U² is independently the second repeating unit being hydrophilic and comprising a peptide moiety;
each U³ is independently a third repeating unit being hydrophobic and comprising a peptide moiety; each third repeating unit comprising a ROMP-polymerized monomer group; each third repeating unit comprises a polymer backbone group directly or indirectly covalently linked to one or more third side chain moieties; at least one third repeating unit comprises a side chain moiety having a non-peptide therapeutic moiety;
each of u, q, and g is independently an integer selected from the range of 2 to 1000;
each of Q¹ and Q² is independently a polymer terminating group; and
the symbol “/” indicates that the units separated thereby are covalently linked randomly or in any order.

34. The polymer of claim 33 being characterized by formula FX17: 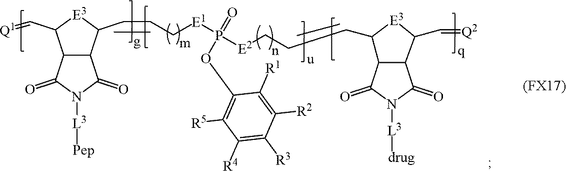
wherein:
each “pep” is a peptide moiety;
each “drug” is a hydrophobic non-peptide therapeutic moiety;
each E³ is independently is C or O;
each of u, q, and g is independently an integer selected from the range of 2 to 1000;
each of Q¹ and Q² is independently a polymer terminating group; and
each of L³ is independently a covalent linking group that can be degraded through enzymolysis and/or hydrolysis.

35. The polymer of claim 31, wherein each L³ independently comprises a hydrolytically labile ester.

36. The polymer of any one of claims 9-26, the polymer being a random or alternating copolymer characterized by formula FX18: 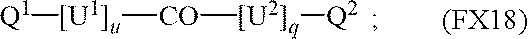
each U¹ is independently the first repeating unit;
each U² is independently the second repeating unit having a therapeutic peptide moiety;
each of u and q is independently an integer selected from the range of 2 to 1000; and
each of Q¹ and Q² is independently a polymer terminating group; and
the symbol “co” indicates that the units separated thereby are covalently linked random and/or alternating order.

37. A liquid formulation comprising:
a solvent or solvent mixture; and
the polymer according to any one of the preceding claims, the polymer being dispersed in the solvent or solvent mixture.

38. The liquid formulation of claim 37 being aqueous.

39. The liquid formulation of claim 37 or 38 being a therapeutic formulation having a therapeutically effective concentration of the polymer.

40. A method of treating or managing a condition in a subject comprising:
administering to the subject the liquid formulation of any one of claims 37-39, the administered amount of the liquid formulation having a therapeutically effective concentration of the polymer.

41. A method of treating or managing a condition in a subject comprising:
administering to the subject a therapeutically effective amount of the polymer of any one of claims 20-36.

42. A method of using the polymer of any one of claims 1-36, the method comprising:
degrading or dissolving the polymer in the presence of acid thereby forming degradation products.

43. The method of claim 42, wherein the degradation products comprise a phosphoric acid, a substituted or unsubstituted diamine or a derivative thereof, or a combination of these.

44. The method of claim 42 or 43, comprising using at least a fraction of the degradation products to synthesize a monomer characterized by formula FX19: 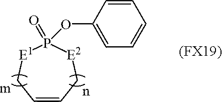
.

45. The method of any one of claims 42-44 comprising forming an agricultural fertilizer comprising at least a fraction of the degradation products.

46. A method for synthesis of a partially or fully degradable polymer, the method comprising:
polymerizing a plurality of monomers using ring-opening metathesis polymerization;
wherein the plurality of monomers comprises a plurality of first monomers; each first monomer being independently characterized by formula FX20: 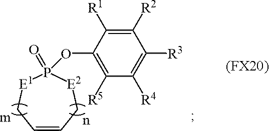
wherein:
each of E¹ and E² is independently NR⁶, O, or OR⁷;
each of R¹-R⁵ is independently a hydrogen, a halogen, a methyl group, or any combination of these;
each of R⁶ and R⁷ is independently hydrogen, a substituted or unsubstituted methyl group, a substituted or unsubstituted ethyl group, a substituted or unsubstituted phenyl group, or any combination of these; and
each of m and n is independently 1 or 2.

47. The method of claim 46, wherein the step of polymerizing occurs in the presence of a Grubbs catalyst; wherein step of polymerizing comprising mixing an initiator solution comprising the Grubbs catalyst and a first monomer solution comprising at least a portion of the plurality of monomers to form a first reaction solution.

48. The method of claim 47, wherein the step of polymerizing further comprises mixing the first reaction solution with a second monomer solution comprising a remaining portion of the plurality of monomers to form a second reaction solution.

49. The method any one of claims 46-48, wherein the plurality of monomers comprises a plurality of second monomers, each second monomer being different from each first monomer; wherein each second monomer comprises ROMP-polymerizable group; and wherein the resulting degradable polymer is a copolymer.

50. The method of claim 49, wherein each second monomer comprises a substituted or unsubstituted norbornene group, a substituted or unsubstituted dicyclopentadiene group, a substituted or unsubstituted norbornene-imide group, a substituted or unsubstituted oxanorbornene-imide group, a substituted or unsubstituted oxanorbornene group, a substituted or unsubstituted cyclooctene group, a substituted or unsubstituted 1,5-cyclooctadiene group, a substituted or unsubstituted dithiocine group, a substituted or unsubstituted dioxaphosphepine group, a substituted or unsubstituted dioxepinone group, any derivative thereof, or any combination of these.

51. The method of claim 49 or 50, wherein the plurality of monomers comprises a plurality of third monomers, each third monomer being different from each first monomer and from each second monomer; wherein each third monomer comprises ROMP-polymerizable group.

52. The method of any one of claims 49-51, wherein each second monomer and/or third monomer, if present, is characterized by formula FX21, FX22, FX23, FX24, FX25, FX26, FX27, FX28, FX29, or any substituted version thereof: 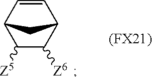 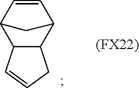 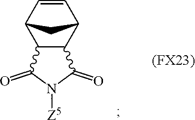 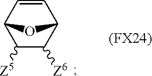 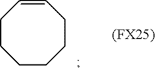 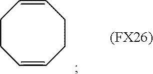 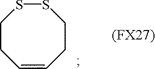 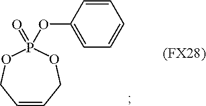 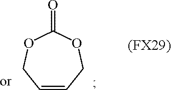
wherein each of Z
⁵ and Z⁶ is independently a side chain moiety or a combination of a covalent linking group and a side chain moiety.

53. The method of anyone of claims 46-52, wherein one or both of E¹ and E² is other than NH.

54. The method of claim 53, wherein the concentration of the plurality of first monomers in the monomer solution is great than 0.5 M.

55. The method of claim 54, wherein a temperature of the monomer solution immediately prior to the mixing step, the initiator solution immediately prior to the mixing step, and/or the mixture of initiator solution and the monomer solution immediately after mixing is greater than 10° C.

56. The method of claim 54 or 55, wherein the monomer solution has a solvent that comprises dimethyl formamide and/or is free of dichloromethane.

57. The method of any one of claims 46-56, wherein each first monomer is characterized by formula FX30, FX31, FX32, FX33, FX34, FX35, FX36, FX37, FX38, FX39, FX40, or FX41: 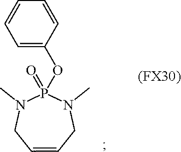 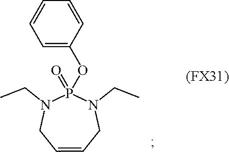 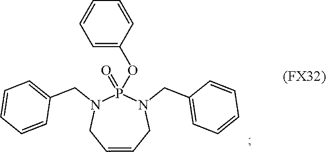 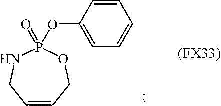 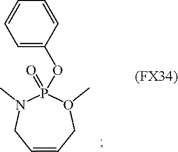 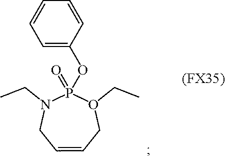 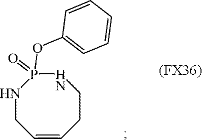 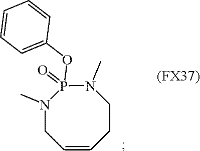 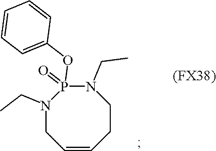 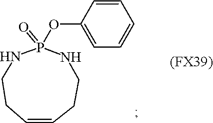 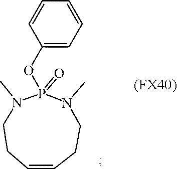 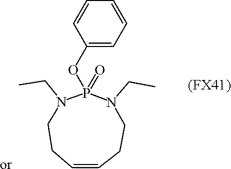
.

58. The method of claim 57, wherein each first monomer is characterized by formula FX30, FX31, FX32, FX33, FX34, FX35, FX37, FX38, FX40, or FX41.

59. The method of any one of claims 46-52, wherein:
each of E¹ and E² is NH;
the Grubbs catalyst is a third-generation Grubbs catalyst (G3) catalyst;
the initiator solution is characterized by a temperature selected from the range of 5° C. to 20° C. immediately prior to or at the time of mixing;
the first monomer solution comprises the plurality of first monomers;
the concentration of the plurality of first monomers in the monomer solution is selected from the range of 0.1 M to 0.8 M; and
the first monomer solution comprises a solvent selected from the group consisting of dichloromethane, chloroform, tetrahydrofuran, methanol, and any combination of these.

60. The method of claim 59, wherein the polymerization of the plurality of first monomers in the presence of the Grubbs catalyst is performed for a time selected from the range of 30 minutes to 5 hours prior to terminating the polymerization reaction.

61. The method of claim 59 or 60, wherein the first monomer solution comprises an additive at an additive concentration selected to facilitate the dissolution of the plurality of first monomers such that the plurality of first monomers do not dissolve at said concentration in the absence of said additive at said additive concentration.

62. The method of any one of claims 59-61, wherein the solvent is a solvent mixture comprising an additive being methanol at an additive concentration selected from the range of 5 vol.% to 10 vol.%.

63. The method of any one of claims 59-62, wherein each first monomer is characterized by formula FX42A, FX36, or FX39: 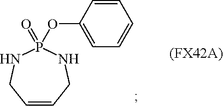 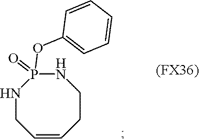 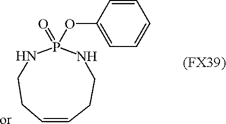
.

64. The method of claim one of claims 59-63, wherein each of m and n is 1 and wherein each first monomer is characterized by formula FX42A: 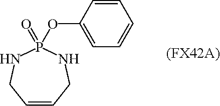 [SMILES: O=P1(Oc2ccccc2)NCC=CCN1]
.

65. A monomer suitable for forming a partially or fully degradable polymer, the monomer being characterized by formula FX20: 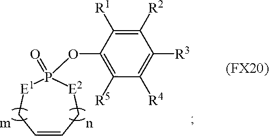
wherein:
each of E¹ and E² is independently NR⁶, O, or OR⁷;
each of R¹-R⁵ is independently a hydrogen, a halogen, a methyl group, or any combination of these;
each of R⁶ and R⁷ is independently a hydrogen, a substituted or unsubstituted methyl group, a substituted or unsubstituted ethyl group, a substituted or unsubstituted phenyl group, or any combination of these;
with the provisio that one or both of E¹ and E² is other than NH; and
each of m and n is independently 1 or 2.

66. A method for synthesizing a monomer suitable for forming a partially or fully degradable polymer, the method comprising:
reacting a precursor using ring-closing metathesis to form the monomer characterized by formula FX20: 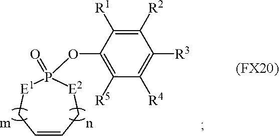
wherein:
each of E¹ and E² is independently NR⁶, O, or OR⁷;
each of R¹-R⁵ is independently a hydrogen, a halogen, a methyl group, or any combination of these;
each of R⁶ and R⁷ is independently a hydrogen, substituted or unsubstituted methyl group, a substituted or unsubstituted ethyl group, a substituted or unsubstituted phenyl group, or any combination of these;
with the provisio that one or both of E¹ and E² is other than NH; and
each of m and n is independently 1 or 2.

67. The method of claim 66, wherein the step of reacting is performed in the presence of a Grubbs catalyst.

68. The method of claim 66 or 67, wherein the precursor is formed by reacting a first reagent and a second reagent, wherein the first reagent is characterized by formula FX43 and wherein the second reagent is characterized by formula FX44A: 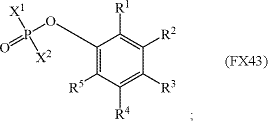
and 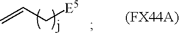
wherein:
each of R¹-R⁵ is independently a hydrogen, a halogen, a methyl group, or any combination of these;
each of X¹ and X² is independently a halide;
j is an integer selected from the range of 1 to 2;
E⁵ is independently NR⁶, O, or OR⁷; and
each of R⁶ and R⁷ is independently hydrogen, a substituted or unsubstituted methyl group, a substituted or unsubstituted ethyl group, a substituted or unsubstituted phenyl group, or any combination of these.

69. The method of any one of claims 66-68, wherein the precursor is characterized by formula FX45A: 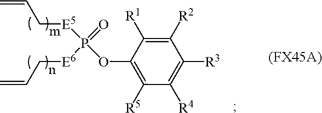
wherein:
each of R¹-R⁵ is independently a hydrogen, a halogen, a methyl group, or any combination of these;
each of m and n is independently the integer 1 or 2;
each of E⁵ and E⁶ is independently NR⁶, O, or OR⁷; and
each of R⁶ and R⁷ is independently hydrogen, a substituted or unsubstituted methyl group, a substituted or unsubstituted ethyl group, a substituted or unsubstituted phenyl group, or any combination of these.

70. A plurality of polymers, each polymer being according to any one of claims 1-37, wherein the plurality of polymers is characterized by a dispersity selected from the range of 1.1 to 1.5.


SEQUENCE LISTING (7 sequences)

SEQ ID NO: 1 - protein, 7 aa, Artificial sequence
  Synthetic construct
GGSGSGS

SEQ ID NO: 2 - protein, 7 aa, Artificial sequence
  Synthetic construct
GGSGSGE

SEQ ID NO: 3 - protein, 7 aa, Artificial sequence
  Synthetic construct
GGSGSGK

SEQ ID NO: 4 - protein, 7 aa, Artificial sequence
  Synthetic construct
GGSGSGR

SEQ ID NO: 5 - protein, 8 aa, Artificial sequence
  Synthetic construct
GGSGSGRR

SEQ ID NO: 6 - protein, 9 aa, Artificial sequence
  Synthetic construct
KVPRNQDWL

SEQ ID NO: 7 - protein, 15 aa, Artificial sequence
  Synthetic construct
GPLGLAGGWGERDGS